(19) United States
(12) Patent Application Publication
(10) Pub. No.: US 2023/0188214 A1
(43) Pub. Date: Jun. 15, 2023

(54) TRANSMISSION/RECEPTION SYSTEM AND TRANSMISSION/RECEPTION METHOD

(71) Applicant: Mitsubishi Electric Corporation, Tokyo (JP)

(72) Inventors: Kiyoshi ONOHARA, Tokyo (JP); Junya NISHIOKA, Tokyo (JP); Michiya HAYAMA, Tokyo (JP); Naoki SUZUKI, Tokyo (JP)

(73) Assignee: Mitsubishi Electric Corporation, Tokyo (JP)

(21) Appl. No.: 18/164,828

(22) Filed: Feb. 6, 2023

Related U.S. Application Data
(63) Continuation of application No. PCT/JP2020/039633, filed on Oct. 21, 2020.

(51) Int. Cl. H04B 10/29; H04B 10/2575; H04B 1/00; H04L 5/00

(52) U.S. Cl. CPC H04B 10/29; H04B 10/2575; H04B 1/0007; H04L 5/0007

(57) ABSTRACT

A transmission/reception system includes: a second transmission/reception device configured to convert a multiplexed signal into a first digital signal in a first format, convert the signal into a first analog signal, and convert the signal into a second optical signal, and convert a first electrical signal into a second digital signal, demodulate the signal to generate a third digital signal, and output a plurality of sixth optical signals; and third transmission/reception device configured to convert a second electrical signal into a fourth digital signal, and demodulate the signal to generate a plurality of fifth digital signals; and convert a plurality of sixth digital signals into a seventh digital signal in a second format, convert the signal into a second analog signal, and convert the signal into a fourth optical signal.

### CROSS REFERENCE TO RELATED APPLICATIONS

This application is a Continuation of PCT International Application No. PCT/JP2020/039633, filed on Oct. 21, 2020, which is hereby expressly incorporated by reference into the present application.

### TECHNICAL FIELD

The present disclosure relates to a transmission/reception system and a transmission/reception method.

### BACKGROUND ART

One of radio signal transmission (hereinafter, referred to as “radio signal transmission”) systems using an optical transmission line such as an optical fiber cable is a digital RoF (Radio-over-Fiber) system.

The digital RoF system is a transmission system in which a transmission-side device converts an analog signal based on a radio signal into a digital signal, then converts the digital signal into an optical signal, and transmits the converted optical signal to a reception-side device via an optical transmission line. In the digital RoF system, for example, an analog signal based on a radio signal is converted into a digital signal of an on-off-keying (OOK) format, so that radio signal transmission by the intensity modulation/direct detection system can be performed.

Incidentally, for example, in the radio signal transmission of the digital RoF system, an analog signal of a signal format of a quadrature amplitude modulation (QAM) system is converted into a digital signal of an OOK format. In the digital RoF system, the higher the multivalued degree of the QAM system or the wider the frequency band of the radio signal, the larger the transmission amount of the radio signal. In radio signal transmission in the fourth generation mobile communication system, a frequency band of a radio signal is about several 100 megahertz (MHz), and a signal format of the QAM system is about 64 QAM or 128 QAM. However, in the future, in higher-speed radio signal transmission of the fifth generation mobile communication system or the like, it is assumed that the frequency band of the radio signal needs to be expanded to about several gigahertz (GHz) and the multivalued degree of the QAM system needs to be increased to about 256 QAM or 1024 QAM, along with an increase in the required transmission amount.

When the frequency band of the radio signal is expanded to about several gigahertz (GHz) and the multivalued degree of the QAM system increases to about 256 QAM or 1024 QAM, a transmission capacity in the optical transmission line becomes insufficient in the radio signal transmission by the digital RoF system. Therefore, in the digital RoF system, there arises a problem that radio signal transmission of a required transmission amount cannot be performed.

As a radio signal transmission system using an optical transmission line such as an optical fiber cable, an analog RoF system is known in addition to the digital RoF system.

The analog RoF system is a transmission system in which a transmission side device directly converts an analog signal based on a radio signal into an optical signal without converting the analog signal into a digital signal, and transmits the converted optical signal to a reception side device via an optical transmission line.

For example, Patent Literature 1 describes a technique related to radio signal transmission by an analog RoF system, and a technique related to IF-over Fiber (IFoF) transmission for transmitting a radio wave emitted from an antenna as an intermediate frequency (IF) signal through an optical fiber.

By applying the technology (hereinafter, referred to as “conventional analog RoF system”) described in Patent Literature 1 to a transmission/reception system that performs radio signal transmission, it is possible to construct a transmission/reception system that can perform radio signal transmission even when the width of the frequency band of the radio signal and the height of the multivalued degree of the QAM system are the width of the frequency band of the radio signal and the height of the multivalued degree of the QAM system that cannot be transmitted by the digital RoF system.

### CITATION LIST

### Patent Literature

Patent Literature 1: Japanese Patent Laid-open Publication No. 2019-212983

### SUMMARY OF INVENTION

### Technical Problem

In the radio signal transmission by the analog RoF system, for example, it is necessary to convert an analog signal in a signal format of the QAM system into a digital signal in an OOK format. That is, in radio signal transmission by the analog RoF system, an analog-to-digital (AD) converter for converting an analog signal into a digital signal is required.

Typical performance indices of the A/D converter include a sampling rate and a bit resolution. These two indices are correlated with the frequency band of the radio signal and the multivalued degree of the QAM system, and as the frequency band of the radio signal is wider and the multivalued degree of the QAM system is higher, the A/D converter is required to have a high sampling rate and a high bit resolution as performance indices.

However, in general, the sampling rate and the bit resolution are in a trade-off relationship. Specifically, for example, the performance of the A/D converter is determined by the product of the sampling rate and the bit resolution.

For example, in a certain A/D converter, when the sampling rate of the A/D converter is 60G samples per second, the bit resolution of the A/D converter is limited to about six bits. Thus, in a case where a transmission/reception system to which the conventional analog RoF system is applied is constructed using the A/D converter, the A/D converter can convert only a radio signal having a multivalued degree up to 64 QAM of the QAM system into a digital signal. Consequentially, when the multivalued degree of the QAM system is a high multivalued degree such as 256 QAM or 1024 QAM, there is a problem that the transmission/reception system cannot perform radio signal transmission.

The present disclosure is intended to solve the above-described problems, and an object of the present disclosure is to provide a transmission/reception system capable of performing radio signal transmission of a QAM system having a higher multivalued degree as compared with a transmission/reception system to which a conventional analog RoF system is used, even if a transmission/reception system is constructed using an A/D converter having similar performance indices.

### Solution to Problem

A transmission/reception system according to the present disclosure is a transmission/reception system that performs transmission and reception of radio signals via an optical transmission line between at least one first transmission/reception device installed at each of a plurality of antenna sites and a second transmission/reception device installed in a relay station building and between the second transmission/reception device and a third transmission/reception device installed in a housing station building and that performs transmission and reception of radio signals in one-to-many connection between a third transmission/reception device and a plurality of user terminals, and the at least one first transmission/reception device includes a plurality of first transmission/reception devices, the second transmission/reception device includes: a relay station UL processing circuit configured to: receive first optical signals output from each of the plurality of first transmission/reception devices and output a multiplexed signal obtained by multiplexing a plurality of electrical signals based on the plurality of first optical signals; convert the multiplexed signal into a first digital signal of a predetermined first format and output the first digital signal after conversion; convert the first digital signal into a first analog signal and output the first analog signal after conversion; and convert the first analog signal into a second optical signal and output the second optical signal after conversion; and a relay station DL processing circuit configured to receive an optical signal based on a fourth optical signal output from the third transmission/reception device as a fifth optical signal and output a first electrical signal based on the fifth optical signal; convert the first electrical signal into a second digital signal and output the second digital signal after conversion; demodulate the second digital signal, thereby generating a third digital signal, and output the generated third digital signal; and output each of a plurality of sixth optical signals based on the third digital signal to a corresponding first transmission/reception device, and the third transmission/reception device including: a housing station UL processing circuit configured to: receive an optical signal based on the second optical signal output from the second transmission/reception device as a third optical signal and output a second electrical signal based on the third optical signal; convert the second electrical signal into a fourth digital signal and output the fourth digital signal after conversion; and demodulate the fourth digital signal to generate a plurality of fifth digital signals and output the plurality of fifth digital signals having been generated; and a housing station DL processing circuit configured to: receive a plurality of sixth digital signals, convert the plurality of sixth digital signals into a seventh digital signal in a predetermined second format, and output the seventh digital signal after conversion; convert the seventh digital signal into a second analog signal, and output the second analog signal after conversion; and convert the second analog signal into the fourth optical signal, and output the fourth optical signal after conversion.

### Advantageous Effects of Invention

According to the present disclosure, even when a transmission/reception system is constructed using an A/D converter having similar performance indices, it is possible to perform radio signal transmission of a QAM system having a higher multivalued degree as compared with a transmission/reception system to which a conventional analog RoF system is used.

### BRIEF DESCRIPTION OF DRAWINGS

FIG. 1 is a block diagram illustrating an example of a configuration of a main part of a transmission/reception system according to a first embodiment.

FIG. 2 is a block diagram illustrating an example of a configuration of a main part of a second transmission/reception device according to the first embodiment.

FIG. 3 is a block diagram illustrating an example of a configuration of a main part of a third transmission/reception device according to the first embodiment.

FIG. 4 is a block diagram illustrating an example of a configuration of a main part of a first transmission/reception device according to the first embodiment.

FIG. 5A is a block diagram illustrating an example of a configuration of a main part of an optical signal receiving unit included in the second transmission/reception device according to the first embodiment. FIG. 5B is a block diagram illustrating an example of a configuration of a main part of an optical signal output unit included in the second transmission/reception device according to the first embodiment.

FIG. 6 is a block diagram illustrating an example of a configuration of a main part of an optical reception front end circuit according to the first embodiment.

FIGS. 7A and 7B are diagrams illustrating an example of a hardware configuration of the first transmission/reception device according to the first embodiment.

FIGS. 8A and 8B are diagrams illustrating an example of a hardware configuration of the second transmission/reception device according to the first embodiment.

FIGS. 9A and 9B are diagrams illustrating an example of a hardware configuration of the third transmission/reception device according to the first embodiment.

FIG. 10 is a flowchart illustrating an example of uplink side processing in the first transmission/reception device according to the first embodiment.

FIG. 11 is a flowchart illustrating an example of uplink side processing in the second transmission/reception device according to the first embodiment.

FIG. 12 is a flowchart illustrating an example of uplink side processing in the third transmission/reception device according to the first embodiment.

FIG. 13 is a flowchart illustrating an example of downlink side processing in the third transmission/reception device according to the first embodiment.

FIG. 14 is a flowchart illustrating an example of downlink side processing in the second transmission/reception device according to the first embodiment.

FIG. 15 is a flowchart illustrating an example of downlink side processing in the first transmission/reception device according to the first embodiment.

FIG. 16 is a block diagram illustrating an example of a configuration of a main part of a transmission/reception system according to a second embodiment.

FIG. 17 is a flowchart illustrating an example of uplink side processing in a second transmission/reception device according to the second embodiment.

FIG. 18 is a flowchart illustrating an example of uplink side processing in a third transmission/reception device according to the second embodiment.

FIG. 19 is a flowchart illustrating an example of downlink side processing in the third transmission/reception device according to the second embodiment.

FIG. 20 is a flowchart illustrating an example of downlink side processing in the second transmission/reception device according to the second embodiment.

FIG. 21 is a block diagram illustrating an example of a configuration of a main part of a transmission/reception system according to a third embodiment.

FIG. 22 is a block diagram illustrating an example of a configuration of a main part of a second transmission/reception device according to the third embodiment.

FIG. 23 is a block diagram illustrating an example of a configuration of a main part of a first transmission/reception device according to the third embodiment.

FIG. 24 is a block diagram illustrating an example of a configuration of a main part of an optical signal receiving unit included in the second transmission/reception device according to the third embodiment.

FIG. 25 is a block diagram illustrating an example of a configuration of a main part of an optical signal output unit included in the second transmission/reception device according to the third embodiment.

FIG. 26 is a flowchart illustrating an example of uplink side processing in the first transmission/reception device according to the third embodiment.

FIG. 27 is a flowchart illustrating an example of uplink side processing in the second transmission/reception device according to the third embodiment.

FIG. 28 is a flowchart illustrating an example of downlink side processing in the second transmission/reception device according to the third embodiment.

FIG. 29 is a flowchart illustrating an example of downlink side processing in the first transmission/reception device according to the third embodiment.

FIG. 30 is a block diagram illustrating an example of a configuration of a main part of a transmission/reception system according to a fourth embodiment.

FIG. 31 is a flowchart illustrating an example of uplink side processing in a second transmission/reception device according to the fourth embodiment.

FIG. 32 is a flowchart illustrating an example of downlink side processing in the second transmission/reception device according to the fourth embodiment.

FIG. 33 is a block diagram illustrating an example of a configuration of a main part of a transmission/reception system according to a fifth embodiment.

FIG. 34 is a block diagram illustrating an example of a configuration of a main part of a relay transmission/reception device according to the fifth embodiment.

FIG. 35 is a block diagram illustrating an example of a configuration of a main part of a relay optical signal receiving unit included in the relay transmission/reception device according to the fifth embodiment.

FIG. 36 is a block diagram illustrating an example of a configuration of a main part of a relay optical signal output unit included in the relay transmission/reception device according to the fifth embodiment.

FIGS. 37A and 37B are diagrams illustrating an example of a hardware configuration of a relay transmission/reception device according to the first embodiment.

FIG. 38 is a flowchart illustrating an example of uplink side processing in the relay transmission/reception device according to the fifth embodiment.

FIG. 39 is a flowchart illustrating an example of downlink side processing in the relay transmission/reception device according to the fifth embodiment.

### DESCRIPTION OF EMBODIMENTS

Hereinafter, embodiments of the present disclosure will be described in detail with reference to the drawings.

First Embodiment.

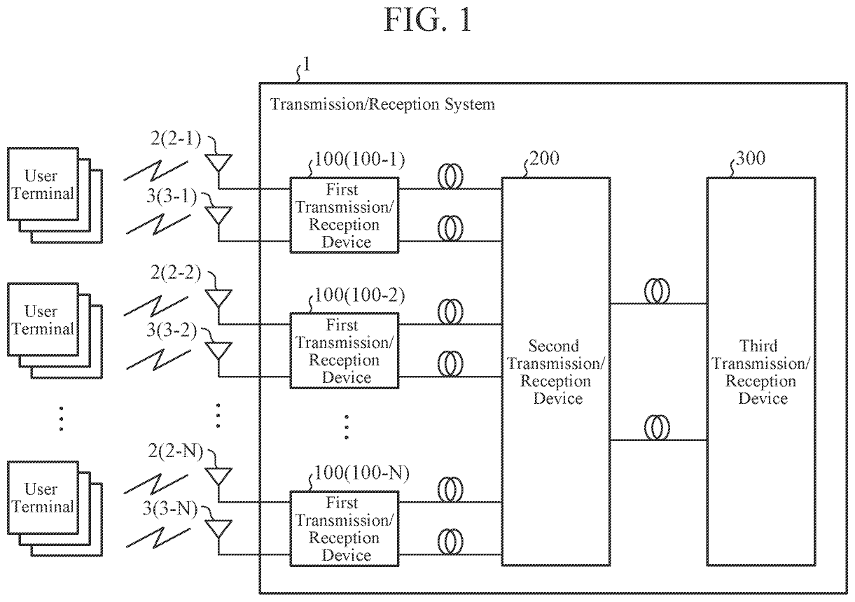

A transmission/reception system 1 according to a first embodiment will be described by referring to FIGS. 1 to 15.

A configuration of a main part of the transmission/reception system 1 according to the first embodiment will be described with reference to FIG. 1.

FIG. 1 is a block diagram illustrating an example of a configuration of a main part of the transmission/reception system 1 according to the first embodiment.

The transmission/reception system 1 includes a plurality of first transmission/reception devices 100, a second transmission/reception device 200, and a third transmission/reception device 300.

FIG. 1 illustrates N (N is a natural number of 2 or more) first transmission/reception devices 100-1,100-2, . . . , and 100-N as the plurality of first transmission/reception devices 100.

Each of the plurality of first transmission/reception devices 100 is connected to a reception antenna 2 and a transmission antenna 3.

FIG. 1 illustrates reception antennas 2-1, 2-2, . . . , and 2-N and transmission antennas 3-1, 3-2, . . . , and 3-N connected to the first transmission/reception devices 100-1, 100-2, . . . , and 100-N.

The first transmission/reception device 100 is a transmission/reception device installed at each of a plurality of antenna sites.

Each of the plurality of first transmission/reception devices 100 performs transmission and reception of radio signals by a radio wave to and from each of a plurality of user terminals via the reception antenna 2 and the transmission antenna 3. Specifically, for example, the first transmission/reception device 100 performs transmission and reception of radio signals by a radio wave to and from each of the plurality of user terminals by a communication system such as an orthogonal frequency division multiplexing system.

The second transmission/reception device 200 is a transmission/reception device installed in a relay station building.

The third transmission/reception device 300 is a transmission/reception device installed in a housing station building.

Each of the plurality of first transmission/reception devices 100 and the second transmission/reception device 200 mutually perform transmission and reception of radio signals via an optical transmission line. In addition, the second transmission/reception device 200 and the third transmission/reception device 300 mutually perform transmission and reception of radio signals via an optical transmission line. The optical transmission line includes, for example, an optical fiber cable.

Specifically, each of the plurality of first transmission/reception devices 100 receives a radio wave output from each of the plurality of user terminals as a reception radio signal via the reception antenna 2. Each of the plurality of first transmission/reception devices 100 generates a first optical signal on the basis of the reception radio signal and outputs the generated first optical signal.

The second transmission/reception device 200 receives the first optical signal output from each of the plurality of first transmission/reception devices 100 via the optical transmission line. The second transmission/reception device 200 generates a second optical signal on the basis of the plurality of received first optical signals, and outputs the generated second optical signal.

The third transmission/reception device 300 receives an optical signal based on the second optical signal output from the second transmission/reception device 200 as a third optical signal via the optical transmission line. In the first embodiment, since the second transmission/reception device 200 and the third transmission/reception device 300 are directly connected by the optical transmission line, the third optical signal received by the third transmission/reception device 300 is the second optical signal output from the second transmission/reception device 200.

In addition, the third transmission/reception device 300 receives a digital signal input from the outside of the transmission/reception system 1. The third transmission/reception device 300 generates a fourth optical signal on the basis of the received digital signal, and outputs the generated fourth optical signal.

The second transmission/reception device 200 receives an optical signal based on the fourth optical signal output from the third transmission/reception device 300 as a fifth optical signal via the optical transmission line. In the first embodiment, since the second transmission/reception device 200 and the third transmission/reception device 300 are directly connected by the optical transmission line, the fifth optical signal received by the second transmission/reception device 200 is the fourth optical signal output from the third transmission/reception device 300. The second transmission/reception device 200 generates a plurality of sixth optical signals on the basis of the received fifth optical signal, and outputs the plurality of generated sixth optical signals.

Each of the plurality of first transmission/reception devices 100 receives a corresponding sixth optical signal among the plurality of sixth optical signals output from the second transmission/reception device 200 via the optical transmission line. Each of the plurality of first transmission/reception devices 100 generates a transmission radio signal on the basis of the received sixth optical signal and outputs the generated transmission radio signal.

The transmission radio signal output from the first transmission/reception device 100 is received by the user terminal as a radio wave via the transmission antenna 3.

With the above configuration, the transmission/reception system 1 performs transmission and reception of radio signals in one-to-many connection between the third transmission/reception device 300 and the plurality of user terminals by performing transmission and reception of radio signals via the optical transmission line between the first transmission/reception device 100 installed at each of the plurality of antenna sites and the second transmission/reception device 200 installed in the relay station building, and between the second transmission/reception device 200 and the third transmission/reception device 300 installed in the housing station building.

The transmission/reception system 1 performs transmission and reception of radio signals by a coherent detection system, for example, between the second transmission/reception device 200 and the third transmission/reception device 300.

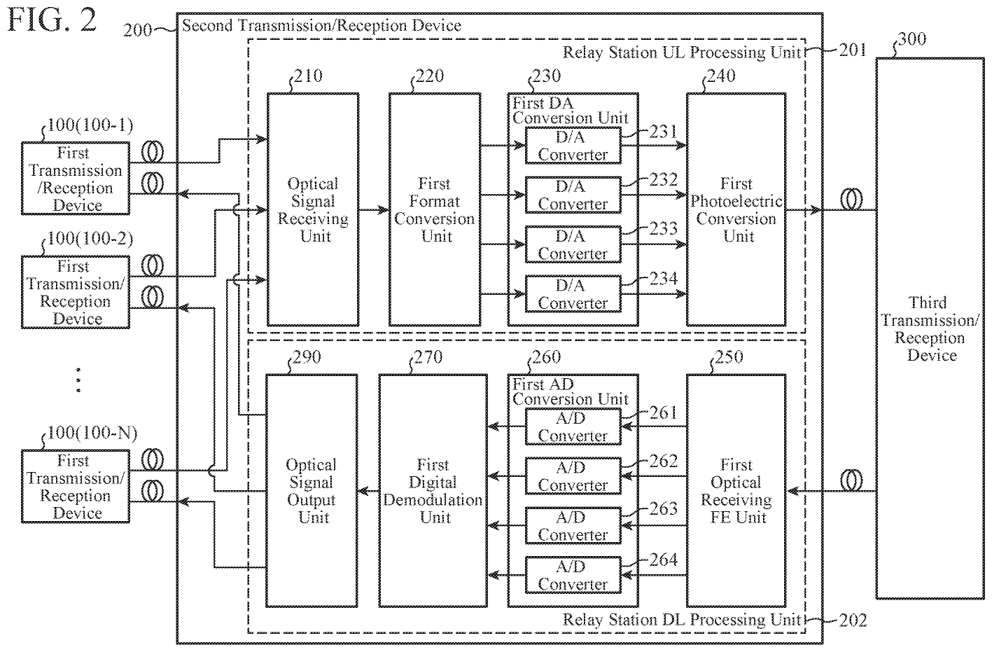

A configuration of a main part of the second transmission/reception device 200 according to the first embodiment will be described with reference to FIG. 2.

FIG. 2 is a block diagram illustrating an example of a configuration of a main part of the second transmission/reception device 200 according to the first embodiment.

The second transmission/reception device 200 includes a relay station UL processing unit 201 and a relay station DL processing unit 202.

The relay station UL processing unit 201 performs uplink (UL) side processing in the second transmission/reception device 200. That is, the relay station UL processing unit 201 performs radio signal processing in a direction from the first transmission/reception device 100 to the third transmission/reception device 300 in the second transmission/reception device 200.

Specifically, the relay station UL processing unit 201 receives the first optical signal output from each of the plurality of first transmission/reception devices 100. The relay station UL processing unit 201 converts the plurality of first optical signals into a second optical signal, and outputs the second optical signal after conversion to the third transmission/reception device 300.

More specifically, the relay station UL processing unit 201 includes an optical signal receiving unit 210, a first format conversion unit 220, a first DA conversion unit 230, and a first photoelectric conversion unit 240. The relay station UL processing unit 201 includes the optical signal receiving unit 210, the first format conversion unit 220, the first DA conversion unit 230, and the first photoelectric conversion unit 240, thereby converting the plurality of first optical signals into a second optical signal and outputting the second optical signal after conversion to the third transmission/reception device 300.

The optical signal receiving unit 210, the first format conversion unit 220, the first DA conversion unit 230, and the first photoelectric conversion unit 240 included in the relay station UL processing unit 201 will be described.

The optical signal receiving unit 210 receives the first optical signal output from each of the plurality of first transmission/reception devices 100 and outputs a multiplexed signal obtained by multiplexing a plurality of electrical signals based on the plurality of first optical signals.

Specifically, the multiplexed signal output from the optical signal receiving unit 210 is a digital signal.

Details of the optical signal receiving unit 210 will be described later.

The first format conversion unit 220 converts the multiplexed signal output from the optical signal receiving unit 210 into a first digital signal in a predetermined first format, and outputs the first digital signal after conversion.

Specifically, first, the first format conversion unit 220 converts the multiplexed signal output from the optical signal receiving unit 210 into a signal format of the QAM system. More specifically, first, the first format conversion unit 220 converts the multiplexed signal output from the optical signal receiving unit 210 into an in-phase (I) signal and a quadrature (Q) signal. Next, the first format conversion unit 220, after converting the multiplexed signal into an I signal and a Q signal, polarizes and separates each of the I signal and Q signal after conversion into an X polarization signal and a Y polarization signal.

As described above, the first format conversion unit 220 converts the multiplexed signal output from the optical signal receiving unit 210 into an X-polarized I signal (hereinafter, referred to as an “XI signal”), an X-polarized Q signal (hereinafter, referred to as an “XQ signal”), a Y-polarized I signal (hereinafter, referred to as a “YI signal”), and a Y-polarized Q signal (hereinafter, referred to as a “YQ signal”).

That is, the conversion into the first digital signal in the first format performed by the first format conversion unit 220 is to convert the multiplexed signal into the XI signal, the XQ signal, the YI signal, and the YQ signal, and the first digital signal is a digital signal including four digital signals of the XI signal, the XQ signal, the YI signal, and the YQ signal.

The first format conversion unit 220 converts the multiplexed signal into the first digital signal in the first format including the XI signal, the XQ signal, the YI signal, and the YQ signal, so that the transmission/reception system 1 can perform transmission and reception of the radio signals by the coherent detection system in the transmission and reception of the radio signals from the second transmission/reception device 200 to the third transmission/reception device 300.

The first DA conversion unit 230 converts the first digital signal output from the first format conversion unit 220 into a first analog signal, and outputs the first analog signal after conversion. For example, the first DA conversion unit 230 includes four D/A converters 231, 232, 233, and 234 as illustrated in FIG. 2.

Specifically, the first DA conversion unit 230 converts each of the XI signal, the XQ signal, the YI signal, and the YQ signal, which are the first digital signals output from the first format conversion unit 220, into an analog signal by a corresponding D/A converter 231, 232, 233, or 234, and outputs the four analog signals after conversion as the first analog signals.

The first photoelectric conversion unit 240 converts the first analog signal output from the first DA conversion unit 230 into a second optical signal, and outputs the second optical signal after conversion.

For example, the first photoelectric conversion unit 240 includes an addition circuit and a photoelectric converter (not illustrated in FIG. 2).

Specifically, for example, the first photoelectric conversion unit 240 first adds all the four analog signals output as the first analog signal by the first DA conversion unit 230 by the addition circuit included in the first photoelectric conversion unit 240.

Next, the first photoelectric conversion unit 240 generates a second optical signal by E/O converting the added analog signal by the photoelectric converter included in the first photoelectric conversion unit 240, and outputs the generated second optical signal.

With the above configuration, the relay station UL processing unit 201 converts the plurality of first optical signals into the second optical signal, and outputs the second optical signal after conversion to the third transmission/reception device 300.

The relay station DL processing unit 202 performs downlink (DL) side processing in the second transmission/reception device 200. That is, the relay station DL processing unit 202 performs radio signal processing in a direction from the third transmission/reception device 300 to the first transmission/reception device 100 in the second transmission/reception device 200.

Specifically, the relay station DL processing unit 202 receives, as a fifth optical signal, an optical signal based on the fourth optical signal output from the third transmission/reception device 300. The relay station DL processing unit 202 converts the fifth optical signal into a plurality of sixth optical signals, and outputs each of the plurality of sixth optical signals after conversion to the first transmission/reception device 100.

More specifically, the relay station DL processing unit 202 includes a first optical receiving FE unit 250, a first AD conversion unit 260, a first digital demodulation unit 270, and an optical signal output unit 290. The relay station DL processing unit 202 includes the first optical receiving FE unit 250, the first AD conversion unit 260, the first digital demodulation unit 270, and the optical signal output unit 290, thereby converting the fifth optical signal into a plurality of sixth optical signals and outputting each of the plurality of sixth optical signals after conversion to the corresponding first transmission/reception device 100.

The first optical receiving FE unit 250, the first AD conversion unit 260, the first digital demodulation unit 270, and the optical signal output unit 290 included in the relay station DL processing unit 202 will be described.

The first optical receiving FE unit 250 receives an optical signal based on the fourth optical signal output from the third transmission/reception device 300 as a fifth optical signal, and outputs a first electrical signal based on the fifth optical signal.

Specifically, the first optical receiving FE unit 250 generates four analog signals on the basis of the fifth optical signal, and outputs the generated four analog signals as first electrical signals.

Details of the first optical receiving FE unit 250 will be described later.

The first AD conversion unit 260 converts the first electrical signal output from the first optical receiving FE unit 250 into a second digital signal, and outputs the second digital signal after conversion. For example, the first AD conversion unit 260 includes four A/D converters 261, 262, 263, and 264 as illustrated in FIG. 2.

Specifically, the first AD conversion unit 260 converts each of the four analog signals, which are the first electrical signals output from the first optical receiving FE unit 250, into digital signals by a corresponding A/D converter 261, 262, 263, or 264, and outputs the four digital signals after conversion as the second digital signals.

The first digital demodulation unit 270 demodulates the second digital signal output from the first AD conversion unit 260 to generate a third digital signal, and outputs the generated third digital signal.

Specifically, the first digital demodulation unit 270 first performs polarization separation on the four digital signals that are the second digital signals output from the first AD conversion unit 260. Further, the first digital demodulation unit 270 demodulates the second digital signal by performing IQ separation on the signal after polarization separation to generate a third digital signal.

The optical signal output unit 290 generates a plurality of sixth optical signals based on the third digital signal output from the first digital demodulation unit 270. The optical signal output unit 290 outputs each of the plurality of generated sixth optical signals to the corresponding first transmission/reception device 100.

Details of the optical signal output unit 290 will be described later.

With the above configuration, the relay station DL processing unit 202 converts the fifth optical signal into a plurality of sixth optical signals, and outputs each of the plurality of sixth optical signals after conversion to the corresponding first transmission/reception device 100.

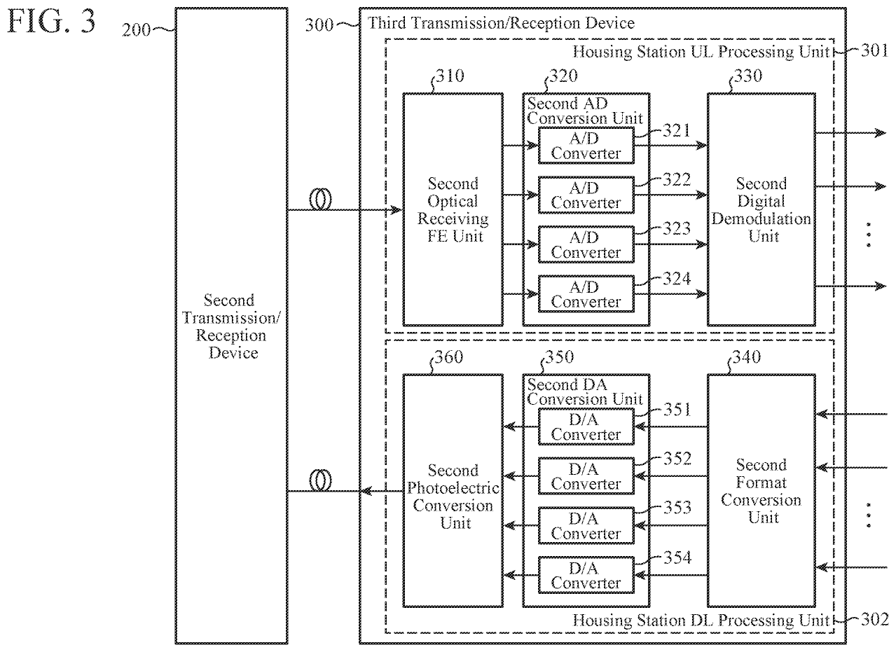

A configuration of a main part of the third transmission/reception device 300 according to the first embodiment will be described with reference to FIG. 3.

FIG. 3 is a block diagram illustrating an example of a configuration of a main part of the third transmission/reception device 300 according to the first embodiment.

The third transmission/reception device 300 includes a housing station UL processing unit 301 and a housing station DL processing unit 302.

The housing station UL processing unit 301 performs uplink (UL) side processing in the third transmission/reception device 300. That is, the housing station UL processing unit 301 performs radio signal processing in a direction from the first transmission/reception device 100 to the third transmission/reception device 300 in the third transmission/reception device 300.

Specifically, the housing station UL processing unit 301 receives an optical signal based on the first optical signal output from the second transmission/reception device 200 as a third optical signal. The housing station UL processing unit 301 demodulates the electrical signal based on the third optical signal, and outputs the electrical signal after demodulation to the outside of the transmission/reception system 1.

More specifically, the housing station UL processing unit 301 includes a second optical receiving FE unit 310, a second AD conversion unit 320, and a second digital demodulation unit 330. The housing station UL processing unit 301 includes the second optical receiving FE unit 310, the second AD conversion unit 320, and the second digital demodulation unit 330, thereby demodulating the electrical signal based on the third optical signal and outputting the electrical signal after demodulation to the outside of the transmission/reception system 1.

The second optical receiving FE unit 310, the second AD conversion unit 320, and the second digital demodulation unit 330 included in the housing station UL processing unit 301 will be described.

The second optical receiving FE unit 310 receives an optical signal based on the second optical signal output from the second transmission/reception device 200 as a third optical signal, and outputs a second electrical signal based on the third optical signal.

Specifically, the second optical receiving FE unit 310 generates four analog signals on the basis of the third optical signal, and outputs the generated four analog signals as second electrical signals.

Details of the second optical receiving FE unit 310 will be described later.

The second AD conversion unit 320 converts the second electrical signal output from the second optical receiving FE unit 310 into a fourth digital signal, and outputs the fourth digital signal after conversion. For example, the second AD conversion unit 320 includes four A/D converters 321, 322, 323, and 324 as illustrated in FIG. 3.

Specifically, the second AD conversion unit 320 converts each of the four analog signals, which are the second electrical signals output from the second optical receiving FE unit 310, into digital signals by a corresponding A/D converter 321, 322, 323, or 324, and outputs the four digital signals after conversion as the fourth digital signals.

The second digital demodulation unit 330 demodulates the fourth digital signals output from the second AD conversion unit 320 to generate a plurality of fifth digital signals, and outputs the plurality of generated fifth digital signals to the outside of the transmission/reception system 1.

Specifically, the second digital demodulation unit 330 first performs polarization separation on the four digital signals that are the fourth digital signals output from the second AD conversion unit 320. Next, the second digital demodulation unit 330 demodulates the fourth digital signal by performing IQ separation on the signal after polarization separation. The electrical signal generated by demodulating the fourth digital signal by the second digital demodulation unit 330 is a digital signal corresponding to the multiplexed signal output from the optical signal receiving unit 210 included in the relay station UL processing unit 201. Further, the second digital demodulation unit 330 separates the electrical signal generated by the demodulation into a plurality of digital signals, and outputs each of the plurality of digital signals after separation to the outside of the transmission/reception system 1 as a fifth digital signal.

Note that each of the plurality of fifth digital signals output from the second digital demodulation unit 330 is a digital signal corresponding to one of the plurality of first transmission/reception devices 100. That is, the number of fifth digital signals output from the second digital demodulation unit 330 corresponds to the number of first transmission/reception devices 100 connected to the second transmission/reception device 200 via the optical transmission line.

With the above configuration, the housing station UL processing unit 301 demodulates the electrical signal based on the third optical signal, and outputs the plurality of fifth digital signals, which are the electrical signals after demodulation, to the outside of the transmission/reception system 1.

The housing station DL processing unit 302 performs downlink (DL) side processing in the third transmission/reception device 300. That is, the housing station DL processing unit 302 performs radio signal processing in a direction from the third transmission/reception device 300 to the first transmission/reception device 100 in the third transmission/reception device 300.

Specifically, the housing station DL processing unit 302 receives a plurality of sixth digital signals input from the outside of the transmission/reception system 1. The housing station DL processing unit 302 converts the plurality of sixth digital signals into a fourth optical signal, and outputs the fourth optical signal after conversion to the second transmission/reception device 200.

More specifically, the housing station DL processing unit 302 includes a second format conversion unit 340, a second DA conversion unit 350, and a second photoelectric conversion unit 360. The housing station DL processing unit 302 includes the second format conversion unit 340, the second DA conversion unit 350, and the second photoelectric conversion unit 360, so that the housing station DL processing unit 302 converts the plurality of sixth digital signals input from the outside of the transmission/reception system 1 into the fourth optical signal and outputs the fourth optical signal after conversion to the second transmission/reception device 200.

Note that each of the plurality of sixth digital signals input from the outside of the transmission/reception system 1 to the second format conversion unit 340 is a digital signal corresponding to one of the plurality of first transmission/reception devices 100. That is, the number of sixth digital signals input from the outside of the transmission/reception system 1 to the second format conversion unit 340 corresponds to the number of first transmission/reception devices 100 connected to the second transmission/reception device 200 via the optical transmission line.

The second format conversion unit 340, the second DA conversion unit 350, and the second photoelectric conversion unit 360 included in the housing station DL processing unit 302 will be described.

The second format conversion unit 340 receives a plurality of sixth digital signals from the outside of the transmission/reception system 1, converts the plurality of sixth digital signals into a seventh digital signal in a predetermined second format, and outputs the seventh digital signal after conversion.

Specifically, first, the second format conversion unit 340 multiplexes the plurality of sixth digital signals input from the outside of the transmission/reception system 1. The second format conversion unit 340 converts an electrical signal after multiplexing into a signal format of the QAM system. More specifically, the second format conversion unit 340 converts the electrical signal after multiplexing into an I signal and a Q signal. Next, the second format conversion unit 340, after converting the sixth digital signal into an I signal and a Q signal, polarizes and separates each of the I signal and Q signal after conversion into an X polarization signal and a Y polarization signal.

As described above, the second format conversion unit 340 multiplexes the plurality of sixth digital signals input from the outside of the transmission/reception system 1, and converts the electrical signal after multiplexing into an XI signal, an XQ signal, a YI signal, and a YQ signal.

That is, the conversion into the seventh digital signal in the second format performed by the second format conversion unit 340 is to multiplex the plurality of sixth digital signals and convert the electrical signal after multiplexing into an XI signal, an XQ signal, a YI signal, and a YQ signal, and the seventh digital signal is a digital signal including four digital signals of the XI signal, the XQ signal, the YI signal, and the YQ signal.

The second format conversion unit 340 converts the sixth digital signal into the seventh digital signal in the second format including the XI signal, the XQ signal, the YI signal, and the YQ signal, so that the transmission/reception system 1 can perform transmission and reception of radio signals by the coherent detection system in the transmission and reception of the radio signals from the third transmission/reception device 300 to the second transmission/reception device 200.

Note that, the third digital signal output from the first digital demodulation unit 270 in the relay station DL processing unit 202 included in the second transmission/reception device 200 is a digital signal corresponding to the electrical signal after multiplexing of the plurality of sixth digital signals multiplexed in the second format conversion unit 340.

The second DA conversion unit 350 converts the seventh digital signal output from the second format conversion unit 340 into the second analog signal, and outputs the second analog signal after conversion. For example, the second DA conversion unit 350 includes four D/A converters 351, 352, 353, and 354 as illustrated in FIG. 3.

Specifically, the second DA conversion unit 350 converts each of the XI signal, the XQ signal, the YI signal, and the YQ signal, which are the seventh digital signals output from the second format conversion unit 340, into an analog signal by a corresponding D/A converter 351, 352, 353, or 354, and outputs the four analog signals after conversion as the second analog signals.

The second photoelectric conversion unit 360 converts the second analog signal output from the second DA conversion unit 350 into a third optical signal, and outputs the fourth optical signal after conversion toward the second transmission/reception device 200.

For example, the second photoelectric conversion unit 360 includes an addition circuit and a photoelectric converter (not illustrated in FIG. 3).

Specifically, for example, the second photoelectric conversion unit 360 first adds all the four analog signals output as the second analog signals by the second DA conversion unit 350 by the addition circuit included in the second photoelectric conversion unit 360.

Next, the second photoelectric conversion unit 360 generates a fourth optical signal by E/O converting the added analog signal by the photoelectric converter included in the second photoelectric conversion unit 360, and outputs the generated fourth optical signal.

With the above configuration, the housing station DL processing unit 302 converts the plurality of sixth digital signals input from the outside of the transmission/reception system 1 into the fourth optical signal, and outputs the fourth optical signal after conversion to the second transmission/reception device 200.

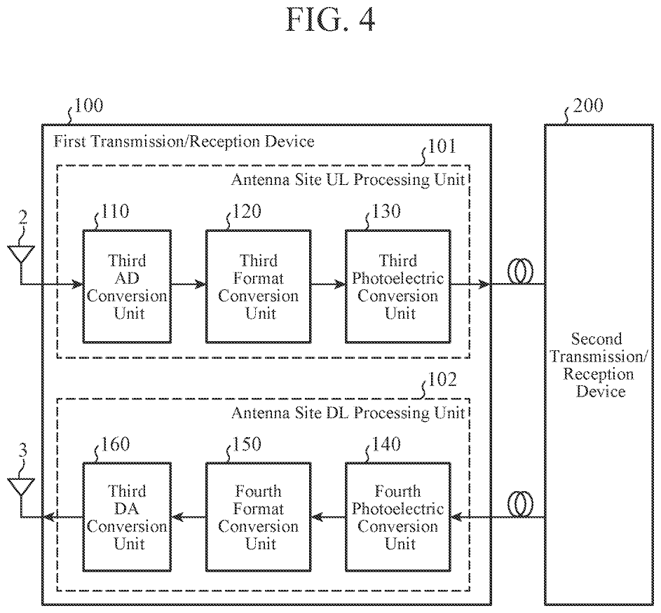

A configuration of a main part of the first transmission/reception device 100 according to the first embodiment will be described with reference to FIG. 4.

FIG. 4 is a block diagram illustrating an example of a configuration of a main part of the first transmission/reception device 100 according to the first embodiment.

The first transmission/reception device 100 includes an antenna site UL processing unit 101 and an antenna site DL processing unit 102.

The antenna site UL processing unit 101 performs uplink (UL) side processing in the first transmission/reception device 100. That is, the antenna site UL processing unit 101 performs radio signal processing in a direction from the first transmission/reception device 100 to the third transmission/reception device 300 in the first transmission/reception device 100.

Specifically, the antenna site UL processing unit 101 receives the reception radio signal output from the reception antenna 2, converts the reception radio signal into a first optical signal, and outputs the first optical signal after conversion to the second transmission/reception device 200.

More specifically, the antenna site UL processing unit 101 includes a third AD conversion unit 110, a third format conversion unit 120, and a third photoelectric conversion unit 130. The antenna site UL processing unit 101 includes the third AD conversion unit 110, the third format conversion unit 120, and the third photoelectric conversion unit 130, thereby converting the reception radio signal output from the reception antenna 2 into a first optical signal and outputting the first optical signal after conversion to the second transmission/reception device 200.

The third AD conversion unit 110, the third format conversion unit 120, and the third photoelectric conversion unit 130 included in the antenna site UL processing unit 101 will be described.

Note that, in a case where the first transmission/reception device 100 and each of the plurality of user terminals perform transmission and reception of radio signals by a radio wave using a communication system based on a digital modulation system such as an orthogonal frequency division multiplexing system, the reception radio signal output from the reception antenna 2 is an analog signal.

The third AD conversion unit 110 receives the reception radio signal from the reception antenna 2, converts the reception radio signal into an eighth digital signal, and outputs the eighth digital signal after conversion. For example, the third AD conversion unit 110 includes an A/D converter (not illustrated in FIG. 4). The third AD conversion unit 110 generates an eighth digital signal by A/D converting the reception radio signal by the A/D converter, and outputs the generated eighth digital signal.

The third format conversion unit 120 converts the eighth digital signal output from the third AD conversion unit 110 into a ninth digital signal in a predetermined third format, and outputs the ninth digital signal after conversion.

Specifically, for example, the third format conversion unit 120 performs on-off modulation on the eighth digital signal output from the third AD conversion unit 110, and converts the eighth digital signal into a ninth digital signal in an OOK format.

That is, the conversion into the ninth digital signal in the third format performed by the third format conversion unit 120 is to convert the eighth digital into a digital signal in the OOK format.

The third photoelectric conversion unit 130 converts the ninth digital signal output from the third format conversion unit 120 into a first optical signal, and outputs the first optical signal after conversion to the second transmission/reception device 200. For example, the third photoelectric conversion unit 130 includes a photoelectric converter (not illustrated in FIG. 4).

Specifically, for example, the third photoelectric conversion unit 130 generates the first optical signal by the photoelectric converter performing the E/O conversion on the ninth digital signal, and outputs the generated first optical signal to the second transmission/reception device 200.

With the above configuration, the antenna site UL processing unit 101 converts the reception radio signal output from the reception antenna 2 into the first optical signal, and outputs the first optical signal after conversion to the second transmission/reception device 200.

The antenna site DL processing unit 102 performs downlink (DL) side processing in the first transmission/reception device 100. That is, the antenna site DL processing unit 102 performs radio signal processing in a direction from the third transmission/reception device 300 to the first transmission/reception device 100 in the first transmission/reception device 100.

Specifically, the antenna site DL processing unit 102 receives the corresponding sixth optical signal among the plurality of sixth optical signals output from the second transmission/reception device 200. The antenna site DL processing unit 102 converts the sixth optical signal into a transmission radio signal and outputs the transmission radio signal after conversion to the transmission antenna 3.

More specifically, the antenna site DL processing unit 102 includes a fourth photoelectric conversion unit 140, a fourth format conversion unit 150, and a third DA conversion unit 160. The antenna site DL processing unit 102 includes the fourth photoelectric conversion unit 140, the fourth format conversion unit 150, and the third DA conversion unit 160, thereby converting the corresponding sixth optical signal among the plurality of sixth optical signals output from the second transmission/reception device 200 into a transmission radio signal and outputting the transmission radio signal after conversion to the transmission antenna 3.

The fourth photoelectric conversion unit 140, the fourth format conversion unit 150, and the third DA conversion unit 160 included in the antenna site DL processing unit 102 will be described.

The fourth photoelectric conversion unit 140 receives the sixth optical signal, converts the sixth optical signal into a tenth digital signal, and outputs the tenth digital signal after conversion. For example, the fourth photoelectric conversion unit 140 includes a photoelectric converter (not illustrated in FIG. 4).

Specifically, for example, the fourth photoelectric conversion unit 140 generates a tenth digital signal by the photoelectric converter performing O/E conversion on the sixth optical signal, and outputs the generated tenth digital signal.

The fourth format conversion unit 150 converts the tenth digital signal output from the fourth photoelectric conversion unit 140 into an eleventh digital signal in a predetermined fourth format, and outputs the eleventh digital signal after conversion.

Specifically, for example, the fourth format conversion unit 150 converts the tenth digital signal into the eleventh digital signal by performing inverse modulation of ON/OFF modulation performed by the third format conversion unit 120 on the tenth digital signal output from the fourth photoelectric conversion unit 140.

That is, the conversion into the eleventh digital signal in the fourth format performed by the fourth format conversion unit 150 is to convert the tenth digital in the OOK format into the eleventh digital signal by inverse modulation of ON/OFF modulation.

The third DA conversion unit 160 converts the eleventh digital signal output from the fourth format conversion unit 150 into a transmission radio signal, and outputs the transmission radio signal after conversion to the transmission antenna 3. For example, the third DA conversion unit 160 includes a D/A converter (not illustrated in FIG. 4). The third DA conversion unit 160 generates an analog signal by the D/A converter performing D/A conversion on the eleventh digital signal, and outputs the generated analog signal to the transmission antenna 3 as a transmission radio signal.

With the above configuration, the antenna site DL processing unit 102 converts the corresponding sixth optical signal among the plurality of sixth optical signals output from the second transmission/reception device 200 into a transmission radio signal, and outputs the transmission radio signal after conversion to the transmission antenna 3.

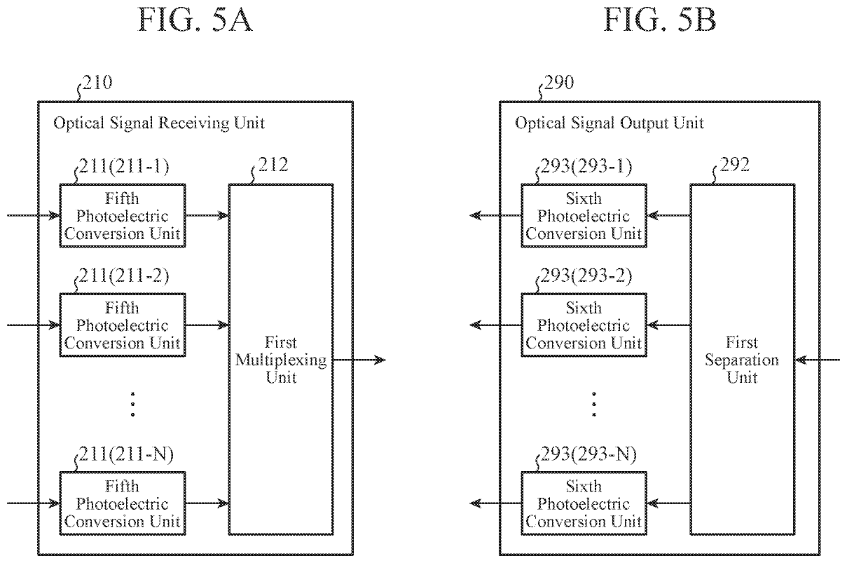

Configurations of main parts of the optical signal receiving unit 210 and the optical signal output unit 290 included in the second transmission/reception device 200 according to the first embodiment will be described with reference to FIG. 5.

FIG. 5A is a block diagram illustrating an example of a configuration of a main part of the optical signal receiving unit 210 included in the second transmission/reception device 200 according to the first embodiment.

The optical signal receiving unit 210 includes a plurality of fifth photoelectric conversion units 211 and a first multiplexing unit 212.

FIG. 5A illustrates N fifth photoelectric conversion units 211-1, 211-2, . . . , and 211-N as the plurality of fifth photoelectric conversion units 211.

Each of the plurality of fifth photoelectric conversion units 211 is connected to a corresponding first transmission/reception device 100 among the plurality of first transmission/reception devices 100 via an optical transmission line.

The N fifth photoelectric conversion units 211-1, 211-2, . . . , and 211-N illustrated in FIG. 1 correspond to the first transmission/reception devices 100-1, 100-2, . . . , and 100-N illustrated in FIG. 1, respectively.

Each of the plurality of fifth photoelectric conversion units 211 receives a first optical signal output from the corresponding first transmission/reception device 100 among the plurality of first transmission/reception devices 100, and converts the first optical signal into a third electrical signal. Each of the plurality of fifth photoelectric conversion units 211 outputs the third electrical signal after conversion.

Note that, since the first optical signal output from the antenna site UL processing unit 101, that is, the first optical signal output from the first transmission/reception device 100 is an optical signal based on the ninth digital signal in the OOK format output from the third format conversion unit 120, the third electrical signal output from each of the plurality of fifth photoelectric conversion units 211 in the relay station UL processing unit 201 included in the second transmission/reception device 200 is a digital signal corresponding to the ninth digital signal in the OOK format output from the third format conversion unit 120.

The first multiplexing unit 212 multiplexes all of the third electrical signals output from the plurality of fifth photoelectric conversion units 211 to generate a multiplexed signal, and outputs the generated multiplexed signal.

With the above configuration, the optical signal receiving unit 210 receives the first optical signal output from each of the plurality of first transmission/reception devices 100, and outputs a multiplexed signal obtained by multiplexing electrical signals based on the plurality of first optical signals.

FIG. 5B is a block diagram illustrating an example of a configuration of a main part of the optical signal output unit 290 included in the second transmission/reception device 200 according to the first embodiment.

The optical signal output unit 290 includes a first separation unit 292 and a plurality of sixth photoelectric conversion units 293.

FIG. 5B illustrates N sixth photoelectric conversion units 293-1, 293-2, . . . , and 293-N as the plurality of sixth photoelectric conversion units 293.

Each of the plurality of sixth photoelectric conversion units 293 is connected to the corresponding first transmission/reception device 100 via an optical transmission line.

Specifically, the N sixth photoelectric conversion units 293-1, 293-2, . . . , and 293-N illustrated in FIG. 5B correspond to the first transmission/reception devices 100-1, 100-2, . . . , and 100-N illustrated in FIG. 1, respectively.

The first separation unit 292 separates the third digital signal output from the first digital demodulation unit 270 into a plurality of thirteenth digital signals, and outputs the plurality of separated thirteenth digital signals after separation.

Note that each of the plurality of thirteenth digital signals output from the first separation unit 292 is a digital signal corresponding to the tenth digital signal output from the fourth photoelectric conversion unit 140 included in the corresponding first transmission/reception device 100 among the plurality of first transmission/reception devices 100.

Each of the plurality of sixth photoelectric conversion units 293 converts the corresponding thirteenth digital signal among the plurality of thirteenth digital signals output from the first separation unit 292 into a sixth optical signal, and outputs the sixth optical signal after conversion to the corresponding first transmission/reception device 100. For example, each of the plurality of sixth photoelectric conversion units 293 includes a photoelectric converter (not illustrated in FIG. 5B).

Specifically, for example, each of the plurality of sixth photoelectric conversion units 293 generates a sixth optical signal by the photoelectric converter performing E/O conversion on the thirteenth digital signal, and outputs the generated sixth optical signal to the second transmission/reception device 200.

With the above configuration, the optical signal output unit 290 outputs each of the plurality of sixth optical signals based on the third digital signal output from the first digital demodulation unit 270 to the corresponding first transmission/reception device 100.

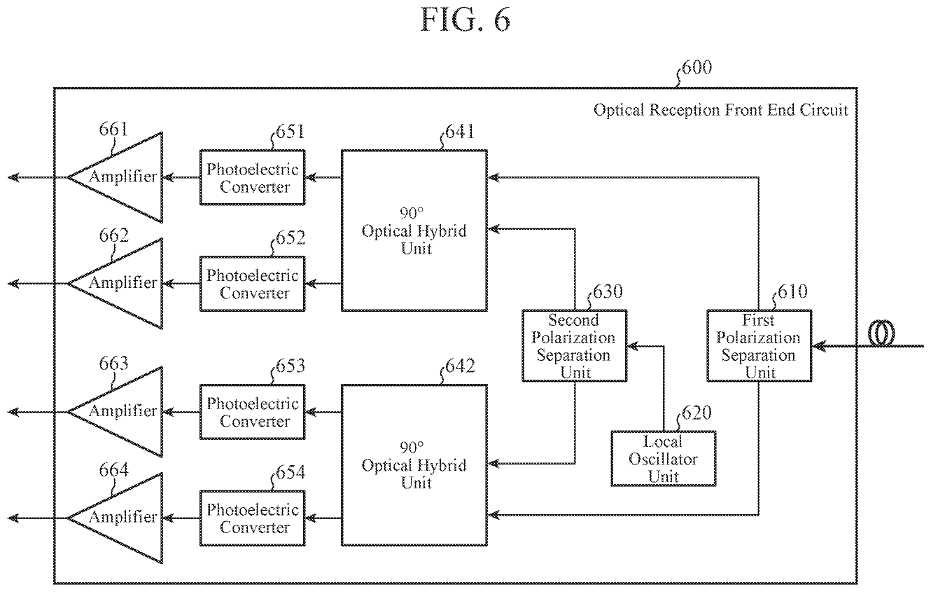

With reference to FIG. 6, the configurations of the main parts of the first optical receiving FE unit 250 included in the second transmission/reception device 200 according to the first embodiment and the second optical receiving FE unit 310 included in the third transmission/reception device 300 according to the first embodiment will be described.

FIG. 6 is a block diagram illustrating an example of a configuration of a main part of an optical reception front end circuit 600 according to the first embodiment.

Each of the first optical receiving FE unit 250 and the second optical receiving FE unit 310 includes an optical reception front end circuit 600 illustrated in FIG. 6 as an example.

The optical reception front end circuit 600 includes a first polarization separation unit 610, a local oscillator unit 620, a second polarization separation unit 630, two 90° optical hybrid units 641 and 642, four photoelectric converters 651, 652, 653, and 654, and four amplifiers 661, 662, 663, and 664.

The first polarization separation unit 610 receives an optical signal input from the outside of the optical reception front end circuit 600, and separates the optical signal into two signals by separating polarized waves of the optical signal. The first polarization separation unit 610 outputs the separated two signals after the separation.

The first polarization separation unit 610 includes, for example, a polarizing beam splitter (PBS).

The local oscillator unit 620 generates a signal for coherently receiving an optical signal input from the outside of the optical reception front end circuit 600, and outputs the generated signal. The local oscillator unit 620 includes an oscillation circuit and the like. Hereinafter, the signal output from the local oscillator unit 620 is referred to as an oscillation signal.

The second polarization separation unit 630 receives the oscillation signal output from the local oscillator unit 620, and separates the oscillation signal into two signals by separating the polarization of the oscillation signal. The second polarization separation unit 630 outputs the separated two signals after the separation.

The second polarization separation unit 630 includes, for example, a polarization beam splitter.

The 90° optical hybrid unit 641 receives one of the two signals output from the first polarization separation unit 610 and one of the two signals output from the second polarization separation unit 630, divides the signal output from the first polarization separation unit 610 into two signals, and outputs the two signals after shifting phases of the two signals after the division by 90° from each other.

The 90° optical hybrid unit 642 receives the other of the two signals output from the first polarization separation unit 610 and the other of the two signals output from the second polarization separation unit 630, divides the signal output from the first polarization separation unit 610 into two signals, and outputs the two signals after shifting phases of the two signals after the division by 90° from each other.

The 90° optical hybrid unit 641 and the 90° optical hybrid unit 642 are configured by a well-known 90° optical hybrid circuit. Since the 90° optical hybrid circuit is well known, the description thereof will be omitted.

Each of the four photoelectric converters 651, 652, 653, and 654 receives a corresponding signal among the signals output from the 90° optical hybrid unit 641 or the 90° optical hybrid unit 642, converts the signal into an electrical signal by O/E conversion, and outputs the electrical signal after conversion. Note that the electrical signal output from each of the four photoelectric converters 651, 652, 653, and 654 is an analog signal.

Each of the four amplifiers 661, 662, 663, and 664 amplifies the electrical signal output from the corresponding photoelectric converter 651, 652, 653, 654 among the four photoelectric converters 651, 652, 653, and 654, and outputs the amplified electrical signal. Needless to say, the electrical signal output from each of the four amplifiers 661, 662, 663, and 664 is an analog signal.

By configuring the first optical receiving FE unit 250 and the second optical receiving FE unit 310 using the optical reception front end circuit 600 illustrated in FIG. 6 as an example, the first optical receiving FE unit 250 receives the signal as a fifth optical signal and outputs a first electrical signal based on the fifth optical signal, and the second optical receiving FE unit 310 receives the signal as a third optical signal and outputs a second electrical signal based on the third optical signal.

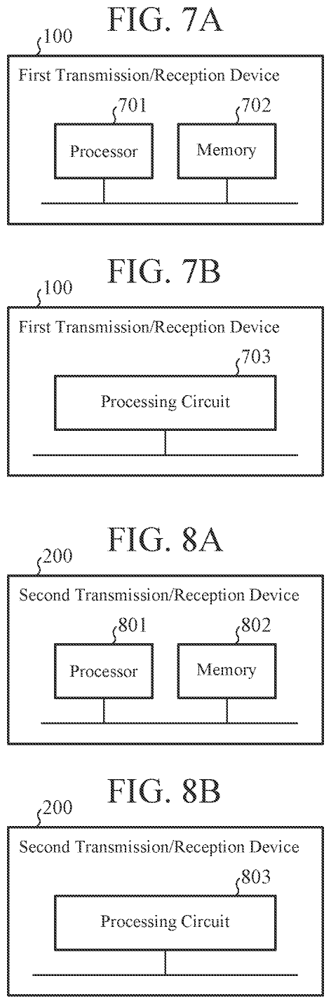

A hardware configuration of the first transmission/reception device 100 according to the first embodiment will be described with reference to FIG. 7.

FIGS. 7A and 7B are diagrams illustrating an example of a hardware configuration of the first transmission/reception device 100 according to the first embodiment.

The processing of the first transmission/reception device 100 is executed by the hardware configuration illustrated in FIG. 7A or 7B except for the processing from reception of the optical signal to conversion of the optical signal into the electrical signal and the processing from conversion of the electrical signal into the optical signal to output of the optical signal.

As illustrated in FIG. 7A, a part of the first transmission/reception device 100 is configured by a computer, and the computer includes a processor 701 and a memory 702.

Further, as illustrated in FIG. 7B, a part of the first transmission/reception device 100 may include a processing circuit 703.

Furthermore, a part of the first transmission/reception device 100 may include the processor 701, the memory 702, and the processing circuit 703 (not illustrated).

The processor 701 uses, for example, a central processing unit (CPU), a graphics processing unit (GPU), a microprocessor, a microcontroller, or a digital signal processor (DSP).

The memory 702 uses, for example, a semiconductor memory or a magnetic disk. More specifically, the memory 702 uses, for example, a random access memory (RAM), a read only memory (ROM), a flash memory, an erasable programmable read only memory (EPROM), an electrically erasable programmable read-only memory (EEPROM), a solid state drive (SSD), or a hard disk drive (HDD).

The processing circuit 703 uses, for example, an application specific integrated circuit (ASIC), a programmable logic device (PLD), a field-programmable gate array (FPGA), a system-on-a-chip (SoC), or a system large-scale integration (LSI).

A hardware configuration of the second transmission/reception device 200 according to the first embodiment will be described with reference to FIG. 8.

FIGS. 8A and 8B are diagrams illustrating an example of a hardware configuration of the second transmission/reception device 200 according to the first embodiment.

The processing of the second transmission/reception device 200 is executed by the hardware configuration illustrated in FIG. 8A or 8B except for processing from reception of an optical signal to conversion of the optical signal into an electrical signal and processing from conversion of the electrical signal into the optical signal to output of the optical signal.

As illustrated in FIG. 8A, a part of the second transmission/reception device 200 is configured by a computer, and the computer includes a processor 801 and a memory 802.

In addition, as illustrated in FIG. 8B, a part of the second transmission/reception device 200 may include a processing circuit 803.

Furthermore, a part of the second transmission/reception device 200 may include the processor 801, the memory 802, and the processing circuit 803 (not illustrated).

Note that, the processor 801, the memory 802, and the processing circuit 803 are similar to the processor 701, the memory 702, and the processing circuit 703 illustrated in FIG. 7, respectively, and thus description of the processor 801, the memory 802, and the processing circuit 803 is omitted.

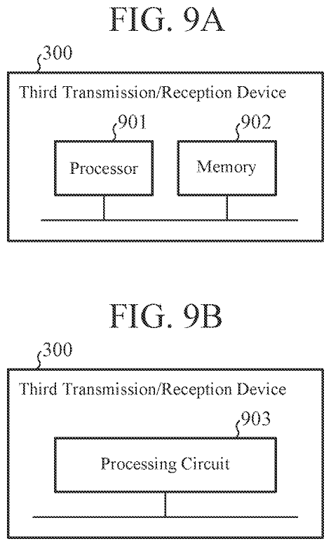

A hardware configuration of the third transmission/reception device 300 according to the first embodiment will be described with reference to FIG. 9.

FIGS. 9A and 9B are diagrams illustrating an example of a hardware configuration of the third transmission/reception device 300 according to the first embodiment.

The processing of the third transmission/reception device 300 is executed by the hardware configuration illustrated in FIG. 9A or 9B except for the processing from the reception of the optical signal to the conversion of the optical signal into the electrical signal and the processing from the conversion of the electrical signal into the optical signal to the output of the optical signal.

As illustrated in FIG. 9A, a part of the third transmission/reception device 300 is configured by a computer, and the computer includes a processor 901 and a memory 902.

Further, as illustrated in FIG. 9B, a part of the third transmission/reception device 300 may include a processing circuit 903.

Furthermore, a part of the third transmission/reception device 300 may include the processor 901, the memory 902, and the processing circuit 903 (not illustrated).

Note that the processor 901, the memory 902, and the processing circuit 903 are similar to the processor 701, the memory 702, and the processing circuit 703 illustrated in FIG. 7, respectively, and thus description of the processor 901, the memory 902, and the processing circuit 903 is omitted.

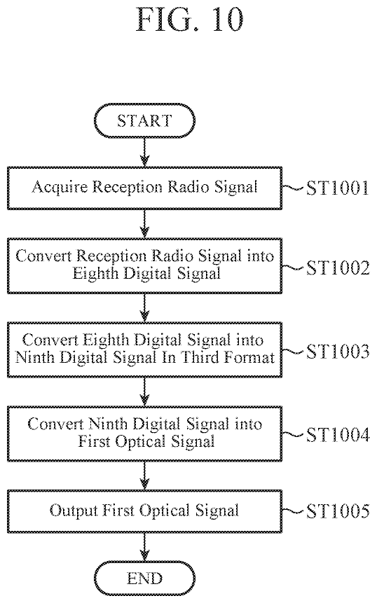

The operation of the transmission/reception system 1 according to the first embodiment will be described with reference to FIGS. 10 to 15.

The uplink side operation in the first transmission/reception device 100 according to the first embodiment will be described with reference to FIG. 10.

FIG. 10 is a flowchart illustrating an example of uplink side processing in the first transmission/reception device 100 according to the first embodiment.

First, in step ST1001, the third AD conversion unit 110 acquires a reception radio signal.

Next, in step ST1002, the third AD conversion unit 110 converts the reception radio signal into an eighth digital signal and outputs the eighth digital signal.

Next, in step ST1003, the third format conversion unit 120 converts the eighth digital signal into a ninth digital signal in the third format and outputs the ninth digital signal.

Next, in step ST1004, the third photoelectric conversion unit 130 converts the ninth digital signal into the first optical signal.

Next, in step ST1005, the third photoelectric conversion unit 130 outputs the first optical signal.

After step ST1005, the first transmission/reception device 100 ends the processing of the flowchart. After ending the processing of the flowchart, the first transmission/reception device 100 returns to step ST1001 and repeatedly executes the processing of the flowchart.

Note that, the first transmission/reception device 100 can execute each processing from step ST1001 to step ST1005 in parallel. Specifically, the first transmission/reception device 100 executes processing from step ST1002 to step ST1005 in parallel on a first in first out (FIFO) basis for the reception radio signal acquired in step ST1001.

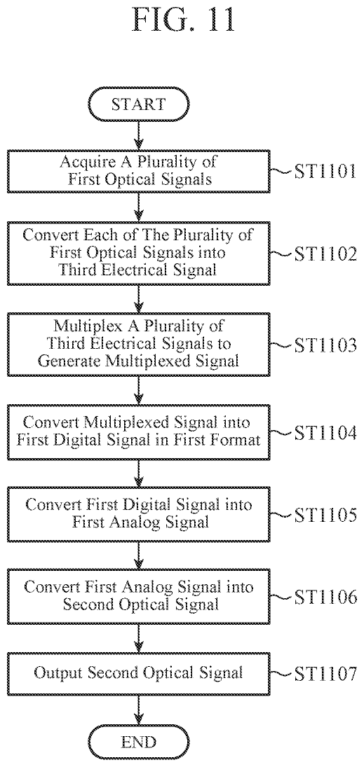

The uplink side operation in the second transmission/reception device 200 according to the first embodiment will be described with reference to FIG. 11.

FIG. 11 is a flowchart illustrating an example of uplink side processing in the second transmission/reception device 200 according to the first embodiment.

After the first transmission/reception device 100 executes the processing of the flowchart illustrated in FIG. 10, the second transmission/reception device 200 executes the processing of the flowchart illustrated in FIG. 11.

After the first transmission/reception device 100 executes the processing in step ST1005 illustrated in FIG. 10, first, in step ST1101, the plurality of fifth photoelectric conversion units 211 included in the optical signal receiving unit 210 acquires the plurality of first optical signals.

Next, in step ST1102, the plurality of fifth photoelectric conversion units 211 included in the optical signal receiving unit 210 convert each of the plurality of first optical signals into a third electrical signal and outputs the third electrical signal.

Next, in step ST1103, the first multiplexing unit 212 included in the optical signal receiving unit 210 multiplexes the plurality of third electrical signals to generate a multiplexed signal, and outputs the multiplexed signal.

Next, in step ST1104, the first format conversion unit 220 converts the multiplexed signal into a first digital signal in the first format and outputs the first digital signal.

Next, in step ST1105, the first DA conversion unit 230 converts the first digital signal into a first analog signal and outputs the first analog signal.

Next, in step ST1106, the first photoelectric conversion unit 240 converts the first analog signal into the second optical signal.

Next, in step ST1107, the first photoelectric conversion unit 240 outputs the second optical signal.

After step ST1107, the second transmission/reception device 200 ends the processing of the flowchart. After ending the processing of the flowchart, the second transmission/reception device 200 returns to step ST1101 and repeatedly executes the processing of the flowchart.

Note that, the second transmission/reception device 200 can execute each processing from step ST1101 to step ST1107 in parallel. Specifically, the second transmission/reception device 200 executes processing from step ST1102 to step ST1107 in parallel on the FIFO basis for the plurality of first optical signals acquired in step ST1101.

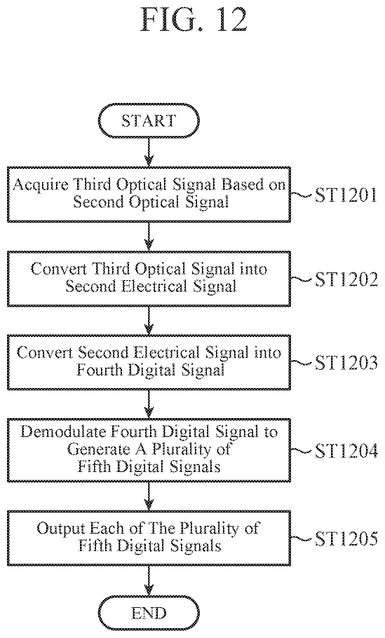

The uplink side operation in the third transmission/reception device 300 according to the first embodiment will be described with reference to FIG. 12.

FIG. 12 is a flowchart illustrating an example of uplink side processing in the third transmission/reception device 300 according to the first embodiment.

The third transmission/reception device 300 executes the processing of the flowchart illustrated in FIG. 12 after the second transmission/reception device 200 executes the processing of the flowchart illustrated in FIG. 11.

After the second transmission/reception device 200 executes the processing in step ST1107 illustrated in FIG. 11, first, in step ST1201, the second optical receiving FE unit 310 acquires the third optical signal based on the second optical signal.

Next, in step ST1202, the second optical receiving FE unit 310 converts the third optical signal into a second electrical signal and outputs the second electrical signal.

Next, in step ST1203, the second AD conversion unit 320 converts the second electrical signal into a fourth digital signal and outputs the fourth digital signal.

Next, in step ST1204, the second digital demodulation unit 330 demodulates the fourth digital signal to generate a plurality of fifth digital signals.

Next, in step ST1205, the second digital demodulation unit 330 outputs each of the plurality of fifth digital signals.

After step ST1205, the third transmission/reception device 300 ends the processing of the flowchart. After ending the processing of the flowchart, the third transmission/reception device 300 returns to step ST1201 and repeatedly executes the processing of the flowchart.

Note that, the third transmission/reception device 300 can execute each processing from step ST1201 to step ST1205 in parallel. Specifically, the third transmission/reception device 300 executes processing from step ST1202 to step ST1205 in parallel on the FIFO basis for the third optical signal acquired in step ST1201.

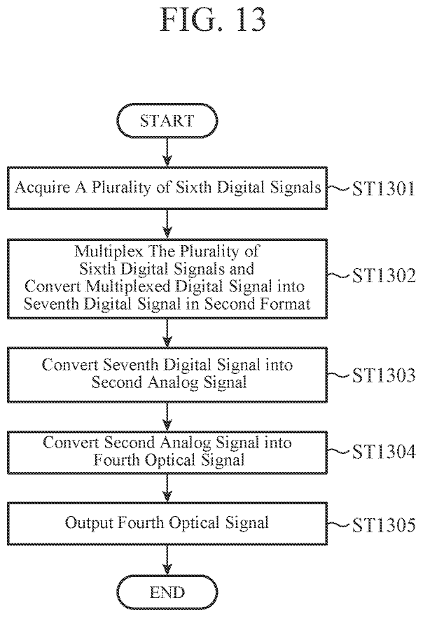

The downlink side operation in the third transmission/reception device 300 according to the first embodiment will be described with reference to FIG. 13.

FIG. 13 is a flowchart illustrating an example of downlink side processing in the third transmission/reception device 300 according to the first embodiment.

First, in step ST1301, the second format conversion unit 340 acquires a plurality of sixth digital signals.

Next, in step ST1302, the second format conversion unit 340 multiplexes the plurality of sixth digital signals, converts the multiplexed digital signal into a seventh digital signal in the second format, and outputs the seventh digital signal.

Next, in step ST1303, the second DA conversion unit 350 converts the seventh digital signal into a second analog signal and outputs the second analog signal.

Next, in step ST1304, the second photoelectric conversion unit 360 converts the second analog signal into a fourth optical signal.

Next, in step ST1305, the second photoelectric conversion unit 360 outputs the fourth optical signal.

After step ST1305, the third transmission/reception device 300 ends the processing of the flowchart. After ending the processing of the flowchart, the third transmission/reception device 300 returns to step ST1301 and repeatedly executes the processing of the flowchart.

Note that, the third transmission/reception device 300 can execute each processing from step ST1301 to step ST1305 in parallel. Specifically, the third transmission/reception device 300 executes processing from step ST1302 to step ST1305 in parallel on the FIFO basis for the plurality of sixth digital signals acquired in step ST1301.

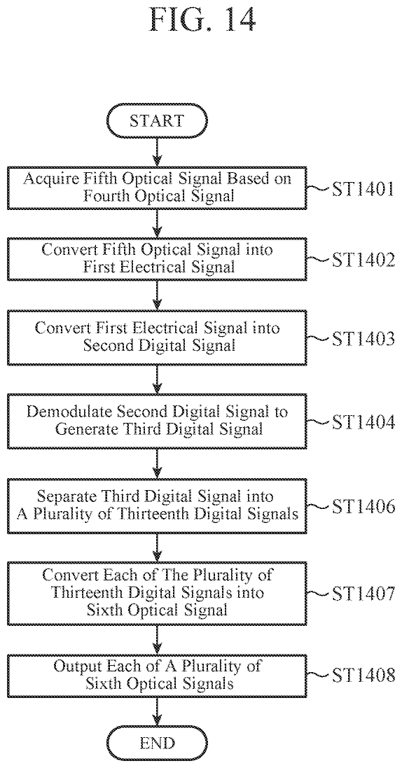

The downlink side operation in the second transmission/reception device 200 according to the first embodiment will be described with reference to FIG. 14.

FIG. 14 is a flowchart illustrating an example of downlink side processing in the second transmission/reception device 200 according to the first embodiment.

After the third transmission/reception device 300 executes the processing of the flowchart illustrated in FIG. 13, the second transmission/reception device 200 executes the processing of the flowchart illustrated in FIG. 14.

After the third transmission/reception device 300 executes the processing in step ST1305 illustrated in FIG. 13, first, in step ST1401, the first optical receiving FE unit 250 acquires the fifth optical signal based on the fourth optical signal.

Next, in step ST1402, the first optical receiving FE unit 250 converts the fifth optical signal into a first electrical signal and outputs the first electrical signal.

Next, in step ST1403, the first AD conversion unit 260 converts the first electrical signal into a second digital signal and outputs the second digital signal.

Next, in step ST1404, the first digital demodulation unit 270 demodulates the second digital signal to generate a third digital signal, and outputs the third digital signal.

Next, in step ST1406, the first separation unit 292 included in the optical signal output unit 290 separates the third digital signal into a plurality of thirteenth digital signals and outputs the plurality of thirteenth digital signals.

Next, in step ST1407, the plurality of sixth photoelectric conversion units 293 included in the optical signal output unit 290 convert each of the plurality of thirteenth digital signals into a sixth optical signal.

Next, in step ST1408, the plurality of sixth photoelectric conversion units 293 included in the optical signal output unit 290 output each of the plurality of sixth optical signals.

After step ST1408, the second transmission/reception device 200 ends the processing of the flowchart. After ending the processing of the flowchart, the second transmission/reception device 200 returns to step ST1401 and repeatedly executes the processing of the flowchart.

Note that, the second transmission/reception device 200 can execute each processing from step ST1401 to step ST1408 in parallel. Specifically, the second transmission/reception device 200 executes processing from step ST1402 to step ST1408 in parallel on the FIFO basis for the fifth optical signal acquired in step ST1401.

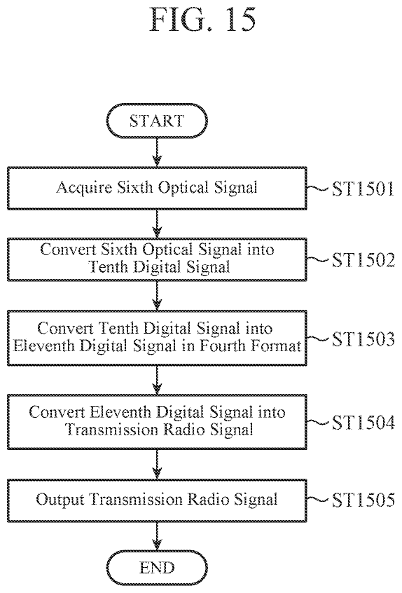

The downlink side operation in the first transmission/reception device 100 according to the first embodiment will be described with reference to FIG. 15.

FIG. 15 is a flowchart illustrating an example of downlink side processing in the first transmission/reception device 100 according to the first embodiment.

After the second transmission/reception device 200 executes the processing of the flowchart illustrated in FIG. 14, the first transmission/reception device 100 executes the processing of the flowchart illustrated in FIG. 15.

After the second transmission/reception device 200 executes the processing in step ST1408 illustrated in FIG. 14, first, in step ST1501, the fourth photoelectric conversion unit 140 acquires the sixth optical signal.

Next, in step ST1502, the fourth photoelectric conversion unit 140 converts the sixth optical signal into a tenth digital signal and outputs the tenth digital signal.

Next, in step ST1503, the fourth format conversion unit 150 converts the tenth digital signal into an eleventh digital signal in the fourth format, and outputs the eleventh digital signal.

Next, in step ST1504, the third DA conversion unit 160 converts the eleventh digital signal into a transmission radio signal.

Next, in step ST1505, the third DA conversion unit 160 outputs the transmission radio signal.

After step ST1505, the first transmission/reception device 100 ends the processing of the flowchart. After ending the processing of the flowchart, the first transmission/reception device 100 returns to step ST1501 and repeatedly executes the processing of the flowchart.

Note that the first transmission/reception device 100 can execute the processing from step ST1501 to step ST1505 in parallel. Specifically, the first transmission/reception device 100 executes processing from step ST1502 to step ST1505 in parallel on the FIFO basis for the sixth optical signal acquired in step ST1501.

With the above configuration, the transmission/reception system 1 can perform transmission and reception of radio signals by the coherent detection system between the second transmission/reception device 200 and the third transmission/reception device 300.

Hereinafter, performance of the transmission/reception system 1 according to the first embodiment and performance of a conventional transmission/reception system (hereinafter, referred to as a “conventional transmission/reception system”) will be compared and described.

Hereinafter, the comparison is performed on the premise of the following conditions.

The second transmission/reception device 200 performs transmission and reception of radio signals to and from 40 user terminals via the plurality of first transmission/reception devices 100.

In addition, the radio signal transmitted and received between the second transmission/reception device 200 and each of the plurality of first transmission/reception devices 100 (hereinafter, referred to as “between the first and second transmission/reception devices”) is assumed to be 256 QAM/symbol. Assuming that the frequency band of the radio signal between the first and second transmission/reception devices is 1.25 GHz, a radio signal of 1.25 Gsymbols per second (GSymbol/Sec) is transmitted and received between the first and second transmission/reception devices.

256 QAM is a data length of 8 bits, and the second transmission/reception device 200 performs transmission and reception of radio signals to and from 40 user terminals via the plurality of first transmission/reception devices 100. Thus, in the second transmission/reception device 200, processing of radio signals of 1.25 (GSymbol/Sec)×40 (channels)×8 (bits)=400 gigabits per second (Gbps) is performed.

The conventional transmission/reception system performs transmission and reception of radio signals of 400 gigabits (Gbit) between the transmission/reception device (hereinafter, referred to as a “relay station device”) installed in the relay station and the transmission/reception device (hereinafter, referred to as a “housing station device”) installed in the housing station (hereinafter, referred to as “between the relay station device and the housing station device”).

Since the frequency band of the relay station device and the housing station device included in the conventional transmission/reception system is 50 GHz=1.25 GHz/ch×40 ch, the A/D converter included in the relay station device or the housing station device requires performance of at least 100 GSample/Sec as a sampling rate.

In addition, since the radio signals of the relay station device and the housing station device are 256 QAM having an 8-bit length, each of the A/D converters included in the relay station device and the housing station device requires performance of at least 16 bits/sample as bit resolution.

Similarly, since the frequency band of the radio signal of each of the second transmission/reception device 200 and the third transmission/reception device 300 is 50 GHz=1.25 GHz/ch×40 ch, each of the A/D converters 261, 262, 263, 264, 321, 322, 323, and 324 included in the second transmission/reception device 200 or the third transmission/reception device 300 requires performance of at least 100 GSample/Sec as a sampling rate.

On the other hand, since the second transmission/reception device 200 and the third transmission/reception device 300 included in the transmission/reception system 1 separate the QAM radio signal into the four signals of the XI signal, the XQ signal, the YI signal, and the YQ signal, when the QAM radio signal is 256 QAM, each of the XI signal, the XQ signal, the YI signal, and the YQ signal is a 16 QAM signal having a data length of 4 bits.

Then, since each of the XI signal, the XQ signal, the YI signal, and the YQ signal in the second transmission/reception device 200 and the third transmission/reception device 300 is 16 QAM having a 4-bit length, it is sufficient that each of the A/D converters 261, 262, 263, 264, 321, 322, 323, and 324 included in the second transmission/reception device 200 or the third transmission/reception device 300 has performance of at least 8 bits/sample as bit resolution.

The basic performance of the A/D converter is determined by the product of the sampling rate and the bit resolution. Therefore, it is sufficient that the basic performance required for each of the A/D converters 261, 262, 263, 264, 321, 322, 323, and 324 included in the second transmission/reception device 200 or the third transmission/reception device 300 is half the basic performance of the A/D converter included in the relay station device and the housing station device in the conventional transmission/reception system.

In other words, even if the transmission/reception system 1 is constructed using the A/D converter having the similar performance indices, the transmission/reception system 1 according to the first embodiment can perform the radio signal transmission of the QAM system having a higher multivalued degree, as compared with the conventional transmission/reception system, in the transmission and reception of the radio signals between the second transmission/reception device 200 and the third transmission/reception device 300 (hereinafter, referred to as “between the second and third transmission/reception devices”).

Note that, since the transmission and reception of the radio signals between the second and third transmission/reception devices are performed by the coherent detection system, it is preferable that the second transmission/reception device 200 and the third transmission/reception device 300 add redundancy such as predetermined overhead or error correction code to the radio signals to be transmitted and received between the second and third transmission/reception devices, and transmit and receive the added radio signals between the second and third transmission/reception devices.

Assuming that the redundancy is 20%, the transmission/reception system 1 performs transmission and reception of the radio signals of 480 gigabits (Gb) between the second and third transmission/reception devices. Even in this case, the required bit resolution remains 8 bit/Sample in each of the A/D converters 261, 262, 263, 264, 321, 322, 323, and 324, and only the sampling rate is 120 GSample/Sec.

Therefore, even in this case, it is sufficient that the basic performance required for each of the A/D converters 261, 262, 263, 264, 321, 322, 323, and 324 included in the second transmission/reception device 200 or the third transmission/reception device 300 is 60% of, which is half, the basic performance of the A/D converter included in the relay station device and the housing station device in the conventional transmission/reception system.

As described above, even in this case, the transmission/reception system 1 according to the first embodiment can perform the radio signal transmission of the QAM system having a higher multivalued degree as compared with the conventional transmission/reception system constructed using the A/D converter having the similar performance indices.

As described above, the transmission/reception system 1 according to the first embodiment is the transmission/reception system 1 that performs transmission and reception of radio signals in one-to-many connection between the third transmission/reception device 300 and a plurality of user terminals by performing the transmission and reception of the radio signals via an optical transmission line between the first transmission/reception device 100 installed at each of a plurality of antenna sites and a second transmission/reception device 200 installed in a relay station building and between the second transmission/reception device 200 and the third transmission/reception device 300 installed in a housing station building, in which the second transmission/reception device 200 includes: a relay station UL processing unit 201 including: an optical signal receiving unit 210 to receive a first optical signal output from each of the plurality of first transmission/reception devices 100 and output a multiplexed signal obtained by multiplexing a plurality of electrical signals based on the plurality of first optical signals; the first format conversion unit 220 to convert the multiplexed signal output from the optical signal receiving unit 210 into a first digital signal in a predetermined first format and output the first digital signal after conversion; the first DA conversion unit 230 to convert the first digital signal output from the first format conversion unit 220 into a first analog signal and output the first analog signal after conversion; and the first photoelectric conversion unit 240 to convert the first analog signal output from the first DA conversion unit 230 into a second optical signal and output the second optical signal after conversion; and the relay station DL processing unit 202 including: the first optical receiving FE unit 250 to receive an optical signal based on a fourth optical signal output from the third transmission/reception device 300 as a fifth optical signal and output a first electrical signal based on the fifth optical signal; the first AD conversion unit 260 to convert the first electrical signal output from the first optical receiving FE unit 250 into a second digital signal and output the second digital signal after conversion; the first digital demodulation unit 270 to demodulate the second digital signal output from the first AD conversion unit 260 to generate a third digital signal and outputs the generated third digital signal; and the optical signal output unit 290 to output each of a plurality of sixth optical signals based on the third digital signal output from the first digital demodulation unit 270 to a corresponding first transmission/reception device 100, and in which the third transmission/reception device 300 includes: the housing station UL processing unit 301 including: the second optical receiving FE unit 310 to receive an optical signal based on the second optical signal output from the second transmission/reception device 200 as a third optical signal and output a second electrical signal based on the third optical signal; the second AD conversion unit 320 to convert the second electrical signal output from the second optical receiving FE unit 310 into a fourth digital signal and output the fourth digital signal after conversion; and the second digital demodulation unit 330 to demodulate the fourth digital signal output from the second AD conversion unit 320 to generate a plurality of fifth digital signals and output the plurality of generated fifth digital signals; and the housing station DL processing unit 302 including: the second format conversion unit 340 to receive a plurality of sixth digital signals, convert the plurality of sixth digital signals into a seventh digital signal in a predetermined second format, and output the seventh digital signal after conversion; the second DA conversion unit 350 to convert the seventh digital signal output from the second format conversion unit 340 into a second analog signal, and output the second analog signal after conversion; and the second photoelectric conversion unit 360 to convert the second analog signal output from the second DA conversion unit 350 into the fourth optical signal, and output the fourth optical signal after conversion.

With such a configuration, even if the transmission/reception system 1 according to the first embodiment is constructed using the A/D converter having the similar performance indices, the transmission/reception system 1 can perform the radio signal transmission of the QAM system having a higher multivalued degree as compared with the conventional transmission/reception system.

In particular, in the transmission and reception of radio signals between the second transmission/reception device 200 and the third transmission/reception device 300, the transmission/reception system 1 according to the first embodiment can perform radio signal transmission of the QAM system having a higher multivalued degree as compared with the conventional transmission/reception system.

In addition, in the transmission/reception system 1 according to the first embodiment, in the above-described configuration, the first format conversion unit 220 included in the second transmission/reception device 200 and the second format conversion unit 340 included in the third transmission/reception device 300 are configured to convert radio signals into digital signals in a format that causes the second transmission/reception device 200 and the third transmission/reception device 300 to mutually perform transmission and reception of radio signals by the coherent detection system in the transmission and reception of radio signals between the second transmission/reception device 200 and the third transmission/reception device 300.

With such a configuration, even if the transmission/reception system 1 according to the first embodiment is constructed using the A/D converter having the similar performance indices, the transmission/reception system 1 can perform the radio signal transmission of the QAM system having a higher multivalued degree as compared with the conventional transmission/reception system.

In particular, in the transmission and reception of radio signals between the second transmission/reception device 200 and the third transmission/reception device 300, the transmission/reception system 1 according to the first embodiment can perform radio signal transmission of the QAM system having a higher multivalued degree as compared with the conventional transmission/reception system.

Second Embodiment.

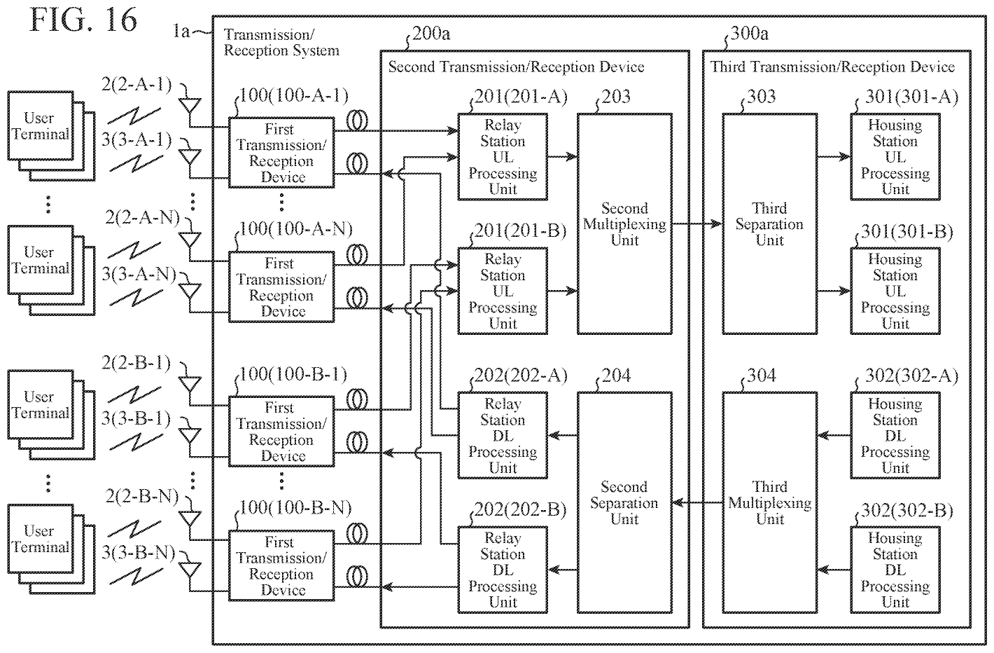

A transmission/reception system 1a according to a second embodiment will be described with reference to FIGS. 16 to 20.

A configuration of a main part of the transmission/reception system 1a according to the second embodiment will be described with reference to FIG. 16.

FIG. 16 is a block diagram illustrating an example of a configuration of a main part of the transmission/reception system 1a according to the second embodiment.

The transmission/reception system 1a includes a plurality of first transmission/reception devices 100, a second transmission/reception device 200a, and a third transmission/reception device 300a.

The transmission/reception system 1a is different from the transmission/reception system 1 according to the first embodiment in that the second transmission/reception device 200 and the third transmission/reception device 300 included in the transmission/reception system 1 according to the first embodiment are changed to the second transmission/reception device 200a and the third transmission/reception device 300a.

In FIG. 16, the same components as those illustrated in FIG. 1, FIG. 2, or FIG. 3 are denoted by the same reference numerals, and description thereof is omitted.

Each of the plurality of first transmission/reception devices 100 included in the transmission/reception system 1a according to the second embodiment is similar to the first transmission/reception device 100 according to the first embodiment.

FIG. 16 illustrates N first transmission/reception devices 100-A-1, . . . , and 100-A-N and N first transmission/reception devices 100-B-1, . . . , and 100-B-N as the plurality of first transmission/reception devices 100.

Each of the plurality of first transmission/reception devices 100 is connected to a reception antenna 2 and a transmission antenna 3.

FIG. 16 illustrates the reception antennas 2-A-1, . . . , and 2-A-N and the transmission antennas 3-A-1, . . . , and 3-A-N to which the N first transmission/reception devices 100-A-1, . . . , and 100-A-N are respectively connected, and the reception antennas 2-B -1, . . . , and 2-B-N and the transmission antennas 3-B-1, . . . , and 3-B-N to which the N first transmission/reception devices 100-B-1, . . . , and 100-B-N are respectively connected.

The second transmission/reception device 200a included in the transmission/reception system 1a according to the second embodiment includes a second multiplexing unit 203, a second separation unit 204, a plurality of relay station UL processing units 201, and a plurality of relay station DL processing units 202.

Each of the plurality of relay station UL processing units 201 included in the second transmission/reception device 200a according to the second embodiment is similar to the relay station UL processing unit 201 included in the second transmission/reception device 200 according to the first embodiment.

In addition, each of the plurality of relay station DL processing units 202 included in the second transmission/reception device 200a according to the second embodiment is similar to the relay station DL processing unit 202 included in the second transmission/reception device 200 according to the first embodiment.

FIG. 16 illustrates a second transmission/reception device 200a including two relay station UL processing units 201-A and 201-B and two relay station DL processing units 202-A and 202-B as an example of the plurality of relay station UL processing units 201 and the plurality of relay station DL processing units 202.

The number of the relay station UL processing units 201 included in the second transmission/reception device 200a is not limited to two, and may be three or more. In addition, the number of relay station DL processing units 202 included in the second transmission/reception device 200a is not limited to two, and may be three or more.

Each of the plurality of relay station UL processing units 201 included in the second transmission/reception device 200a and each of the plurality of relay station DL processing units 202 included in the second transmission/reception device 200a are connected to the corresponding first transmission/reception device 100 among the plurality of first transmission/reception devices 100.

The N first transmission/reception devices 100-A-1, . . . , and 100-A-N illustrated in FIG. 16 are connected to the relay station UL processing unit 201-A and the relay station DL processing unit 202-A included in the second transmission/reception device 200a via an optical transmission line. In addition, the N first transmission/reception devices 100-B-1, . . . , and 100-B-N illustrated in FIG. 16 are connected to the relay station UL processing unit 201-B and the relay station DL processing unit 202-B included in the second transmission/reception device 200a via an optical transmission line.

The second multiplexing unit 203 included in the second transmission/reception device 200a receives the second optical signal output from each of the plurality of relay station UL processing units 201. The second multiplexing unit 203 multiplexes a plurality of second optical signals and outputs an optical signal after multiplexing as a second optical signal. The second multiplexing unit 203 includes, for example, an optical coupler.

The second separation unit 204 included in the second transmission/reception device 200a receives the fifth optical signal based on the fourth optical signal output from the third transmission/reception device 300a. Note that, in the second embodiment, since the second transmission/reception device 200a and the third transmission/reception device 300a are directly connected by the optical transmission line, the fifth optical signal received by the second separation unit 204 is the fourth optical signal output from the third transmission/reception device 300a.

The second separation unit 204 separates the fifth optical signal to generate a plurality of optical signals, and outputs each of the plurality of generated optical signals as the fifth optical signal to the relay station DL processing unit 202 included in the second transmission/reception device 200a. The second separation unit 204 includes an optical coupler, an optical splitter, or the like.

The third transmission/reception device 300a included in the transmission/reception system 1a according to the second embodiment includes a third multiplexing unit 304, a third separation unit 303, a plurality of housing station UL processing units 301, and a plurality of housing station DL processing units 302.

Each of the plurality of housing station UL processing units 301 included in the third transmission/reception device 300a according to the second embodiment is similar to the housing station UL processing unit 301 included in the third transmission/reception device 300 according to the first embodiment.

Each of the plurality of housing station DL processing units 302 included in the third transmission/reception device 300a according to the second embodiment is similar to the housing station DL processing unit 302 included in the third transmission/reception device 300 according to the first embodiment.

In FIG. 16, as an example of the plurality of housing station UL processing units 301 and the plurality of housing station DL processing units 302, a third transmission/reception device 300a including two housing station UL processing units 301-A and 301-B and two housing station DL processing units 302-A and 302-B is illustrated.

The number of the housing station UL processing units 301 included in the third transmission/reception device 300a is not limited to two, and may be three or more. In addition, the number of the housing station DL processing units 302 included in the third transmission/reception device 300a is not limited to two, and may be three or more.

Each of the plurality of housing station UL processing units 301 included in the third transmission/reception device 300a corresponds to one relay station UL processing unit 201 among the plurality of relay station UL processing units 201 included in the second transmission/reception device 200a.

In addition, each of the plurality of housing station DL processing units 302 included in the third transmission/reception device 300a corresponds to one relay station DL processing unit 202 among the plurality of relay station DL processing units 202 included in the second transmission/reception device 200a.

The relay station UL processing unit 201-A included in the second transmission/reception device 200a illustrated in FIG. 16 corresponds to the housing station UL processing unit 301-A included in the third transmission/reception device 300a, and the relay station UL processing unit 201-B corresponds to the housing station UL processing unit 301-B.

In addition, the relay station DL processing unit 202-A included in the second transmission/reception device 200a illustrated in FIG. 16 corresponds to the housing station DL processing unit 302-A included in the third transmission/reception device 300a, and the relay station DL processing unit 202-B corresponds to the housing station DL processing unit 302-B.

The third separation unit 303 included in the third transmission/reception device 300a receives the third optical signal based on the second optical signal output from the second transmission/reception device 200a. Note that, in the second embodiment, since the second transmission/reception device 200a and the third transmission/reception device 300a are directly connected by the optical transmission line, the third optical signal received by the third separation unit 303 is the second optical signal output from the second transmission/reception device 200a.

The third separation unit 303 separates the third optical signal to generate a plurality of optical signals, and outputs each of the plurality of generated optical signals as a third optical signal to the corresponding housing station UL processing unit 301 among the plurality of housing station UL processing units 301 included in the third transmission/reception device 300a. The third separation unit 303 includes an optical coupler, an optical splitter, or the like.

The third multiplexing unit 304 included in the third transmission/reception device 300a receives the fourth optical signal output from each of the plurality of housing station DL processing units 302. The third multiplexing unit 304 multiplexes the plurality of fourth optical signals and outputs an optical signal after multiplexing as a fourth optical signal. The third multiplexing unit 304 includes an optical coupler or the like.

The processing of the second transmission/reception device 200a is executed by the hardware configuration illustrated in FIG. 8A or 8B, for example, except for the processing from the reception of the optical signal to the conversion of the optical signal into the electrical signal and the processing from the conversion of the electrical signal into the optical signal to the output of the optical signal.

The processing of the third transmission/reception device 300a is executed by the hardware configuration illustrated in FIG. 9A or 9B, for example, except for the processing from the reception of the optical signal to the conversion of the optical signal into the electrical signal and the processing from the conversion of the electrical signal into the optical signal to the output of the optical signal.

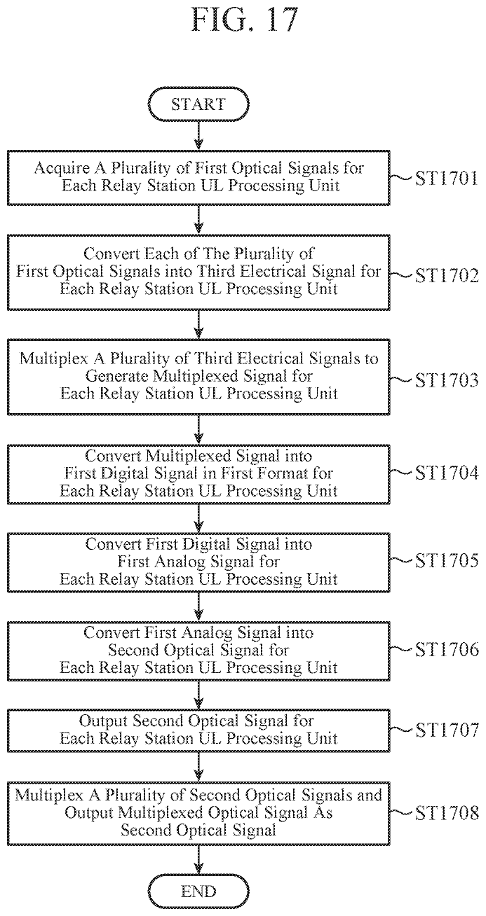

The operation of the transmission/reception system 1a according to the second embodiment will be described with reference to FIGS. 17 to 20.

Since the first transmission/reception device 100 according to the second embodiment is similar to the first transmission/reception device 100 according to the first embodiment, description of the uplink side operation and the downlink side operation in the first transmission/reception device 100 according to the second embodiment will be omitted.

The uplink side operation in the second transmission/reception device 200a according to the second embodiment will be described with reference to FIG. 17.

FIG. 17 is a flowchart illustrating an example of uplink side processing in the second transmission/reception device 200a according to the second embodiment.

The second transmission/reception device 200a executes the processing of the flowchart illustrated in FIG. 17 after the first transmission/reception device 100 executes the processing of the flowchart illustrated in FIG. 10.

After the first transmission/reception device 100 executes the processing in step ST1005 illustrated in FIG. 10, first, in step ST1701, the plurality of fifth photoelectric conversion units 211 included in the optical signal receiving unit 210 acquire the plurality of first optical signals for each of the relay station UL processing units 201-A and 201-B.

Next, in step ST7102, in both the relay station UL processing units 201-A and 201-B, each of the plurality of fifth photoelectric conversion units 211 included in the optical signal receiving unit 210 converts each of the plurality of first optical signals into a third electrical signal and outputs the third electrical signal.

Next, in step ST1703, the first multiplexing unit 212 included in the optical signal receiving unit 210 multiplexes a plurality of third electrical signals in each of the relay station UL processing units 201-A and 201-B to generate a multiplexed signal, and outputs the multiplexed signal.

Next, in step ST1704, the first format conversion unit 220 in each of the relay station UL processing units 201-A and 201-B converts the multiplexed signal into a first digital signal in the first format and outputs the first digital signal.

Next, in step ST1705, the first DA conversion unit 230 in each of the relay station UL processing units 201-A and 201-B converts the first digital signal into a first analog signal and outputs the first analog signal.

Next, in step ST1706, the first photoelectric conversion unit 240 in each of the relay station UL processing units 201-A and 201-B converts the first analog signal into the second optical signal.

Next, in step ST1707, the first photoelectric conversion unit 240 in each of the relay station UL processing units 201-A and 201-B outputs the second optical signal.

Next, in step ST1708, the second multiplexing unit 203 multiplexes the plurality of second optical signals and outputs an optical signal after multiplexing as a second optical signal.

After step ST1708, the second transmission/reception device 200a ends the processing of the flowchart. After ending the processing of the flowchart, the second transmission/reception device 200a returns to step ST1701 and repeatedly executes the processing of the flowchart.

Note that the second transmission/reception device 200a can execute the processing from step ST1701 to step ST1708 in parallel. Specifically, the second transmission/reception device 200a executes the processing from step ST1702 to step ST1708 in parallel on the FIFO basis for the plurality of first optical signals acquired in step ST1701.

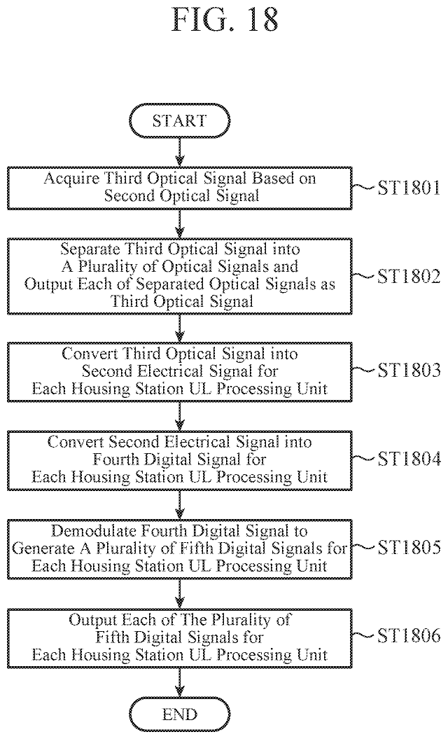

The uplink side operation in the third transmission/reception device 300a according to the second embodiment will be described with reference to FIG. 18.

FIG. 18 is a flowchart illustrating an example of uplink side processing in the third transmission/reception device 300a according to the second embodiment.

The third transmission/reception device 300a executes the processing of the flowchart illustrated in FIG. 18 after the second transmission/reception device 200a executes the processing of the flowchart illustrated in FIG. 17.

After the second transmission/reception device 200a executes the processing in step ST1708 illustrated in FIG. 17, first, in step ST1801, the third separation unit 303 acquires the third optical signal based on the second optical signal.

Next, in step ST1802, the third separation unit 303 separates the third optical signal into a plurality of optical signals, and outputs each of the optical signals after separation as a third optical signal.

Next, in step ST1803, the second optical receiving FE unit 310 in each of the housing station UL processing units 301-A and 301-B converts the third optical signal into a second electrical signal and outputs the second electrical signal.

Next, in step ST1804, the second AD conversion unit 320 in each of the housing station UL processing units 301-A and 301-B converts the second electrical signal into a fourth digital signal and outputs the fourth digital signal.

Next, in step ST1805, the second digital demodulation unit 330 in each of the housing station UL processing units 301-A and 301-B demodulates the fourth digital signal to generate a plurality of fifth digital signals.

Next, in step ST1806, the second digital demodulation unit 330 in each of the housing station UL processing units 301-A and 301-B outputs each of the plurality of fifth digital signals.

After step ST1806, the third transmission/reception device 300a ends the processing of the flowchart. After ending the processing of the flowchart, the third transmission/reception device 300a returns to step ST1801 and repeatedly executes the processing of the flowchart.

Note that the third transmission/reception device 300a can execute the processing from step ST1801 to step ST1806 in parallel. Specifically, the third transmission/reception device 300a executes processing from step ST1802 to step ST1806 in parallel on the FIFO basis for the third optical signal acquired in step ST1801.

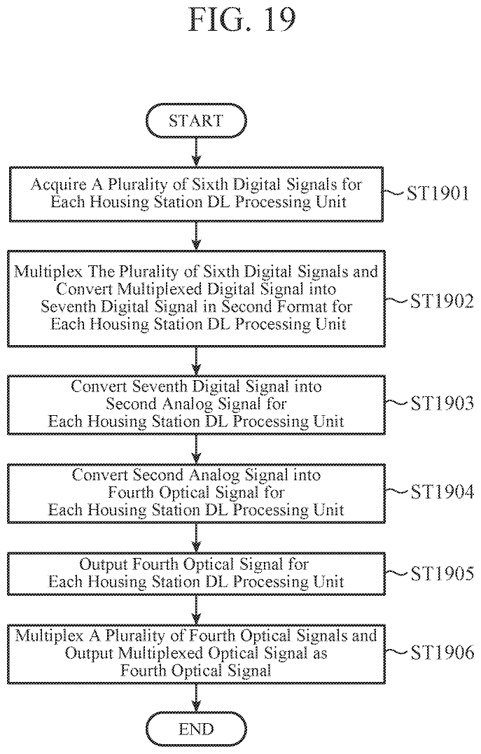

The downlink side operation in the third transmission/reception device 300a according to the second embodiment will be described with reference to FIG. 19.

FIG. 19 is a flowchart illustrating an example of downlink side processing in the third transmission/reception device 300a according to the second embodiment.

First, in step ST1901, the second format conversion unit 340 in each of the housing station DL processing units 302-A and 302-B acquires a plurality of sixth digital signals.

Next, in step ST1902, the second format conversion unit 340 in each of the housing station DL processing units 302-A and 302-B multiplexes the plurality of sixth digital signals, converts the digital signal after multiplexing into a seventh digital signal in the second format, and outputs the seventh digital signal.

Next, in step ST1903, the second DA conversion unit 350 in each of the housing station DL processing units 302-A and 302-B converts the seventh digital signal into a second analog signal and outputs the second analog signal.

Next, in step ST1904, the second photoelectric conversion unit 360 in each of the housing station DL processing units 302-A and 302-B converts the second analog signal into the fourth optical signal.

Next, in step ST1905, the second photoelectric conversion unit 360 in each of the housing station DL processing units 302-A and 302-B outputs a fourth optical signal.

Next, in step ST1906, the third multiplexing unit 304 multiplexes the plurality of fourth optical signals and outputs an optical signal after multiplexing as a fourth optical signal.

After step ST1906, the third transmission/reception device 300a ends the processing of the flowchart. After ending the processing of the flowchart, the third transmission/reception device 300a returns to step ST1901 and repeatedly executes the processing of the flowchart.

Note that the third transmission/reception device 300a can execute the processing from step ST1901 to step ST1906 in parallel. Specifically, the third transmission/reception device 300a executes processing from step ST1902 to step ST1906 in parallel on the FIFO basis for the plurality of sixth digital signals acquired in step ST1901.

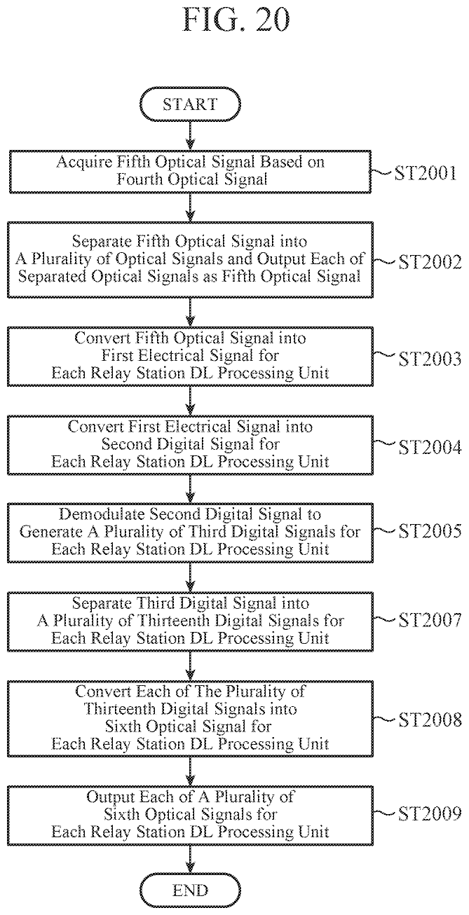

The downlink side operation in the second transmission/reception device 200a according to the second embodiment will be described with reference to FIG. 20.

FIG. 20 is a flowchart illustrating an example of downlink side processing in the second transmission/reception device 200a according to the second embodiment.

The second transmission/reception device 200a executes the processing of the flowchart illustrated in FIG. 20 after the third transmission/reception device 300a executes the processing of the flowchart illustrated in FIG. 19.

After the third transmission/reception device 300a executes the processing in step ST1906 illustrated in FIG. 19, first, in step ST2001, the second separation unit 204 acquires the fifth optical signal based on the fourth optical signal.

Next, in step ST2002, the second separation unit 204 separates the fifth optical signal into a plurality of optical signals, and outputs each of the optical signals after separation as a fifth optical signal.

Next, in step ST2003, the first optical receiving FE unit 250 in each of the relay station DL processing units 202-A and 202-B converts the fifth optical signal into a first electrical signal and outputs the first electrical signal.

Next, in step ST2004, the first AD conversion unit 260 in each of the relay station DL processing units 202-A and 202-B converts the first electrical signal into a second digital signal and outputs the second digital signal.

Next, in step ST2005, the first digital demodulation unit 270 in each of the relay station DL processing units 202-A and 202-B demodulates the second digital signal to generate a third digital signal and outputs the third digital signal.

Next, in step ST2007, the first separation unit 292 included in the optical signal output unit 290 in each of the relay station DL processing units 202-A and 202-B separates the third digital signal into a plurality of thirteenth digital signals and outputs the plurality of thirteenth digital signals.

Next, in step ST2008, the plurality of sixth photoelectric conversion units 293 included in the optical signal output unit 290 in each of the relay station DL processing units 202-A and 202-B convert each of the plurality of thirteenth digital signals into a sixth optical signal.

Next, in step ST2009, the plurality of sixth photoelectric conversion units 293 included in the optical signal output unit 290 in each of the relay station DL processing units 202-A and 202-B output each of the plurality of sixth optical signals.

After step ST2009, the second transmission/reception device 200a ends the processing of the flowchart. After ending the processing of the flowchart, the second transmission/reception device 200a returns to step ST2001 and repeatedly executes the processing of the flowchart.

Note that the second transmission/reception device 200a can execute the processing from step ST2001 to step ST2009 in parallel. Specifically, the second transmission/reception device 200a executes processing from step ST2002 to step ST2009 in parallel on the FIFO basis for the fifth optical signal acquired in step ST2001.

With the above configuration, the transmission/reception system 1a according to the second embodiment can perform transmission of a plurality of radio signals different from each other and reception of a plurality of radio signals different from each other between the second transmission/reception device 200a and the third transmission/reception device 300a by using a pair of optical transmission lines while enabling radio signal transmission of the QAM system having a higher multivalued degree as compared with the conventional transmission/reception system in the transmission and reception of radio signals between the second transmission/reception device 200a and the third transmission/reception device 300a.

As described above, the transmission/reception system 1a according to the second embodiment is the transmission/reception system 1a that performs transmission and reception of radio signals in one-to-many connection between the third transmission/reception device 300a and a plurality of user terminals by performing the transmission and reception of the radio signals via an optical transmission line between the first transmission/reception device 100 installed at each of a plurality of antenna sites and the second transmission/reception device 200a installed in a relay station building and between the second transmission/reception device 200a and the third transmission/reception device 300a installed in a housing station building, in which the second transmission/reception device 200a includes: the relay station UL processing unit 201 including: the optical signal receiving unit 210 to receive a first optical signal output from each of the plurality of first transmission/reception devices 100 and output a multiplexed signal obtained by multiplexing a plurality of electrical signals based on the plurality of first optical signals; the first format conversion unit 220 to convert the multiplexed signal output from the optical signal receiving unit 210 into a first digital signal in a predetermined first format and output the first digital signal after conversion; the first DA conversion unit 230 to convert the first digital signal output from the first format conversion unit 220 into a first analog signal and output the first analog signal after conversion; and the first photoelectric conversion unit 240 to convert the first analog signal output from the first DA conversion unit 230 into a second optical signal and output the second optical signal after conversion; and the relay station DL processing unit 202 including: the first optical receiving FE unit 250 to receive an optical signal based on a fourth optical signal output from the third transmission/reception device 300a as a fifth optical signal and output a first electrical signal based on the fifth optical signal; the first AD conversion unit 260 to convert the first electrical signal output from the first optical receiving FE unit 250 into a second digital signal and output the second digital signal after conversion; the first digital demodulation unit 270 to demodulate the second digital signal output from the first AD conversion unit 260 to generate a third digital signal and output the generated third digital signal; and the optical signal output unit 290 to output each of a plurality of sixth optical signals based on the third digital signal output from the first digital demodulation unit 270 to a corresponding first transmission/reception device 100, in which the third transmission/reception device 300a includes: the housing station UL processing unit 301 including: the second optical receiving FE unit 310 to receive an optical signal based on the second optical signal output from the second transmission/reception device 200a as a third optical signal and output a second electrical signal based on the third optical signal; the second AD conversion unit 320 to convert the second electrical signal output from the second optical receiving FE unit 310 into a fourth digital signal and output the fourth digital signal after conversion, and the second digital demodulation unit 330 to demodulate the fourth digital signal output from the second AD conversion unit 320 to generate a plurality of fifth digital signals and output the plurality of generated fifth digital signals; and the housing station DL processing unit 302 including: the second format conversion unit 340 to receive a plurality of sixth digital signals, convert the plurality of sixth digital signals into a seventh digital signal in a predetermined second format, and output the seventh digital signal after conversion; the second DA conversion unit 350 to convert the seventh digital signal output from the second format conversion unit 340 into a second analog signal, and output the second analog signal after conversion; and the second photoelectric conversion unit 360 to convert the second analog signal output from the second DA conversion unit 350 into the fourth optical signal, and output the fourth optical signal after conversion, in which the second transmission/reception device 200a includes: the plurality of relay station UL processing units 201; the second multiplexing unit 203 to multiplex the second optical signal output from each of the plurality of relay station UL processing units 201 and output an optical signal after multiplexing as the second optical signal; the plurality of relay station DL processing units 202; a second separation unit 204 to receive an optical signal based on the fourth optical signal output from the third transmission/reception device 300a as the fifth optical signal, separate the fifth optical signal into a plurality of optical signals, and output each of the plurality of optical signals after separation as the fifth optical signal to the corresponding relay station DL processing unit 202, and in which the third transmission/reception device 300a includes: the plurality of housing station UL processing units 301; the third separation unit 303 to receive an optical signal based on the second optical signal output from the second transmission/reception device 200a as the third optical signal, separate the third optical signal into a plurality of optical signals, and output each of the plurality of optical signals after separation as the third optical signal to the corresponding housing station UL processing unit 301; a plurality of the housing station DL processing units 302; and the third multiplexing unit 304 to multiplex the fourth optical signal output from each of the plurality of relay station UL processing units 201 and output an optical signal after multiplexing as the fourth optical signal.

With such a configuration, the transmission/reception system 1a according to the second embodiment can perform transmission of a plurality of radio signals different from each other and reception of a plurality of radio signals different from each other by using a pair of optical transmission lines while enabling the radio signal transmission of the QAM system having a higher multivalued degree as compared with the conventional transmission/reception system even if the transmission/reception system la is constructed using the A/D converter having the same performance indices.

In particular, in transmission and reception of radio signals between the second transmission/reception device 200a and the third transmission/reception device 300a, the transmission/reception system 1a according to the second embodiment can perform transmission of a plurality of radio signals different from each other and reception of a plurality of radio signals different from each other between the second transmission/reception device 200a and the third transmission/reception device 300a by using a pair of optical transmission lines while enabling the radio signal transmission of the QAM system having a higher multivalued degree as compared with the conventional transmission/reception system.

Third Embodiment.

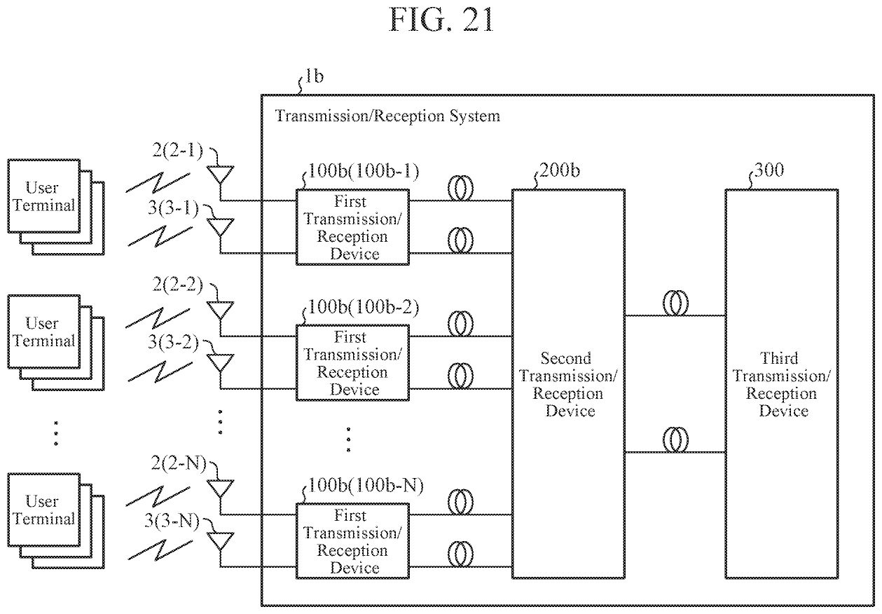

A transmission/reception system 1b according to a third embodiment will be described with reference to FIGS. 21 to 29.

A configuration of a main part of the transmission/reception system 1b according to the third embodiment will be described with reference to FIG. 21.

FIG. 21 is a block diagram illustrating an example of a configuration of a main part of the transmission/reception system 1b according to the third embodiment.

The transmission/reception system 1b includes a plurality of first transmission/reception devices 100b, a second transmission/reception device 200b, and a third transmission/reception device 300.

The transmission/reception system 1b according to the third embodiment is different from the transmission/reception system 1 according to the first embodiment in that the first transmission/reception device 100 and the second transmission/reception device 200 included in the transmission/reception system 1 according to the first embodiment are changed to the first transmission/reception device 100b and the second transmission/reception device 200b.

Note that in FIG. 21, the same components as those illustrated in FIG. 1 are denoted by the same reference numerals, and description thereof is omitted.

Since the third transmission/reception device 300 included in the transmission/reception system 1b according to the third embodiment is similar to the third transmission/reception device 300 according to the first embodiment, a detailed description of the third transmission/reception device 300 is omitted in the third embodiment.

FIG. 21 illustrates N first transmission/reception devices 100b-1 100b-2, . . . , 100b-N as the plurality of first transmission/reception devices 100b.

Each of the plurality of first transmission/reception devices 100b is connected to the reception antenna 2 and the transmission antenna 3.

FIG. 21 illustrates reception antennas 2-1, 2-2, . . . , and 2-N and transmission antennas 3-1, 3-2, . . . , and 3-N to which the first transmission/reception devices 100b-1,100b-2, . . . , and 100b-N are connected, respectively.

The first transmission/reception device 100b is a transmission/reception device installed at each of a plurality of antenna sites. The first transmission/reception device 100b performs transmission and reception of radio signals by radio waves to and from each of a plurality of user terminals via the reception antenna 2 and the transmission antenna 3. Specifically, for example, the first transmission/reception device 100b performs transmission and reception of radio signals by radio waves to and from each of the plurality of user terminals by a communication system such as an orthogonal frequency division multiplexing system.

The second transmission/reception device 200b is a transmission/reception device installed in the relay station building.

The third transmission/reception device 300 is a transmission/reception device installed in a housing station building.

The first transmission/reception device 100b and the second transmission/reception device 200b perform transmission and reception of radio signals to and from each other via an optical transmission line. In addition, the second transmission/reception device 200b and the third transmission/reception device 300 perform transmission and reception of radio signals to and from each other via an optical transmission line. The optical transmission line includes, for example, an optical fiber cable.

Specifically, the first transmission/reception device 100b receives the radio wave output from each of the plurality of user terminals as a reception radio signal via the reception antenna 2. The first transmission/reception device 100b generates a first optical signal on the basis of the reception radio signal and outputs the generated first optical signal.

The second transmission/reception device 200b receives the first optical signal output from each of the plurality of first transmission/reception devices 100b via the optical transmission line.

The second transmission/reception device 200b generates a second optical signal on the basis of the plurality of received first optical signals, and outputs the generated second optical signal.

The third transmission/reception device 300 receives an optical signal based on the second optical signal output from the second transmission/reception device 200b as a third optical signal via the optical transmission line. In the third embodiment, since the second transmission/reception device 200b and the third transmission/reception device 300 are directly connected by the optical transmission line, the third optical signal received by the third transmission/reception device 300 is the second optical signal output from the second transmission/reception device 200b.

In addition, the third transmission/reception device 300 outputs the fourth optical signal.

The second transmission/reception device 200b receives an optical signal based on the fourth optical signal output from the third transmission/reception device 300 as a fifth optical signal via the optical transmission line. In the third embodiment, since the second transmission/reception device 200b and the third transmission/reception device 300 are directly connected by the optical transmission line, the fifth optical signal received by the second transmission/reception device 200b is the fourth optical signal output from the third transmission/reception device 300. The second transmission/reception device 200b generates a plurality of sixth optical signals on the basis of the received fifth optical signal, and outputs the plurality of generated sixth optical signals.

The first transmission/reception device 100b receives the sixth optical signal corresponding to the first transmission/reception device 100b among the plurality of sixth optical signals output from the second transmission/reception device 200b via the optical transmission line. The first transmission/reception device 100b generates a transmission radio signal on the basis of the received sixth optical signal, and outputs the generated transmission radio signal.

The transmission radio signal output from the first transmission/reception device 100b is received by the user terminal as a radio wave via the transmission antenna 3.

With the above configuration, the transmission/reception system 1b can perform transmission and reception of radio signals in one-to-many connection between the third transmission/reception device 300 and the plurality of user terminals.

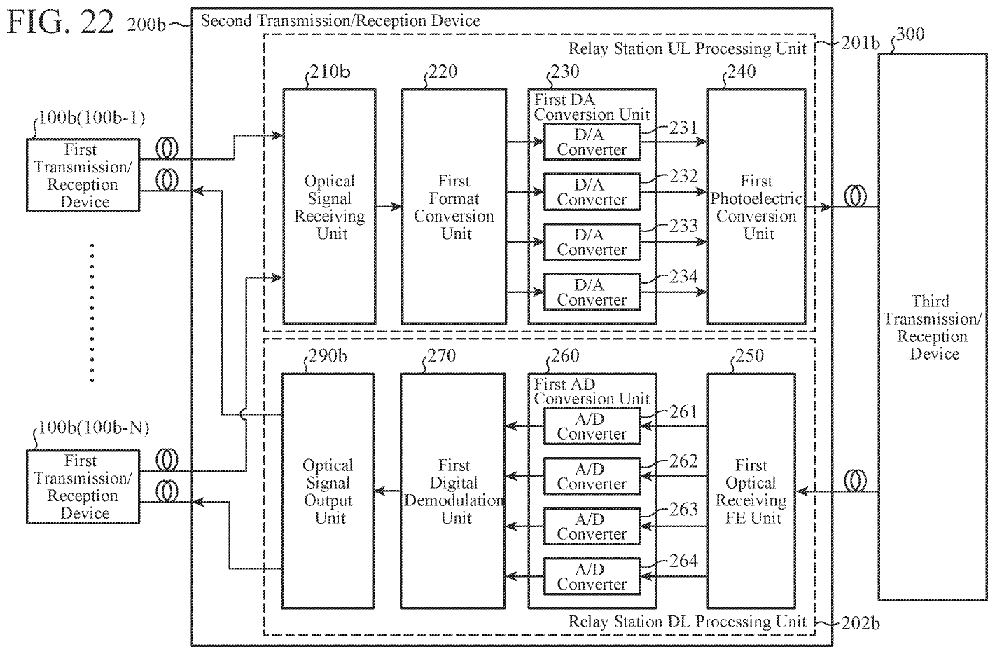

A configuration of a main part of the second transmission/reception device 200b according to the third embodiment will be described with reference to FIG. 22.

Note that in FIG. 22, the same reference numerals are given to the same configurations as those illustrated in FIG. 2, and the description thereof will be omitted.

FIG. 22 is a block diagram illustrating an example of a configuration of a main part of the second transmission/reception device 200b according to the third embodiment.

The second transmission/reception device 200b includes a relay station UL processing unit 201b and a relay station DL processing unit 202b.

The relay station UL processing unit 201b performs uplink (UL) side processing in the second transmission/reception device 200b. That is, the relay station UL processing unit 201b performs radio signal processing in a direction from the first transmission/reception device 100b to the third transmission/reception device 300 in the second transmission/reception device 200b.

Specifically, the relay station UL processing unit 201b receives the first optical signal output from each of the plurality of first transmission/reception devices 100b. The relay station UL processing unit 201b converts the plurality of first optical signals into a second optical signal, and outputs the second optical signal after conversion to the third transmission/reception device 300.

More specifically, the relay station UL processing unit 201b includes the optical signal receiving unit 210b, a first format conversion unit 220, a first DA conversion unit 230, and a first photoelectric conversion unit 240. The relay station UL processing unit 201b includes the optical signal receiving unit 210b, the first format conversion unit 220, the first DA conversion unit 230, and the first photoelectric conversion unit 240, thereby converting the plurality of first optical signals into the second optical signal and outputting the second optical signal after conversion to the third transmission/reception device 300.

The optical signal receiving unit 210b, the first format conversion unit 220, the first DA conversion unit 230, and the first photoelectric conversion unit 240 included in the relay station UL processing unit 201b will be described.

The optical signal receiving unit 210b receives the first optical signal output from each of the plurality of first transmission/reception devices 100b, and outputs a multiplexed signal obtained by multiplexing electrical signals based on the plurality of first optical signals.

Details of the optical signal receiving unit 210b will be described later.

The first format conversion unit 220 converts the multiplexed signal output from the optical signal receiving unit 210b into a first digital signal of a predetermined first format, and outputs the first digital signal after conversion.

The first DA conversion unit 230 converts the first digital signal output from the first format conversion unit 220 into a first analog signal, and outputs the first analog signal after conversion.

Specifically, for example, the first DA conversion unit 230 includes four D/A converters 231, 232, 233, and 234 as illustrated in FIG. 22.

The first photoelectric conversion unit 240 converts the first analog signal output from the first DA conversion unit 230 into a second optical signal, and outputs the second optical signal after conversion.

With the above configuration, the relay station UL processing unit 201b converts the plurality of first optical signals into the second optical signal, and outputs the second optical signal after conversion to the third transmission/reception device 300.

The relay station DL processing unit 202b performs downlink (DL) side processing in the second transmission/reception device 200b. That is, the relay station DL processing unit 202b performs radio signal processing in a direction from the third transmission/reception device 300 to the first transmission/reception device 100b in the second transmission/reception device 200b.

Specifically, the relay station DL processing unit 202b receives, as a fifth optical signal, an optical signal based on the fourth optical signal output from the third transmission/reception device 300. The relay station DL processing unit 202b converts the fifth optical signal into a sixth optical signal, and outputs the sixth optical signal after conversion to the first transmission/reception device 100b.

More specifically, the relay station DL processing unit 202b includes a first optical receiving FE unit 250, a first AD conversion unit 260, a first digital demodulation unit 270, and an optical signal output unit 290b. The relay station DL processing unit 202b includes the first optical receiving FE unit 250, the first AD conversion unit 260, the first digital demodulation unit 270, and the optical signal output unit 290b, thereby converting the fifth optical signal into a plurality of sixth optical signals and outputting the plurality of sixth optical signals after conversion to the corresponding first transmission/reception device 100b.

The first optical receiving FE unit 250, the first AD conversion unit 260, the first digital demodulation unit 270, and the optical signal output unit 290b included in the relay station DL processing unit 202b will be described.

The first optical receiving FE unit 250 receives an optical signal based on the fourth optical signal output from the third transmission/reception device 300 as a fifth optical signal, and outputs a first electrical signal based on the fifth optical signal.

The first AD conversion unit 260 converts the first electrical signal output from the first optical receiving FE unit 250 into a second digital signal, and outputs the second digital signal after conversion.

Specifically, for example, the first AD conversion unit 260 includes four A/D converters 261, 262, 263, and 264 as illustrated in FIG. 22.

The first digital demodulation unit 270 demodulates the second digital signal output from the first AD conversion unit 260 to generate a third digital signal, and outputs the generated third digital signal.

The optical signal output unit 290b outputs each of the plurality of sixth optical signals based on the third digital signal output from the first digital demodulation unit 270 to the corresponding first transmission/reception device 100b.

Details of the optical signal output unit 290b will be described later.

With the above configuration, the relay station DL processing unit 202b converts the fifth optical signal into a plurality of sixth optical signals, and outputs the plurality of sixth optical signals after conversion to the corresponding first transmission/reception device 100b.

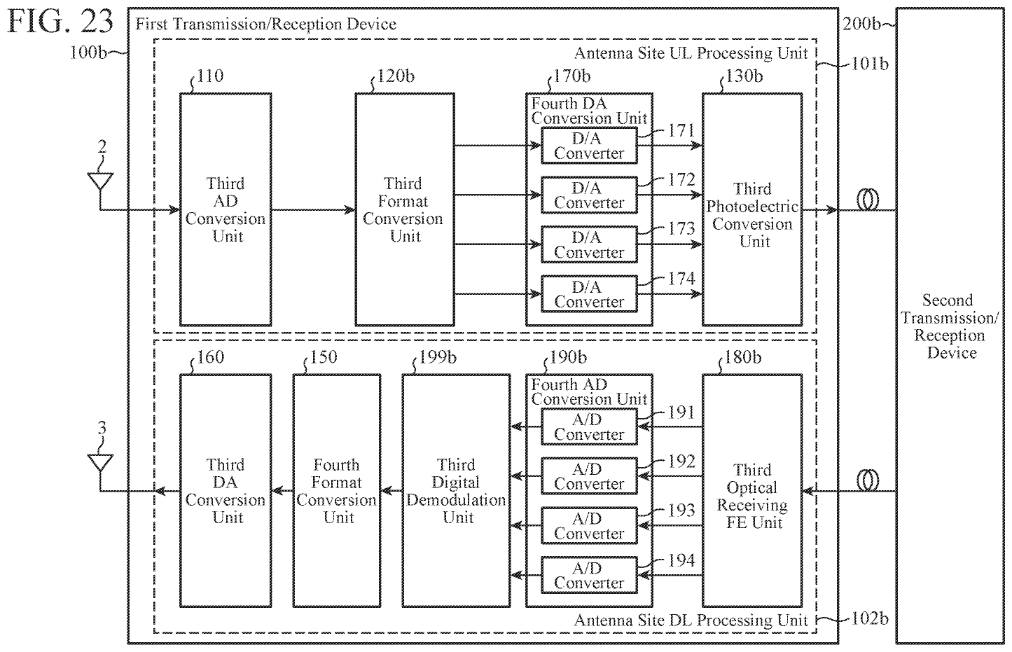

A configuration of a main part of the first transmission/reception device 100b according to the third embodiment will be described with reference to FIG. 23.

In FIG. 23, the same components as those illustrated in FIG. 4 are denoted by the same reference numerals, and description thereof is omitted.

FIG. 23 is a block diagram illustrating an example of a configuration of a main part of the first transmission/reception device 100b according to the third embodiment.

The first transmission/reception device 100b includes an antenna site UL processing unit 101b and an antenna site DL processing unit 102b.

The antenna site UL processing unit 101b performs uplink (UL) side processing in the first transmission/reception device 100b. That is, the antenna site UL processing unit 101b performs radio signal processing in a direction from the first transmission/reception device 100b to the third transmission/reception device 300 in the first transmission/reception device 100b.

Specifically, the antenna site UL processing unit 101b receives the reception radio signal output from the reception antenna 2, converts the reception radio signal into a first optical signal, and outputs the first optical signal after conversion to the second transmission/reception device 200b.

More specifically, the antenna site UL processing unit 101b includes a third AD conversion unit 110, a third format conversion unit 120b, a fourth DA conversion unit 170b, and a third photoelectric conversion unit 130b. The antenna site UL processing unit 101b includes the third AD conversion unit 110, the third format conversion unit 120b, the fourth DA conversion unit 170b, and the third photoelectric conversion unit 130b, thereby converting the reception radio signal output from the reception antenna 2 into a first optical signal and outputting the first optical signal after conversion to the second transmission/reception device 200b.

The third AD conversion unit 110, the third format conversion unit 120b, the fourth DA conversion unit 170b, and the third photoelectric conversion unit 130b included in the antenna site UL processing unit 101b will be described.

The third AD conversion unit 110 receives the reception radio signal from the reception antenna 2, converts the reception radio signal into an eighth digital signal, and outputs the eighth digital signal after conversion.

The third format conversion unit 120b converts the eighth digital signal output from the third AD conversion unit 110 into a fourteenth digital signal in a predetermined sixth format, and outputs the fourteenth digital signal after conversion.

Specifically, for example, the third format conversion unit 120b first performs on-off modulation on the eighth digital signal output from the third AD conversion unit 110. After the on/off modulation, the third format conversion unit 120b converts the eighth digital signal after the on/off modulation into an I signal and a Q signal, and further polarizes and separates each of the I signal and the Q signal into an X polarization signal and a Y polarization signal, thereby converting the eighth digital signal into the fourteenth digital signal in the sixth format.

That is, the conversion into the fourteenth digital signal in the sixth format performed by the third format conversion unit 120b is on-off modulation of the eighth digital signal and conversion of the eighth digital signal after the on-off modulation into an XI signal, an XQ signal, a YI signal, and a YQ signal, and the fourteenth digital signal is a digital signal including four digital signals of the XI signal, the XQ signal, the YI signal, and the YQ signal.

The third format conversion unit 120b converts the eighth digital signal into the fourteenth digital signal in the sixth format including the XI signal, the XQ signal, the YI signal, and the YQ signal, so that the transmission/reception system 1b can perform transmission and reception of the radio signals by the coherent detection system in the transmission and reception of the radio signals from each of the plurality of first transmission/reception devices 100b to and from the second transmission/reception device 200b.

The fourth DA conversion unit 170b converts the fourteenth digital signal output from the third format conversion unit 120b into a third analog signal, and outputs the third analog signal after conversion.

Specifically, for example, the fourth DA conversion unit 170b includes four D/A converters 171, 172, 173, and 174 as illustrated in FIG. 23.

Specifically, the fourth DA conversion unit 170b converts each of the XI signal, the XQ signal, the YI signal, and the YQ signal, which are the fourteenth digital signals output from the third format conversion unit 120b, into an analog signal by the corresponding D/A converter 171, 172, 173, or 174, and outputs the four analog signals after conversion as the third analog signals.

The third photoelectric conversion unit 130b converts the third analog signals output from the fourth DA conversion unit 170b into a first optical signal, and outputs the first optical signal after conversion to the second transmission/reception device 200b. For example, the third photoelectric conversion unit 130b includes an addition circuit and a photoelectric converter (not illustrated in FIG. 23).

Specifically, for example, the third photoelectric conversion unit 130b first adds all the four analog signals output as the third analog signals by the fourth DA conversion unit 170b by an addition circuit included in the third photoelectric conversion unit 130b.

Next, the third photoelectric conversion unit 130b converts the added analog signal into a first optical signal by a photoelectric converter included in the third photoelectric conversion unit 130b, and outputs the first optical signal after conversion to the second transmission/reception device 200b.

With the above configuration, the reception radio signal output from the reception antenna 2 is converted into the first optical signal, and the first optical signal after conversion is output to the second transmission/reception device 200b.

The antenna site DL processing unit 102b performs downlink (DL) side processing in the first transmission/reception device 100b. That is, the antenna site DL processing unit 102b performs radio signal processing in a direction from the third transmission/reception device 300 to the first transmission/reception device 100b in the first transmission/reception device 100b.

Specifically, the antenna site DL processing unit 102b receives a corresponding sixth optical signal among the plurality of sixth optical signals output from the second transmission/reception device 200b. The antenna site DL processing unit 102b converts the sixth optical signal into a transmission radio signal and outputs the transmission radio signal after conversion to the transmission antenna 3.

More specifically, the antenna site DL processing unit 102b includes the third optical receiving FE unit 180b, a fourth AD conversion unit 190b, a third digital demodulation unit 199b, a fourth format conversion unit 150, and a third DA conversion unit 160. The antenna site DL processing unit 102b includes the third optical receiving FE unit 180b, the fourth AD conversion unit 190b, the third digital demodulation unit 199b, the fourth format conversion unit 150, and the third DA conversion unit 160, thereby converting the corresponding sixth optical signal among the plurality of sixth optical signals output from the second transmission/reception device 200b into a transmission radio signal and outputting the transmission radio signal after conversion to the transmission antenna 3.

The third optical receiving FE unit 180b, the fourth AD conversion unit 190b, the third digital demodulation unit 199b, the fourth format conversion unit 150, and the third DA conversion unit 160 included in the antenna site DL processing unit 102b will be described.

The third optical receiving FE unit 180b converts the sixth optical signal into fourth electrical signals and outputs the fourth electrical signals after conversion. The third optical receiving FE unit 180b includes, for example, an optical reception front end circuit 600 illustrated in FIG. 6 as an example.

Specifically, the third optical receiving FE unit 180b generates four analog signals based on the sixth optical signal, and outputs the generated four analog signals as the fourth electrical signals.

The fourth AD conversion unit 190b converts the fourth electrical signal output from the third optical receiving FE unit 180b into a fifteenth digital signal, and outputs the fifteenth digital signal after conversion. For example, the fourth AD conversion unit 190b includes four A/D converters 191, 192, 193, and 194 as illustrated in FIG. 23.

Specifically, the fourth AD conversion unit 190b converts each of the four analog signals, which are the fourth electrical signals output from the third optical receiving FE unit 180b, into a digital signal by the corresponding A/D converter 191, 192, 193, or 194, and outputs the four digital signals after conversion as the fifteenth digital signals.

The third digital demodulation unit 199b demodulates the fifteenth digital signals output from the fourth AD conversion unit 190b to generate a tenth digital signal, and outputs the generated tenth digital signal.

Specifically, the third digital demodulation unit 199b first performs polarization separation on the four digital signals that are the fifteenth digital signals output from the fourth AD conversion unit 190b. Further, the fourth AD conversion unit 190b demodulates the fifteenth digital signals by performing IQ separation on the signals after polarization separation to generate the tenth digital signal.

The fourth format conversion unit 150 converts the tenth digital signal output from the third digital demodulation unit 199b into an eleventh digital signal in a predetermined fourth format, and outputs the eleventh digital signal after conversion.

The third DA conversion unit 160 converts the eleventh digital signal output from the fourth format conversion unit 150 into a transmission radio signal, and outputs the transmission radio signal after conversion to the transmission antenna 3.

With the above configuration, the antenna site DL processing unit 102b converts the corresponding sixth optical signal among the plurality of sixth optical signals output from the second transmission/reception device 200b into a transmission radio signal, and outputs the transmission radio signal after conversion to the transmission antenna 3.

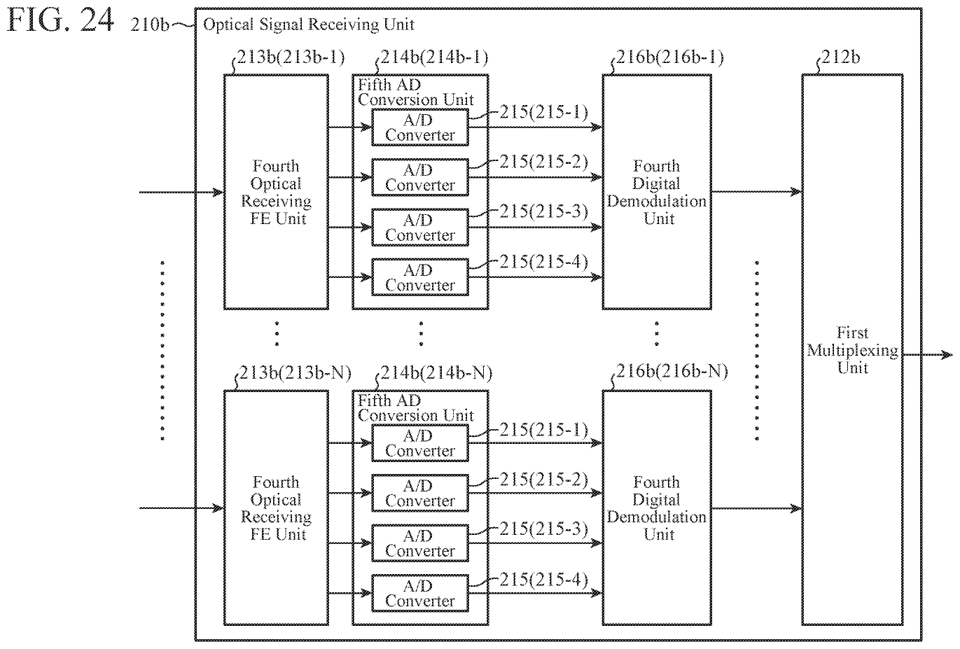

A configuration of a main part of the optical signal receiving unit 210b included in the second transmission/reception device 200b according to the third embodiment will be described with reference to FIG. 24.

Note that in FIG. 24, the same components as those illustrated in FIG. 5A are denoted by the same reference numerals, and description thereof is omitted.

FIG. 24 is a block diagram illustrating an example of a configuration of a main part of the optical signal receiving unit 210b included in the second transmission/reception device 200b according to the third embodiment.

The optical signal receiving unit 210b includes a plurality of fourth optical receiving FE units 213b, a plurality of fifth AD conversion units 214b, a plurality of fourth digital demodulation units 216b, and a first multiplexing unit 212b.

FIG. 24 illustrates, as the plurality of fourth optical receiving FE units 213b, the plurality of fifth AD conversion units 214b, and the plurality of fourth digital demodulation units 216b, N fourth optical receiving FE units 213b-1, . . . , and 213b-N, N fifth AD conversion units 214b-1, . . . , and 214b-N, and N fourth digital demodulation units 216b-1, . . . , and 216b-N, which have the same number as the first transmission/reception device 100b illustrated in FIG. 21.

The fourth optical receiving FE unit 213b is connected to the first transmission/reception device 100b via an optical transmission line.

The N fourth optical receiving FE units 213b-1, . . . , and 213b-N illustrated in FIG. 24 correspond to the first transmission/reception devices 100b-1, . . . , and 100b-N illustrated in FIG. 21, respectively.

Each of the plurality of fourth optical receiving FE units 213b receives the first optical signal output from the corresponding first transmission/reception device 100b. Each of the plurality of fourth optical receiving FE units 213b converts the first optical signal into a fifth electrical signal, and outputs the fifth electrical signal after conversion. Each of the plurality of fourth optical receiving FE units 213b includes, for example, an optical reception front end circuit 600 illustrated in FIG. 6 as an example.

Specifically, each of the plurality of fourth optical receiving FE units 213b generates four analog signals based on the first optical signal, and outputs the generated four analog signals as the fifth electrical signals.

Each of the plurality of fifth AD conversion units 214b converts the fifth electrical signal output from the corresponding fourth optical receiving FE unit 213b into a sixteenth digital signal, and outputs the sixteenth digital signal after conversion. For example, each of the plurality of fifth AD conversion units 214b includes four A/D converters 215 (215-1, 215-2, 215-3, and 215-4) as illustrated in FIG. 24.

Specifically, each of the plurality of fifth AD conversion units 214b converts each of the four analog signals, which are the fifth electrical signals output from the corresponding fourth optical receiving FE unit 213b, into a digital signal by the corresponding A/D converter 215-1, 215-2, 215-3, or 215-4, and outputs the four digital signals after conversion as the sixteenth digital signals.

Each of the plurality of fourth digital demodulation units 216b demodulates the sixteenth digital signals output from the corresponding fifth AD conversion unit 214b to generate a seventeenth digital signal, and outputs the generated seventeenth digital signal.

Specifically, each of the plurality of fourth digital demodulation units 216b first performs polarization separation on the four digital signals that are the sixteenth digital signals output from the corresponding fifth AD conversion unit 214b. Further, each of the plurality of fourth digital demodulation units 216b demodulates the sixteenth digital signals by performing IQ separation on the signals after polarization separation to generate the seventeenth digital signal, and outputs the generated seventeenth digital signal.

The first multiplexing unit 212b multiplexes the seventeenth digital signals output from each of the plurality of fourth digital demodulation units 216b to generate a multiplexed signal, and outputs the generated multiplexed signal.

With the above configuration, the optical signal receiving unit 210b receives the first optical signal output from each of the plurality of first transmission/reception devices 100b, and outputs the multiplexed signal obtained by multiplexing the electrical signals based on the plurality of first optical signals.

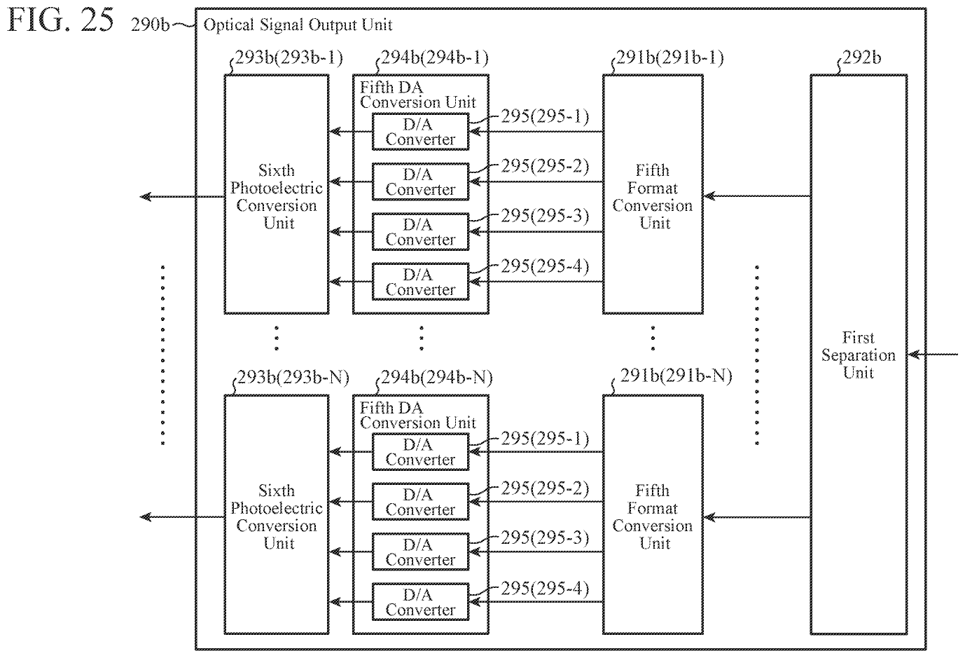

A configuration of a main part of the optical signal output unit 290b included in the second transmission/reception device 200b according to the third embodiment will be described with reference to FIG. 25.

Note that, in FIG. 25, the same components as those illustrated in FIG. 5B are denoted by the same reference numerals, and description thereof is omitted.

FIG. 25 is a block diagram illustrating an example of a configuration of a main part of the optical signal output unit 290b included in the second transmission/reception device 200b according to the third embodiment.

The optical signal output unit 290b includes a plurality of fifth format conversion units 291b, a first separation unit 292b, a plurality of fifth DA conversion units 294b, and a plurality of sixth photoelectric conversion units 293b.

FIG. 25 illustrates, as the plurality of fifth format conversion units 291b, the plurality of fifth DA conversion units 294b, and the plurality of sixth photoelectric conversion units 293b, N fifth format conversion units 291b-1, . . . , and 291b-N, N sixth photoelectric conversion units 293b-1, . . . , and 293b-N, and N fifth DA conversion units 294b-1, . . . , and 294b-N, which have the same number as the first transmission/reception devices 100b illustrated in FIG. 21.

The sixth photoelectric conversion unit 293b is connected to the first transmission/reception device 100b via an optical transmission line.

The N sixth photoelectric conversion units 293b-1, . . . , and 293b-N illustrated in FIG. 25 correspond to the first transmission/reception devices 100b-1, . . . , and 100b-N illustrated in FIG. 21, respectively.

The first separation unit 292b separates the third digital signal output from the first digital demodulation unit 270 into a plurality of eighteenth digital signals, and outputs the plurality of eighteenth digital signals after separation.

Each of the plurality of fifth format conversion units 291b converts the corresponding eighteenth digital signal among the plurality of eighteenth digital signals output from the first separation unit 292b into a nineteenth digital signal in a predetermined seventh format, and outputs the nineteenth digital signal after conversion.

Specifically, first, each of the plurality of fifth format conversion units 291b converts the corresponding eighteenth digital signal among the plurality of eighteenth digital signals output from the first separation unit 292b into an I signal and a Q signal, and further polarizes and separates each of the I signal and the Q signal into an X polarization signal and a Y polarization signal, thereby converting the eighteenth digital signal into the nineteenth digital signal in the seventh format.

That is, the conversion into the nineteenth digital signal in the seventh format performed by each of the plurality of fifth format conversion units 291b is to convert the eighteenth digital signal into the XI signal, the XQ signal, the YI signal, and the YQ signal, and the nineteenth digital signal is a digital signal including four digital signals of the XI signal, the XQ signal, the YI signal, and the YQ signal.

The plurality of fifth format conversion units 291b converts the eighteenth digital signals into the nineteenth digital signals in the seventh format including the XI signal, the XQ signal, the YI signal, and the YQ signal, so that the transmission/reception system 1b can perform transmission and reception of the radio signals by the coherent detection system in the transmission and reception of the radio signals from the second transmission/reception device 200b to each of the plurality of first transmission/reception devices 100b.

Each of the plurality of fifth DA conversion units 294b converts the nineteenth digital signal output from the corresponding fifth format conversion unit 291b into a fifth analog signal, and outputs the fifth analog signal after conversion. For example, each of the plurality of fifth DA conversion units 294b includes four D/A converters 295 (295-1, 295-2, 295-3, and 295-4) as illustrated in FIG. 25.

Specifically, each of the plurality of fifth DA conversion units 294b converts each of the XI signal, the XQ signal, the YI signal, and the YQ signal, which are the nineteenth digital signals output from the corresponding fifth format conversion unit 291b, into an analog signal by the corresponding D/A converter 295-1, 295-2, 295-3, or 295-4, and outputs the four analog signals after conversion as the fifth analog signals.

Each of the plurality of sixth photoelectric conversion units 293b converts the fifth analog signals output from the corresponding fifth DA conversion unit 294b into a sixth optical signal, and outputs the sixth optical signal after conversion. For example, each of the plurality of sixth photoelectric conversion units 293b includes a photoelectric converter (not illustrated in FIG. 25).

Specifically, for example, each of the plurality of sixth photoelectric conversion units 293b generates a sixth optical signal by the photoelectric converter performing E/O conversion on the fifth analog signals, and outputs the generated sixth optical signal to the second transmission/reception device 200b.

With the above configuration, the optical signal output unit 290b converts the third digital signal output from the first digital demodulation unit 270 into a nineteenth digital signal that is an electrical signal in a predetermined seventh format, and outputs each of the plurality of sixth optical signals based on the nineteenth digital signal after conversion to the corresponding first transmission/reception device 100b.

The processing of the first transmission/reception device 100b is executed by the hardware configuration illustrated in FIG. 7A or 7B, for example, except for the processing from the reception of the optical signal to the conversion of the optical signal into the electrical signal and the processing from the conversion of the electrical signal into the optical signal to the output of the optical signal.

The processing of the second transmission/reception device 200b is executed by the hardware configuration illustrated in FIG. 8A or 8B, for example, except for the processing from the reception of the optical signal to the conversion of the optical signal into the electrical signal and the processing from the conversion of the electrical signal into the optical signal to the output of the optical signal.

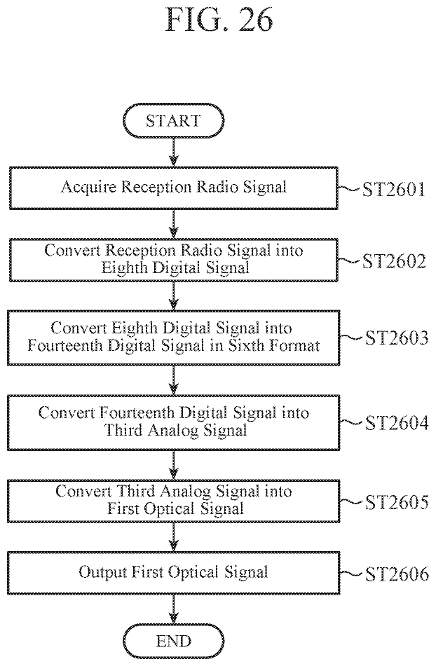

The operation of the transmission/reception system 1b according to the third embodiment will be described with reference to FIGS. 26 to 29.

The uplink side operation in the first transmission/reception device 100b according to the third embodiment will be described with reference to FIG. 26.

FIG. 26 is a flowchart illustrating an example of uplink side processing in the first transmission/reception device 100b according to the third embodiment.

First, in step ST2601, the third AD conversion unit 110 acquires a reception radio signal.

Next, in step ST2602, the third AD conversion unit 110 converts the reception radio signal into an eighth digital signal and outputs the eighth digital signal.

Next, in step ST2603, the third format conversion unit 120b converts the eighth digital signal into the fourteenth digital signal in the sixth format, and outputs the fourteenth digital signal.

Next, in step ST2604, the third photoelectric conversion unit 130b converts the fourteenth digital signal into a third analog signal and outputs the third analog signal.

Next, in step ST2605, the third photoelectric conversion unit 130b converts the third analog signal into a first optical signal.

Next, in step ST2606, the third photoelectric conversion unit 130b outputs the first optical signal.

After step ST2606, the first transmission/reception device 100b ends the processing of the flowchart. After ending the processing of the flowchart, the first transmission/reception device 100b returns to step ST2601 and repeatedly executes the processing of the flowchart.

Note that the first transmission/reception device 100b can execute the processing from step ST2601 to step ST2606 in parallel. Specifically, the first transmission/reception device 100b executes processing from step ST2602 to step ST2606 in parallel on the FIFO basis for the reception radio signal acquired in step ST2601.

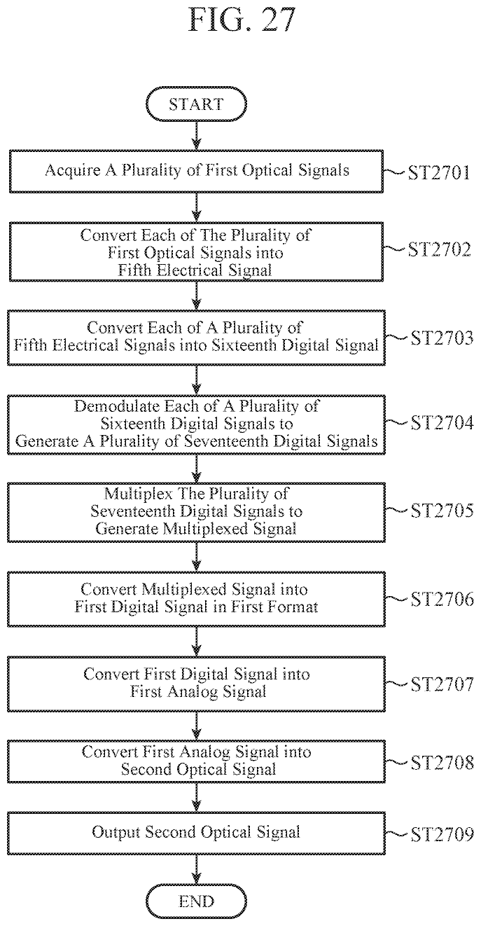

The uplink side operation in the second transmission/reception device 200b according to the third embodiment will be described with reference to FIG. 27.

FIG. 27 is a flowchart illustrating an example of uplink side processing in the second transmission/reception device 200b according to the third embodiment.

After the first transmission/reception device 100b executes the processing of the flowchart illustrated in FIG. 26, the second transmission/reception device 200b executes the processing of the flowchart illustrated in FIG. 27.

After the first transmission/reception device 100b executes the processing in step ST2606 illustrated in FIG. 26, first, in step ST2701, the plurality of fourth optical receiving FE units 213b included in the optical signal receiving unit 210b acquires the plurality of first optical signals.

Next, in step ST2702, the plurality of fourth optical receiving FE units 213b included in the optical signal receiving unit 210b converts each of the plurality of first optical signals into the fifth electrical signal and outputs the fifth electrical signal.

Next, in step ST2703, the plurality of fifth AD conversion units 214b included in the optical signal receiving unit 210b converts each of the plurality of fifth electrical signals into a sixteenth digital signal, and outputs the plurality of sixteenth digital signals.

Next, in step ST2704, the plurality of fourth digital demodulation units 216b included in the optical signal receiving unit 210b demodulates each of the plurality of sixteenth digital signals to generate a plurality of seventeenth digital signals, and outputs the plurality of seventeenth digital signals.

Next, in step ST2705, the first multiplexing unit 212b included in the optical signal receiving unit 210b multiplexes the plurality of seventeenth digital signals to generate a multiplexed signal, and outputs the multiplexed signal.

Next, in step ST2706, the first format conversion unit 220 converts the multiplexed signal into a first digital signal in the first format and outputs the first digital signal.

Next, in step ST2707, the first DA conversion unit 230 converts the first digital signal into a first analog signal and outputs the first analog signal.

Next, in step ST2708, the first photoelectric conversion unit 240 converts the first analog signal into a second optical signal.

Next, in step ST2709, the first photoelectric conversion unit 240 outputs the second optical signal.

After step ST2709, the second transmission/reception device 200b ends the processing of the flowchart. After ending the processing of the flowchart, the second transmission/reception device 200b returns to step ST2701 and repeatedly executes the processing of the flowchart.

Note that the second transmission/reception device 200b can execute the processing from step ST2701 to step ST2709 in parallel. Specifically, the second transmission/reception device 200b executes processing from step ST2702 to step ST2709 in parallel on the FIFO basis for the plurality of first optical signals acquired in step ST2701.

Since the third transmission/reception device 300 according to the third embodiment is similar to the third transmission/reception device 300 according to the first embodiment, the description of the uplink side operation and the downlink side operation in the third transmission/reception device 300 according to the third embodiment will be omitted.

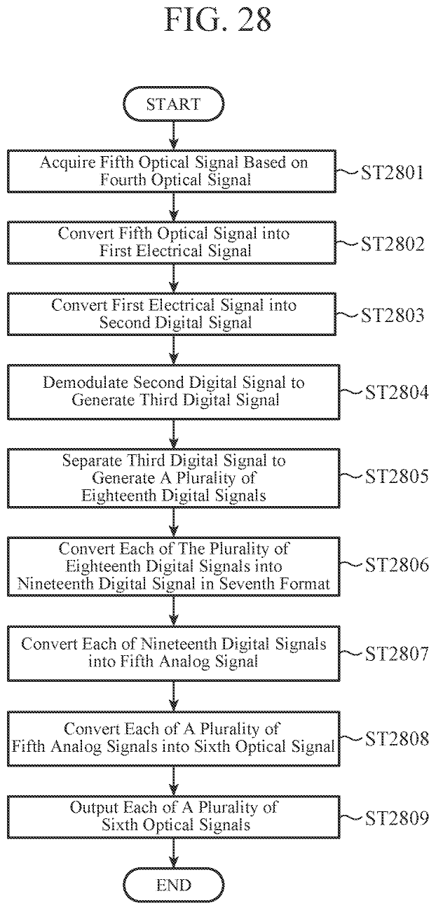

The downlink side operation in the second transmission/reception device 200b according to the third embodiment will be described with reference to FIG. 28.

FIG. 28 is a flowchart illustrating an example of downlink side processing in the second transmission/reception device 200b according to the third embodiment.

The second transmission/reception device 200b executes the processing of the flowchart illustrated in FIG. 28 after the third transmission/reception device 300 executes the processing of the flowchart illustrated in FIG. 13.

After the third transmission/reception device 300 executes the processing in step ST1305 illustrated in FIG. 13, first, in step ST2801, the first optical receiving FE unit 250 acquires the fifth optical signal based on the fourth optical signal.

Next, in step ST2802, the first optical receiving FE unit 250 converts the fifth optical signal into a first electrical signal and outputs the first electrical signal.

Next, in step ST2803, the first AD conversion unit 260 converts the first electrical signal into a second digital signal and outputs the second digital signal.

Next, in step ST2804, the first digital demodulation unit 270 demodulates the second digital signal to generate a third digital signal, and outputs the third digital signal.

Next, in step ST2805, the first separation unit 292b included in the optical signal output unit 290b separates the third digital signal to generate a plurality of eighteenth digital signals, and outputs the plurality of eighteenth digital signals.

Next, in step ST2806, the plurality of fifth format conversion units 291b included in the optical signal output unit 290b converts each of the plurality of eighteenth digital signals into a nineteenth digital signal in the seventh format, and outputs the plurality of nineteenth digital signals.

Next, in step ST2807, the fifth DA conversion unit 294b included in the optical signal output unit 290b converts each of the nineteenth digital signals into a fifth analog signal and outputs the plurality of fifth analog signals.

Next, in step ST2808, the plurality of sixth photoelectric conversion units 293b included in the optical signal output unit 290b converts each of the plurality of fifth analog signals into a sixth optical signal.

Next, in step ST2809, the plurality of sixth photoelectric conversion units 293b included in the optical signal output unit 290b outputs each of the plurality of sixth optical signals.

After step ST2809, the second transmission/reception device 200b ends the processing of the flowchart. After ending the processing of the flowchart, the second transmission/reception device 200b returns to step ST2801 and repeatedly executes the processing of the flowchart.

Note that the second transmission/reception device 200b can execute the processing from step ST2801 to step ST2809 in parallel. Specifically, the second transmission/reception device 200b executes processing from step ST2802 to step ST2809 in parallel on the FIFO basis for the fifth optical signal acquired in step ST2801.

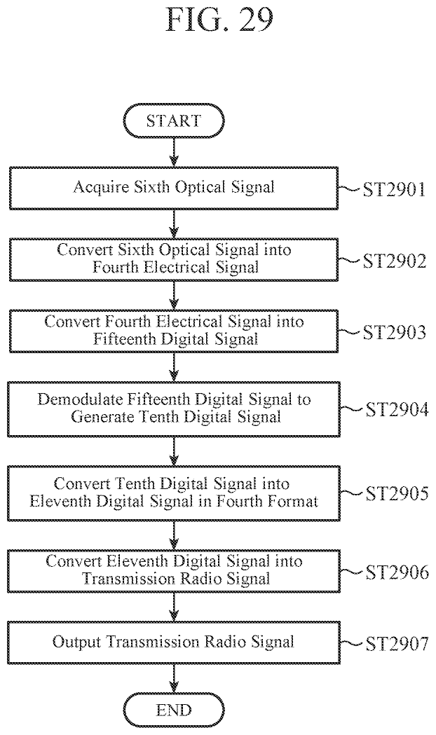

The downlink side operation in the first transmission/reception device 100b according to the third embodiment will be described with reference to FIG. 29.

FIG. 29 is a flowchart illustrating an example of downlink side processing in the first transmission/reception device 100b according to the third embodiment.

The first transmission/reception device 100b executes the processing of the flowchart illustrated in FIG. 29 after the second transmission/reception device 200b executes the processing of the flowchart illustrated in FIG. 28.

After the second transmission/reception device 200b executes the processing in step ST2809 illustrated in FIG. 28, first, in step ST2901, the third optical receiving FE unit 180b acquires the sixth optical signal.

Next, in step ST2902, the third optical receiving FE unit 180b converts the sixth optical signal into a fourth electrical signal and outputs the fourth electrical signal.

Next, in step ST2903, the fourth AD conversion unit 190b converts the fourth electrical signal into a fifteenth digital signal and outputs the fifteenth digital signal.

Next, in step ST2904, the third digital demodulation unit 199b demodulates the fifteenth digital signal to generate a tenth digital signal, and outputs the tenth digital signal.

Next, in step ST2905, the fourth format conversion unit 150 converts the tenth digital signal into an eleventh digital signal in the fourth format, and outputs the eleventh digital signal.

Next, in step ST2906, the third DA conversion unit 160 converts the eleventh digital signal into a transmission radio signal.

Next, in step ST2907, the third DA conversion unit 160 outputs the transmission radio signal.

After step ST2907, the first transmission/reception device 100b ends the processing of the flowchart. After ending the processing of the flowchart, the first transmission/reception device 100b returns to step ST2901 and repeatedly executes the processing of the flowchart.

Note that the first transmission/reception device 100b can execute the processing from step ST2901 to step ST2907 in parallel. Specifically, the first transmission/reception device 100b executes processing from step ST2902 to step ST2907 in parallel on the FIFO basis for the sixth optical signal acquired in step ST2901.

With the above configuration, the transmission/reception system 1b can perform transmission and reception of radio signals by the coherent detection system between each of the plurality of first transmission/reception devices 100b and the second transmission/reception device 200b in addition to between the second transmission/reception device 200b and the third transmission/reception device 300.

In addition, the transmission/reception system 1b according to the third embodiment can perform radio signal transmission of the QAM system having a higher multivalued degree, as compared with a conventional transmission/reception system constructed using an A/D converter having similar performance indices, not only for transmission and reception of radio signals between the second transmission/reception device 200b and the third transmission/reception device 300 but also for transmission and reception of radio signals between each of the plurality of first transmission/reception devices 100b and the second transmission/reception device 200b.

As described above, the transmission/reception system 1b according to the third embodiment is the transmission/reception system 1b that performs transmission and reception of radio signals in one-to-many connection between the third transmission/reception device 300 and the plurality of user terminals by performing the transmission and reception of the radio signals via an optical transmission line between a first transmission/reception device 100b installed at each of a plurality of antenna sites and the second transmission/reception device 200b installed in a relay station building and between the second transmission/reception device 200b and the third transmission/reception device 300 installed in a housing station building, in which the second transmission/reception device 200b includes: a relay station UL processing unit 201b including: the optical signal receiving unit 210b to receive a first optical signal output from each of the plurality of first transmission/reception devices 100b and output a multiplexed signal obtained by multiplexing a plurality of electrical signals based on the plurality of first optical signals; the first format conversion unit 220 to convert the multiplexed signal output from the optical signal receiving unit 210b into a first digital signal in a predetermined first format and output the first digital signal after conversion; the first DA conversion unit 230 to convert the first digital signal output from the first format conversion unit 220 into a first analog signal and output the first analog signal after conversion; and the first photoelectric conversion unit 240 to convert the first analog signal output from the first DA conversion unit 230 into a second optical signal and output the second optical signal after conversion; and the relay station DL processing unit 202b including: the first optical receiving FE unit 250 to receive an optical signal based on a fourth optical signal output from the third transmission/reception device 300 as a fifth optical signal and output a first electrical signal based on the fifth optical signal; the first AD conversion unit 260 to convert the first electrical signal output from the first optical receiving FE unit 250 into a second digital signal and output the second digital signal after conversion; the first digital demodulation unit 270 to demodulate the second digital signal output from the first AD conversion unit 260 to generate a third digital signal and output the generated third digital signal; and the optical signal output unit 290b to output each of a plurality of sixth optical signals based on the third digital signal output from the first digital demodulation unit 270 to a corresponding first transmission/reception device 100b, in which the third transmission/reception device 300 includes: the housing station UL processing unit 301 including: the second optical receiving FE unit 310 to receive an optical signal based on the second optical signal output from the second transmission/reception device 200b as a third optical signal and output a second electrical signal based on the third optical signal, the second AD conversion unit 320 to convert the second electrical signal output from the second optical receiving FE unit 310 into a fourth digital signal and output the fourth digital signal after conversion, and the second digital demodulation unit 330 to demodulate the fourth digital signal output from the second AD conversion unit 320 to generate a plurality of fifth digital signals and output the plurality of generated fifth digital signals; and the housing station DL processing unit 302 including: the second format conversion unit 340 to receive a plurality of sixth digital signals, convert the plurality of sixth digital signals into a seventh digital signal in a predetermined second format, and output the seventh digital signal after conversion; the second DA conversion unit 350 to convert the seventh digital signal output from the second format conversion unit 340 into a second analog signal, and output the second analog signal after conversion; and the second photoelectric conversion unit 360 to convert the second analog signal output from the second DA conversion unit 350 into the fourth optical signal, and output the fourth optical signal after conversion, in which the first transmission/reception device 100b includes: the antenna site UL processing unit 101b including: the third AD conversion unit 110 to receive a reception radio signal from the reception antenna 2, convert the reception radio signal into an eighth digital signal, and output the eighth digital signal after conversion; the third format conversion unit 120b to convert the eighth digital signal output from the third AD conversion unit 110 into a fourteenth digital signal in a predetermined sixth format, and output the fourteenth digital signal after conversion; the fourth DA conversion unit 170b to convert the fourteenth digital signal output from the third format conversion unit120b into a third analog signal, and output the third analog signal after conversion; and the third photoelectric conversion unit 130b to convert the third analog signal output from the fourth DA conversion unit 170b into the first optical signal, and output the first optical signal after conversion to the second transmission/reception device 200b; and the antenna site DL processing unit 102b including: the third optical receiving FE unit 180b to receive the sixth optical signal output from the second transmission/reception device 200b, convert the sixth optical signal into a fourth electrical signal, and output the fourth electrical signal after conversion; the fourth AD conversion unit 190b to convert the fourth electrical signal output from the third optical receiving FE unit 180b into a fifteenth digital signal, and output the fifteenth digital signal after conversion; the third digital demodulation unit 199b to demodulate the fifteenth digital signal output from the fourth AD conversion unit 190b to generate a tenth digital signal, and output the generated tenth digital signal; the fourth format conversion unit 150 to convert the tenth digital signal output from the third digital demodulation unit 199b into an eleventh digital signal in a predetermined fourth format, and output the eleventh digital signal after conversion; and the third DA conversion unit 160 to convert the eleventh digital signal output from the fourth format conversion unit 150 into a transmission radio signal and output the transmission radio signal after conversion to the transmission antenna 3, in which the optical signal receiving unit 210b included in the relay station UL processing unit 201b included in the second transmission/reception device 200b includes: the plurality of fourth optical receiving FE units 213b, each of the fourth optical receiving FE units 213b converting the first optical signal output from the first transmission/reception device 100b into a fifth electrical signal and outputting the fifth electrical signal after conversion; the plurality of fifth AD conversion units 214b, each of the fifth AD conversion units 214b converting the fifth electrical signal output from the fourth optical receiving FE unit 213b into a sixteenth digital signal and outputting the sixteenth digital signal after conversion; the plurality of fourth digital demodulation units 216b, each of the fourth digital demodulation units 216b demodulating the sixteenth digital signal output from the fifth AD conversion unit 214b to generate a seventeenth digital signal, and outputting the generated seventeenth digital signal; and the first multiplexing unit 212b to multiplex the seventeenth digital signals output from each of the plurality of fourth digital demodulation units 216b to generate the multiplexed signal, and outputs the generated multiplexed signal, and in which the optical signal output unit 290b included in the relay station DL processing unit 202b included in the second transmission/reception device 200b includes: the first separation unit 292b to separate the third digital signal output from the first digital demodulation unit 270 into a plurality of eighteenth digital signals and output the plurality of eighteenth digital signals after separation; the plurality of fifth format conversion units 291b, each of the fifth format conversion units 291b converting a corresponding eighteenth digital signal among the plurality of eighteenth digital signals output from the first separation unit 292b into a nineteenth digital signal in a predetermined seventh format and outputting the nineteenth digital signal after conversion; the plurality of fifth DA conversion units 294b, each of the fifth DA conversion units 294b converting the nineteenth digital signal output from the fifth format conversion unit 291b into a fifth analog signal and outputting the fifth analog signal after conversion; and the plurality of sixth photoelectric conversion units 293b, each of the sixth photoelectric conversion units 293b converting the fifth analog signal output from the fifth DA conversion unit 294b into the sixth optical signal and outputting the sixth optical signal after conversion.

With such a configuration, the transmission/reception system 1b according to the third embodiment can perform the radio signal transmission of the QAM system having a higher multivalued degree as compared with the conventional transmission/reception system even if the transmission/reception system 1b is constructed using the A/D converter having the similar performance indices.

In particular, the transmission/reception system 1b according to the third embodiment can perform the radio signal transmission of the QAM system having a higher multivalued degree as compared with the conventional transmission/reception system constructed using the A/D converter having the similar performance indices, not only for the transmission and reception of radio signals between the second transmission/reception device 200b and the third transmission/reception device 300 but also for the transmission and reception of radio signals between each of the plurality of first transmission/reception devices 100b and the second transmission/reception device 200b.

In addition, the transmission/reception system 1b according to the third embodiment is configured in such a manner that, in the above-described configuration, the first format conversion unit 220 included in the second transmission/reception device 200b and the second format conversion unit 340 included in the third transmission/reception device 300 convert radio signals into digital signals in a format that causes the second transmission/reception device 200b and the third transmission/reception device 300 to mutually perform transmission and reception of radio signals by the coherent detection system in the transmission and reception of radio signals between the second transmission/reception device 200b and the third transmission/reception device 300, and the third format conversion unit 120b included in the antenna site UL processing unit 101b included in the first transmission/reception device 100b and the fifth format conversion unit 291b in the optical signal output unit 290b included in the relay station DL processing unit 202b included in the second transmission/reception device 200b convert radio signals into digital signals in a format that causes the first transmission/reception device 100b and the second transmission/reception device 200b to mutually perform transmission and reception of radio signals by the coherent detection system in the transmission and reception of radio signals between the first transmission/reception device 100b and the second transmission/reception device 200b.

With such a configuration, the transmission/reception system 1b according to the third embodiment can perform the radio signal transmission of the QAM system having a higher multivalued degree as compared with the conventional transmission/reception system even if the transmission/reception system 1b is constructed using the A/D converter having the similar performance indices.

In particular, the transmission/reception system 1b according to the third embodiment can perform the radio signal transmission of the QAM system having a higher multivalued degree as compared with the conventional transmission/reception system constructed using the A/D converter having the similar performance indices, not only for the transmission and reception of radio signals between the second transmission/reception device 200b and the third transmission/reception device 300 but also for the transmission and reception of radio signals between each of the plurality of first transmission/reception devices 100b and the second transmission/reception device 200b.

Fourth Embodiment.

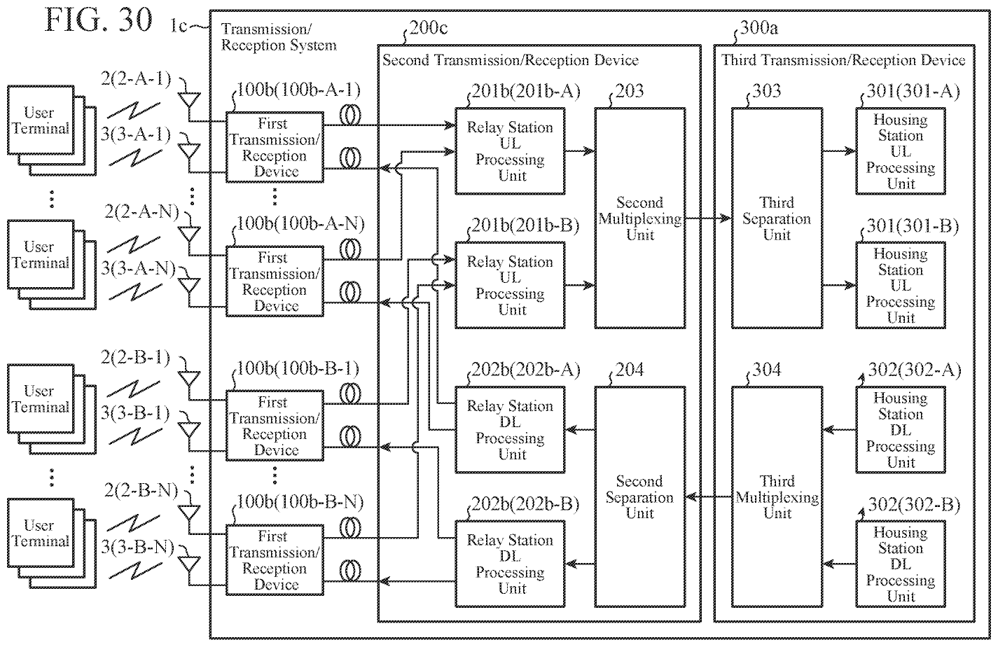

A transmission/reception system 1c according to a fourth embodiment will be described with reference to FIGS. 30 to 32.

A configuration of a main part of the transmission/reception system 1c according to the fourth embodiment will be described with reference to FIG. 30.

Note that, in FIG. 30, the same reference numerals are given to the same configurations as those illustrated in FIG. 16, FIG. 21, FIG. 22, or FIG. 23, and the description thereof is omitted.

FIG. 30 is a block diagram illustrating an example of a configuration of a main part of the transmission/reception system 1c according to the fourth embodiment.

The transmission/reception system 1c includes a plurality of first transmission/reception devices 100b, a second transmission/reception device 200c, and a third transmission/reception device 300a.

Each of the plurality of first transmission/reception devices 100b included in the transmission/reception system 1c according to the fourth embodiment is similar to the first transmission/reception device 100b according to the third embodiment.

The third transmission/reception device 300a included in the transmission/reception system 1c according to the fourth embodiment is similar to the third transmission/reception device 300a according to the second embodiment.

FIG. 30 illustrates N first transmission/reception devices 100b-A-1, . . . , and 100b-A-N and N first transmission/reception devices 100b-B-1, . . . , and 100b-B-N as the plurality of first transmission/reception devices 100b.

Each of the plurality of first transmission/reception devices 100b is connected to the reception antenna 2 and the transmission antenna 3.

FIG. 30 illustrates reception antennas 2-A-1, . . . , and 2-A-N and transmission antennas 3-A-1, . . . , and 3-A-N to which the N first transmission/reception devices 100b-A-1, . . . , and 100b-A-N are respectively connected and reception antennas 2-B-1, . . . , and 2-B-N and transmission antennas 3-B-1, . . . , and 3-B-N to which the N first transmission/reception devices 100b-B-1, . . . , and 100b-B-N are respectively connected.

The second transmission/reception device 200c included in the transmission/reception system 1c according to the fourth embodiment includes a second multiplexing unit 203, a second separation unit 204, a plurality of relay station UL processing units 201b, and a plurality of relay station DL processing units 202b.

Each of the plurality of relay station UL processing units 201b included in the second transmission/reception device 200c according to the fourth embodiment is similar to the relay station UL processing units 201b included in the second transmission/reception device 200b according to the third embodiment.

Each of the plurality of relay station DL processing units 202b included in the second transmission/reception device 200c according to the fourth embodiment is similar to the relay station DL processing unit 202b included in the second transmission/reception device 200b according to the third embodiment.

FIG. 30 illustrates the second transmission/reception device 200c including two relay station UL processing units 201b-A and 201b-B and two relay station DL processing units 202b-A and 202b-B as an example of the plurality of relay station UL processing units 201b and the plurality of relay station DL processing units 202b.

The number of the relay station UL processing units 201b included in the second transmission/reception device 200c is not limited to two, and may be three or more. In addition, the number of relay station DL processing units 202b included in the second transmission/reception device 200c is not limited to two, and may be three or more.

Each of the plurality of relay station UL processing units 201b included in the second transmission/reception device 200c is connected to the corresponding plurality of first transmission/reception devices 100b, and each of the plurality of relay station DL processing units 202b included in the second transmission/reception device 200c is connected to the corresponding plurality of first transmission/reception devices 100b.

The N first transmission/reception devices 100b-A-1, . . . , 100b-A-N illustrated in FIG. 30 are connected to the relay station UL processing unit 201b-A and the relay station DL processing unit 202b-A included in the second transmission/reception device 200c via optical transmission lines. In addition, the N first transmission/reception devices 100b-B-1, . . . , 100b-B-N illustrated in FIG. 30 are connected to the relay station UL processing unit 201b-B and the relay station DL processing unit 202b-B included in the second transmission/reception device 200c via optical transmission lines.

The second multiplexing unit 203 included in the second transmission/reception device 200c receives the second optical signal output from each of the plurality of relay station UL processing units 201b. The second multiplexing unit 203 multiplexes a plurality of second optical signals and outputs an optical signal after multiplexing as a second optical signal.

The second separation unit 204 included in the second transmission/reception device 200c receives the fifth optical signal based on the fourth optical signal output from the third transmission/reception device 300a. The second separation unit 204 separates the fifth optical signal to generate a plurality of optical signals, and outputs each of the plurality of generated optical signals as the fifth optical signal to the relay station DL processing unit 202b included in the second transmission/reception device 200c. In the fourth embodiment, since the second transmission/reception device 200c and the third transmission/reception device 300a are directly connected by the optical transmission line, the fifth optical signal received by the second separation unit 204 is the fourth optical signal output from the third transmission/reception device 300a.

The processing of the second transmission/reception device 200c is executed by the hardware configuration illustrated in FIG. 8A or 8B, for example, except for the processing from the reception of the optical signal to the conversion of the optical signal into the electrical signal and the processing from the conversion of the electrical signal into the optical signal to the output of the optical signal.

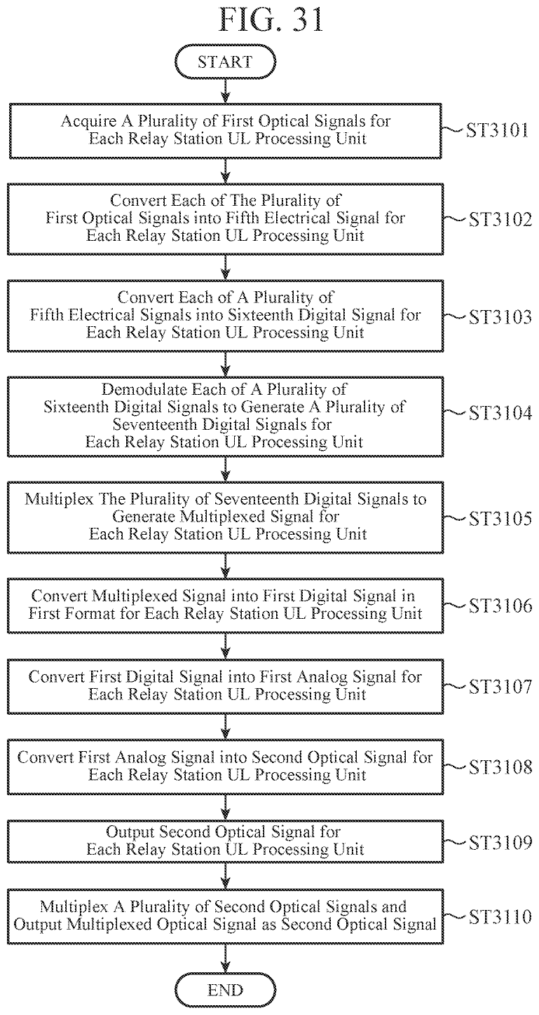

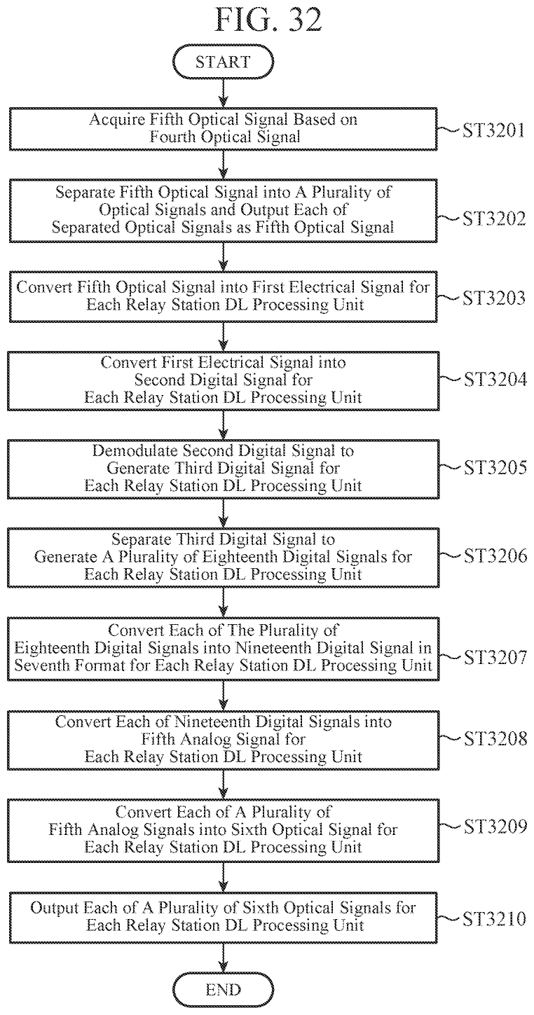

The operation of the transmission/reception system 1c according to the fourth embodiment will be described with reference to FIGS. 31 to 32.

Since the first transmission/reception device 100b according to the fourth embodiment is similar to the first transmission/reception device 100b according to the third embodiment, description of the uplink side operation and the downlink side operation in the first transmission/reception device 100b according to the fourth embodiment will be omitted.

Since the third transmission/reception device 300a according to the fourth embodiment is similar to the third transmission/reception device 300a according to the second embodiment, the description of the uplink side operation and the downlink side operation in the third transmission/reception device 300a according to the fourth embodiment will be omitted.

The uplink side operation in the second transmission/reception device 200c according to the fourth embodiment will be described with reference to FIG. 31.

FIG. 31 is a flowchart illustrating an example of uplink side processing in the second transmission/reception device 200c according to the fourth embodiment.

After the first transmission/reception device 100b executes the processing of the flowchart illustrated in FIG. 26, the second transmission/reception device 200c executes the processing of the flowchart illustrated in FIG. 31.

After the first transmission/reception device 100b executes the processing in step ST2606 illustrated in FIG. 26, first, in step ST3101, the plurality of fourth optical receiving FE units 213b included in the optical signal receiving unit 210b in each of the relay station UL processing units 201b-A and 201b-B acquires the plurality of first optical signals.

Next, in step ST3102, the plurality of fourth optical receiving FE units 213b included in the optical signal receiving unit 210b in each of the relay station UL processing units 201b-A and 201b-B convert each of the plurality of first optical signals into a fifth electrical signal and outputs the fifth electrical signal.

Next, in step ST3103, the plurality of fifth AD conversion units 214b included in the optical signal receiving unit 210b in each of the relay station UL processing units 201b-A and 201b-B convert each of the plurality of fifth electrical signals into the sixteenth digital signal and outputs the plurality of sixteenth digital signals.

Next, in step ST3104, the plurality of fourth digital demodulation units 216b included in the optical signal receiving unit 210b in each of the relay station UL processing units 201b-A and 201b-B demodulate each of the plurality of sixteenth digital signals to generate the plurality of seventeenth digital signals, and outputs the plurality of seventeenth digital signals.

Next, in step ST3105, the first multiplexing unit 212b included in the optical signal receiving unit 210b in each of the relay station UL processing units 201b-A and 201b-B multiplexes the plurality of seventeenth digital signals to generate a multiplexed signal, and outputs the multiplexed signal.

Next, in step ST3106, the first format conversion unit 220 in each of the relay station UL processing units 201b-A and 201b-B converts the multiplexed signal into a first digital signal in the first format and outputs the first digital signal.

Next, in step ST3107, the first DA conversion unit 230 in each of the relay station UL processing units 201b-A and 201b-B converts the first digital signal into a first analog signal and outputs the first analog signal.

Next, in step ST3108, the first photoelectric conversion unit 240 in each of the relay station UL processing units 201b-A and 201b-B converts the first analog signal into a second optical signal.

Next, in step ST3109, the first photoelectric conversion unit 240 in each of the relay station UL processing units 201b-A and 201b-B outputs the second optical signal.

Next, in step ST3110, the second multiplexing unit 203 multiplexes the plurality of second optical signals and outputs the optical signal after multiplexing as the second optical signal.

After step ST3110, the second transmission/reception device 200c ends the processing of the flowchart. After ending the processing of the flowchart, the second transmission/reception device 200c returns to step ST3101 and repeatedly executes the processing of the flowchart.

Note that the second transmission/reception device 200c can execute the processing from step ST3101 to step ST3110 in parallel. Specifically, the second transmission/reception device 200c executes the processing from step ST3102 to step ST3110 in parallel on the FIFO basis for the plurality of first optical signals acquired in step ST3101.

The downlink side operation in the second transmission/reception device 200c according to the fourth embodiment will be described with reference to FIG. 32.

FIG. 32 is a flowchart illustrating an example of downlink side processing in the second transmission/reception device 200c according to the fourth embodiment.

The second transmission/reception device 200c executes the processing of the flowchart illustrated in FIG. 32 after the third transmission/reception device 300a executes the processing of the flowchart illustrated in FIG. 19.

After the third transmission/reception device 300a executes the processing in step ST1906 illustrated in FIG. 19, first, in step ST3201, the third separation unit 303 acquires the fifth optical signal based on the fourth optical signal.

Next, in step ST3202, the third separation unit 303 separates the fifth optical signal into a plurality of optical signals, and outputs each of the optical signals after separation as a fifth optical signal.

Next, in step ST3203, the first optical receiving FE unit 250 in each of the relay station DL processing units 202b-A and 202b-B converts the fifth optical signal into a first electrical signal and outputs the first electrical signal.

Next, in step ST3204, the first AD conversion unit 260 in each of the relay station DL processing units 202b-A and 202b-B converts the first electrical signal into a second digital signal and outputs the second digital signal.

Next, in step ST3205, the first digital demodulation unit 270 in each of the relay station DL processing units 202b-A and 202b-B demodulates the second digital signal to generate a third digital signal and outputs the third digital signal.

Next, in step ST3206, the first separation unit 292b included in the optical signal output unit 290b in each of the relay station DL processing units 202b-A and 202b-B separates the third digital signal to generate a plurality of eighteenth digital signals, and outputs the plurality of eighteenth digital signals.

Next, in step ST3207, the plurality of fifth format conversion units 291b included in the optical signal output unit 290b in each of the relay station DL processing units 202b-A and 202b-B converts each of the plurality of eighteenth digital signals into a nineteenth digital signal in the seventh format, and outputs the plurality of nineteenth digital signals.

Next, in step ST3208, the fifth DA conversion unit 294b included in the optical signal output unit 290b in each of the relay station DL processing units 202b-A and 202b-B converts each of the nineteenth digital signals into a fifth analog signal and outputs the plurality of fifth analog signals.

Next, in step ST3209, the plurality of sixth photoelectric conversion units 293b included in the optical signal output unit 290b in each of the relay station DL processing units 202b-A and 202b-B convert each of the plurality of fifth analog signals into a sixth optical signal.

Next, in step ST3210, the plurality of sixth photoelectric conversion units 293b included in the optical signal output unit 290b in each of the relay station DL processing units 202b-A and 202b-B output each of the plurality of sixth optical signals.

After step ST3210, the second transmission/reception device 200c ends the processing of the flowchart. After ending the processing of the flowchart, the second transmission/reception device 200c returns to step ST3201 and repeatedly executes the processing of the flowchart.

Note that the second transmission/reception device 200c can execute the processing from step ST3201 to step ST3210 in parallel. Specifically, the second transmission/reception device 200c executes processing from step ST3202 to step

ST3210 in parallel on the FIFO basis for the fifth optical signal acquired in step ST3201.

With the above configuration, the transmission/reception system 1c according to the fourth embodiment can perform transmission of a plurality of radio signals different from each other and reception of a plurality of radio signals different from each other between the second transmission/reception device 200c and the third transmission/reception device 300a and between each of the plurality of first transmission/reception devices 100b and the second transmission/reception device 200c by using a pair of optical transmission lines while enabling radio signal transmission of the QAM system having a higher multivalued degree as compared with the conventional transmission/reception system, not only for transmission and reception of radio signals between the second transmission/reception device 200c and the third transmission/reception device 300a but also for transmission and reception of radio signals between each of the plurality of first transmission/reception devices 100b and the second transmission/reception device 200c.

As described above, the transmission/reception system 1c according to the fourth embodiment is a transmission/reception system 1c that performs transmission and reception of radio signals in one-to-many connection between a third transmission/reception device 300a and a plurality of user terminals by performing the transmission and reception of the radio signals via an optical transmission line between a first transmission/reception device 100b installed at each of a plurality of antenna sites and a second transmission/reception device 200c installed in a relay station building and between the second transmission/reception device 200c and the third transmission/reception device 300a installed in a housing station building, in which the second transmission/reception device 200c includes: a relay station UL processing unit 201b including: an optical signal receiving unit 210b to receive a first optical signal output from each of the plurality of first transmission/reception devices 100b and output a multiplexed signal obtained by multiplexing a plurality of electrical signals based on the plurality of first optical signals; a first format conversion unit 220 to convert the multiplexed signal output from the optical signal receiving unit 210b into a first digital signal in a predetermined first format and output the first digital signal after conversion; a first DA conversion unit 230 to convert the first digital signal output from the first format conversion unit 220 into a first analog signal and output the first analog signal after conversion; and a first photoelectric conversion unit 240 to convert the first analog signal output from the first DA conversion unit 230 into a second optical signal and output the second optical signal after conversion; and a relay station DL processing unit 202b including: a first optical receiving FE unit 250 to receive an optical signal based on a fourth optical signal output from the third transmission/reception device 300a as a fifth optical signal and output a first electrical signal based on the fifth optical signal; a first AD conversion unit 260 to convert the first electrical signal output from the first optical receiving FE unit 250 into a second digital signal and output the second digital signal after conversion; a first digital demodulation unit 270 to demodulate the second digital signal output from the first AD conversion unit 260 to generate a third digital signal and output the generated third digital signal; and an optical signal output unit 290b to output each of a plurality of sixth optical signals based on the third digital signal output from the first digital demodulation unit 270 to a corresponding first transmission/reception device 100b, in which the third transmission/reception device 300a includes: a housing station UL processing unit 301 including: a second optical receiving FE unit 310 to receive an optical signal based on the second optical signal output from the second transmission/reception device 200c as a third optical signal and output a second electrical signal based on the third optical signal; a second AD conversion unit 320 to convert the second electrical signal output from the second optical receiving FE unit 310 into a fourth digital signal and output the fourth digital signal after conversion, and a second digital demodulation unit 330 to demodulate the fourth digital signal output from the second AD conversion unit 320 to generate a plurality of fifth digital signals and output the plurality of generated fifth digital signals; and a housing station DL processing unit 302 including: a second format conversion unit 340 to receive a plurality of sixth digital signals, convert the plurality of sixth digital signals into a seventh digital signal in a predetermined second format, and output the seventh digital signal after conversion; a second DA conversion unit 350 to convert the seventh digital signal output from the second format conversion unit 340 into a second analog signal, and output the second analog signal after conversion; and a second photoelectric conversion unit 360 to convert the second analog signal output from the second DA conversion unit 350 into the fourth optical signal, and output the fourth optical signal after conversion, in which the first transmission/reception device 100b includes: an antenna site UL processing unit 101b including: a third AD conversion unit 110 to receive a reception radio signal from the reception antenna 2, convert the reception radio signal into an eighth digital signal, and output the eighth digital signal after conversion; a third format conversion unit 120b to convert the eighth digital signal output from the third AD conversion unit 110 into a fourteenth digital signal in a predetermined sixth format, and output the fourteenth digital signal after conversion; a fourth DA conversion unit 170b to convert the fourteenth digital signal output from the third format conversion unit 120b into a third analog signal, and output the third analog signal after conversion; and a third photoelectric conversion unit 130b to convert the third analog signal output from the fourth DA conversion unit 170b into the first optical signal, and output the first optical signal after conversion to the second transmission/reception device 200c; and an antenna site DL processing unit 102b including: a third optical receiving FE unit 180b to receive the sixth optical signal output from the second transmission/reception device 200c, convert the sixth optical signal into a fourth electrical signal, and output the fourth electrical signal after conversion; a fourth AD conversion unit 190b to convert the fourth electrical signal output from the third optical receiving FE unit 180b into a fifteenth digital signal, and output the fifteenth digital signal after conversion; a third digital demodulation unit 199b to demodulate the fifteenth digital signal output from the fourth AD conversion unit 190b to generate a tenth digital signal, and output the generated tenth digital signal; a fourth format conversion unit 150 to convert the tenth digital signal output from the third digital demodulation unit 199b into an eleventh digital signal in a predetermined fourth format, and output the eleventh digital signal after conversion; and a third DA conversion unit 160 to convert the eleventh digital signal output from the fourth format conversion unit 150 into a transmission radio signal and output the transmission radio signal after conversion to the transmission antenna 3, in which the optical signal receiving unit 210b included in the relay station UL processing unit 201b included in the second transmission/reception device 200c includes: a plurality of fourth optical receiving FE units 213b, each of the fourth optical receiving FE units 213b converting the first optical signal output from the first transmission/reception device 100b into a fifth electrical signal and outputting the fifth electrical signal after conversion; a plurality of fifth AD conversion units 214b, each of the fifth AD conversion units 214b converting the fifth electrical signal output from the fourth optical receiving FE unit 213b into a sixteenth digital signal and outputting the sixteenth digital signal after conversion; a plurality of fourth digital demodulation units 216b, each of the fourth digital demodulation units 216b demodulating the sixteenth digital signal output from the fifth AD conversion unit 214b to generate a seventeenth digital signal, and outputting the generated seventeenth digital signal; and a first multiplexing unit 212b to multiplex the seventeenth digital signals output from each of the plurality of fourth digital demodulation units 216b to generate the multiplexed signal, and outputs the generated multiplexed signal, and in which the optical signal output unit 290b included in the relay station DL processing unit 202b included in the second transmission/reception device 200c includes: a first separation unit 292b to separate the third digital signal output from the first digital demodulation unit 270 into a plurality of eighteenth digital signals and output the plurality of eighteenth digital signals after separation; a plurality of fifth format conversion units 291b, each of the fifth format conversion units 291b converting a corresponding eighteenth digital signal among the plurality of eighteenth digital signals output from the first separation unit 292b into a nineteenth digital signal in a predetermined seventh format and outputting the nineteenth digital signal after conversion; a plurality of fifth DA conversion units 294b, each of the fifth DA conversion units 294b converting the nineteenth digital signal output from the fifth format conversion unit 291b into a fifth analog signal and outputting the fifth analog signal after conversion; and a plurality of sixth photoelectric conversion units 293b, each of the sixth photoelectric conversion units 293b converting the fifth analog signal output from the fifth DA conversion unit 294b into the sixth optical signal and outputting the sixth optical signal after conversion, in which the second transmission/reception device 200c includes: the plurality of relay station UL processing units 201b; a second multiplexing unit 203 to multiplex the second optical signal output from each of the plurality of relay station UL processing units 201b and output an optical signal after multiplexing as the second optical signal; the plurality of relay station DL processing units 202b; and a second separation unit 204 to receive an optical signal based on the fourth optical signal output from the third transmission/reception device 300a as the fifth optical signal, separate the fifth optical signal into a plurality of optical signals, and output each of the plurality of optical signals after separation as the fifth optical signal to the corresponding relay station DL processing unit 202b, and in which the third transmission/reception device 300a includes: the plurality of housing station UL processing units 301; a third separation unit 303 to receive an optical signal based on the second optical signal output from the second transmission/reception device 200c as the third optical signal, separate the third optical signal into a plurality of optical signals, and output each of the plurality of optical signals after separation as the third optical signal to the corresponding housing station UL processing unit 301; the plurality of housing station DL processing units 302; and a third multiplexing unit 304 to multiplex the fourth optical signal output from each of the plurality of relay station UL processing units 201b and output an optical signal after multiplexing as the fourth optical signal.

With such a configuration, the transmission/reception system 1c according to the fourth embodiment can perform transmission of a plurality of radio signals different from each other and reception of a plurality of radio signals different from each other using a pair of optical transmission lines while enabling radio signal transmission of the QAM system having a higher multivalued degree as compared with the conventional transmission/reception system even if the transmission/reception system 1c is constructed using the A/D converter having the same performance indices.

In particular, the transmission/reception system 1c according to the fourth embodiment can perform transmission of a plurality of radio signals different from each other and reception of a plurality of radio signals different from each other using a pair of optical transmission lines between the second transmission/reception device 200c and the third transmission/reception device 300a and between each of the plurality of first transmission/reception devices 100b and the second transmission/reception device 200c while enabling radio signal transmission of the QAM system having a higher multivalued degree as compared with the conventional transmission/reception system not only for transmission and reception of radio signals between the second transmission/reception device 200c and the third transmission/reception device 300a but also for transmission and reception of radio signals between each of the plurality of first transmission/reception devices 100b and the second transmission/reception device 200c.

Fifth Embodiment.

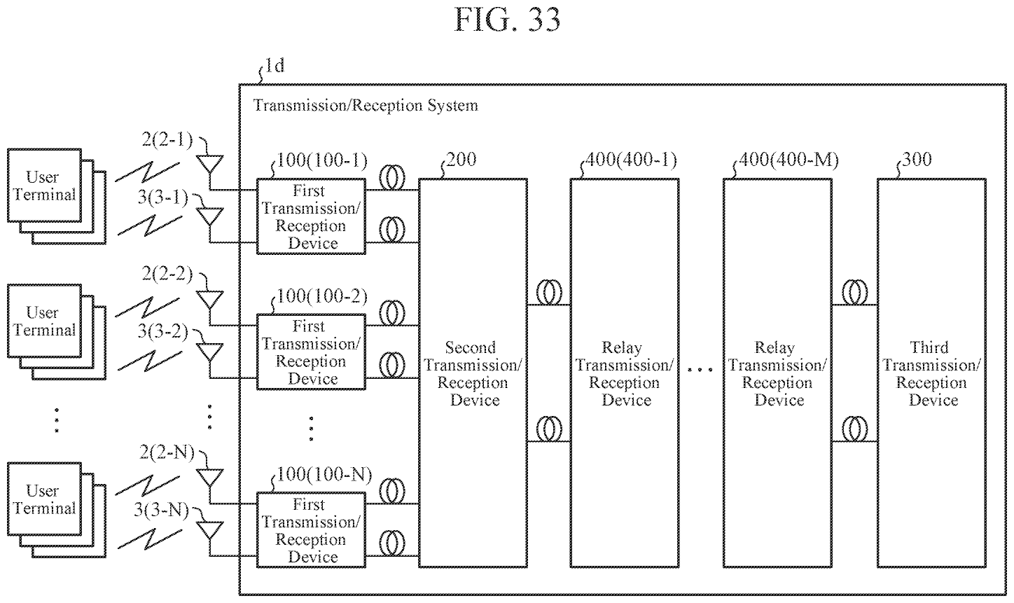

A transmission/reception system 1d according to a fifth embodiment will be described with reference to FIGS. 33 to 39.

A configuration of a main part of the transmission/reception system 1d according to the fifth embodiment will be described with reference to FIG. 33.

FIG. 33 is a block diagram illustrating an example of a configuration of a main part of the transmission/reception system 1d according to the fifth embodiment.

The transmission/reception system 1d includes a plurality of first transmission/reception devices 100, a second transmission/reception device 200, one or more relay transmission/reception devices 400, and a third transmission/reception device 300.

As compared with the transmission/reception system 1 according to the first embodiment, the transmission/reception system 1d according to the fifth embodiment includes one or more relay transmission/reception devices 400 between the second transmission/reception device 200 and the third transmission/reception device 300 included in the transmission/reception system 1 according to the first embodiment.

Specifically, the first transmission/reception device 100, the second transmission/reception device 200, and the third transmission/reception device 300 included in the transmission/reception system 1d according to the fifth embodiment are similar to the first transmission/reception device 100, the second transmission/reception device 200, and the third transmission/reception device 300 according to the first embodiment, and thus detailed description of the first transmission/reception device 100, the second transmission/reception device 200, and the third transmission/reception device 300 is omitted in the fifth embodiment.

Note that in FIG. 33, the same components as those illustrated in FIG. 1 are denoted by the same reference numerals, and description thereof is omitted.

FIG. 33 illustrates M (M is a natural number of 1 or more) relay transmission/reception devices 400-1, . . . , and 400-M as one or more relay transmission/reception devices 400.

The one or more relay transmission/reception devices 400 are connected by cascade connection between the second transmission/reception device 200 and the third transmission/reception device 300 in the transmission/reception system 1d, and one end of the cascade connection is connected to the second transmission/reception device 200 and the other end is connected to the third transmission/reception device 300.

Note that, in the fifth embodiment, one or more relay transmission/reception devices 400 are described as being connected by cascade connection between the second transmission/reception device 200 and the third transmission/reception device 300. However, one or more relay transmission/reception devices 400 may be connected by cascade connection between the second transmission/reception device 200a and the third transmission/reception device 300a included in the transmission/reception system la according to the second embodiment, may be connected by cascade connection between the second transmission/reception device 200b and the third transmission/reception device 300 included in the transmission/reception system 1b according to the third embodiment, or may be connected by cascade connection between the second transmission/reception device 200c and the third transmission/reception device 300a included in the transmission/reception system 1c according to the fourth embodiment.

Each of the one or more relay transmission/reception devices 400 is a transmission/reception device installed in a relay station building different from the relay station building disposed between the housing station building and the relay station building in which the second transmission/reception device 200 is installed.

The second transmission/reception device 200 and the relay transmission/reception device 400-1 mutually perform transmission and reception of radio signals via an optical transmission line. In addition, the third transmission/reception device 300 and the relay transmission/reception device 400-M mutually perform transmission and reception of radio signals via an optical transmission line. In a case where there are a plurality of relay transmission/reception devices 400, a relay transmission/reception device 400-K (K is a natural number of 1 or more and smaller than M) and a relay transmission/reception device 400-K+1 mutually perform transmission and reception of radio signals via an optical transmission line. The optical transmission line includes, for example, an optical fiber cable.

Specifically, the second transmission/reception device 200 generates a second optical signal on the basis of a plurality of received first optical signals, and outputs the generated second optical signal.

The relay transmission/reception device 400-1 receives the second optical signal output from the second transmission/reception device 200 via the optical transmission line.

The relay transmission/reception device 400-1 generates a third optical signal on the basis of the received second optical signal, and outputs the generated third optical signal.

The relay transmission/reception device 400-K+1 receives the third optical signal output from the relay transmission/reception device 400-K via the optical transmission line.

The relay transmission/reception device 400-K+1 generates a third optical signal on the basis of the received third optical signal, and outputs the generated third optical signal.

In a case where M is 1, the relay transmission/reception device 400-M receives the second optical signal output from the second transmission/reception device 200 via the optical transmission line, and in a case where M is 2 or more, the relay transmission/reception device 400-M receives the third optical signal output from the relay transmission/reception device 400-M-1 via the optical transmission line.

The relay transmission/reception device 400-M generates a third optical signal on the basis of the received second optical signal or third signal, and outputs the generated third optical signal.

The third transmission/reception device 300 receives the third optical signal output from the relay transmission/reception device 400-M and based on the second optical signal via the optical transmission line.

In addition, the third transmission/reception device 300 outputs the fourth optical signal.

The relay transmission/reception device 400-M receives the fourth optical signal output from the third transmission/reception device 300.

The relay transmission/reception device 400-M generates a fifth optical signal on the basis of the received fourth optical signal, and outputs the generated fifth optical signal.

The relay transmission/reception device 400-K receives the fifth optical signal output from the relay transmission/reception device 400-K+1 via the optical transmission line.

The relay transmission/reception device 400-K generates a fifth optical signal on the basis of the received fifth optical signal, and outputs the generated fifth optical signal.

The relay transmission/reception device 400-1 receives, in a case where M is 1, the fourth optical signal output from the third transmission/reception device 300 via the optical transmission line, and receives, in a case where M is 2 or more, the fifth optical signal output from the relay transmission/reception device 400-2 via the optical transmission line.

The relay transmission/reception device 400-1 generates a fifth optical signal on the basis of the received fourth optical signal or fifth signal, and outputs the generated fifth optical signal.

The second transmission/reception device 200 receives the fifth optical signal output from the relay transmission/reception device 400-1 and based on the fourth signal via the optical transmission line.

The second transmission/reception device 200 generates a plurality of sixth optical signals on the basis of the received fifth optical signal, and outputs the plurality of generated sixth optical signals.

With the above configuration, the transmission/reception system 1d can perform transmission and reception of radio signals in one-to-many connection between the third transmission/reception device 300 and the plurality of user terminals.

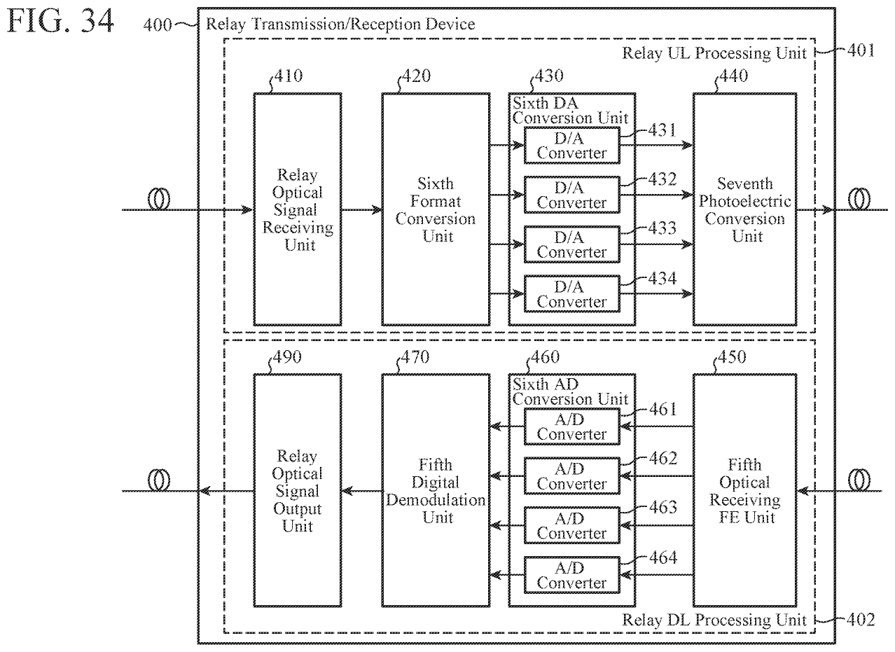

A configuration of a main part of the relay transmission/reception device 400 according to the fifth embodiment will be described with reference to FIG. 34.

FIG. 34 is a block diagram illustrating an example of a configuration of a main part of the relay transmission/reception device 400 according to the fifth embodiment.

The relay transmission/reception device 400 includes a relay UL processing unit 401 and a relay DL processing unit 402.

The relay UL processing unit 401 performs uplink (UL) side processing in the relay transmission/reception device 400. That is, the relay UL processing unit 401 performs radio signal processing in a direction from the first transmission/reception device 100 to the third transmission/reception device 300 in the relay transmission/reception device 400.

Specifically, the relay UL processing unit 401 receives the second optical signal output from the second transmission/reception device 200 or the third optical signal output from the first relay transmission/reception device 400 that is another relay transmission/reception device 400 different from the relay transmission/reception device 400. The relay UL processing unit 401 converts the second optical signal or the third optical signal into a third optical signal, and outputs the third optical signal after conversion to the third transmission/reception device 300 or the second relay transmission/reception device 400 which is another relay transmission/reception device 400 different from the relay transmission/reception device 400.

More specifically, the relay UL processing unit 401 includes a relay optical signal receiving unit 410, a sixth format conversion unit 420, a sixth DA conversion unit 430, and a seventh photoelectric conversion unit 440. The relay UL processing unit 401 includes the relay optical signal receiving unit 410, the sixth format conversion unit 420, the sixth DA conversion unit 430, and the seventh photoelectric conversion unit 440, thereby converting the second optical signal or the third optical signal into a third optical signal and outputting the third optical signal after conversion.

The relay optical signal receiving unit 410, the sixth format conversion unit 420, the sixth DA conversion unit 430, and the seventh photoelectric conversion unit 440 included in the relay UL processing unit 401 will be described.

The relay optical signal receiving unit 410 receives the second optical signal output from the second transmission/reception device 200 or the third optical signal output from the first relay transmission/reception device 400 that is another relay transmission/reception device 400 different from the relay transmission/reception device 400, and outputs a twentieth digital signal based on the second optical signal or the third optical signal.

Details of the relay optical signal receiving unit 410 will be described later.

The sixth format conversion unit 420 converts the twentieth digital signal output from the relay optical signal receiving unit 410 into a twenty-first digital signal in a predetermined eighth format, and outputs the twenty-first digital signal after conversion.

Specifically, first, the sixth format conversion unit 420 converts the twentieth digital signal output from the relay optical signal receiving unit 410 into an I signal and a Q signal, and further polarizes and separates each of the I signal and the Q signal into an X polarization signal and a Y polarization signal, thereby converting the twentieth digital signal into the twenty-first digital signal in the eighth format.

That is, the conversion into the twenty-first digital signal in the eighth format performed by the sixth format conversion unit 420 is to convert the twentieth digital signal into the XI signal, the XQ signal, the YI signal, and the YQ signal, and the twenty-first digital signal is a digital signal including four digital signals of the XI signal, the XQ signal, the YI signal, and the YQ signal.

The sixth format conversion unit 420 converts the twentieth digital signal into the twenty-first digital signal in the eighth format including the XI signal, the XQ signal, the YI signal, and the YQ signal, so that the transmission/reception system 1d can perform transmission and reception of radio signals by the coherent detection system in transmission and reception of radio signals from the relay transmission/reception device 400 to the third transmission/reception device 300 or the second relay transmission/reception device 400 that is another relay transmission/reception device 400 different from the relay transmission/reception device

The sixth DA conversion unit 430 converts the twenty-first digital signal output from the sixth format conversion unit 420 into a sixth analog signal, and outputs the sixth analog signal after conversion.

Specifically, for example, the sixth DA conversion unit 430 includes four D/A converters 431, 432, 433, and 434 as illustrated in FIG. 34.

Specifically, the sixth DA conversion unit 430 converts each of the XI signal, the XQ signal, the YI signal, and the YQ signal, which are the twenty-first digital signals output from the sixth format conversion unit 420, into an analog signal by the corresponding D/A converter 431, 432, 433, or 434, and outputs the four analog signals after conversion as the sixth analog signals.

The seventh photoelectric conversion unit 440 converts the sixth analog signal output from the sixth DA conversion unit 430 into a third optical signal, and outputs the third optical signal after conversion. For example, the seventh photoelectric conversion unit 440 includes a photoelectric converter (not illustrated in FIG. 34).

Specifically, for example, the seventh photoelectric conversion unit 440 generates a third optical signal by the photoelectric converter performing E/O conversion on the sixth analog signal, and outputs the generated third optical signal to the third transmission/reception device 300 or the second relay transmission/reception device 400 that is another relay transmission/reception device 400 different from the relay transmission/reception device 400.

With the above configuration, the relay UL processing unit 401 converts the second optical signal or the third optical signal into the third optical signal, and outputs the third optical signal after conversion.

The relay DL processing unit 402 performs downlink (DL) side processing in the relay transmission/reception device 400. That is, the relay DL processing unit 402 performs radio signal processing in a direction from the third transmission/reception device 300 to the first transmission/reception device 100 in the relay transmission/reception device 400.

Specifically, the relay DL processing unit 402 receives the fourth optical signal output from the third transmission/reception device 300 or the fifth optical signal output from the second relay transmission/reception device 400 that is another relay transmission/reception device 400 different from the relay transmission/reception device 400. The relay DL processing unit 402 converts the fourth optical signal or the fifth optical signal into a fifth optical signal, and outputs the fifth optical signal after conversion to the second transmission/reception device 200 or the first relay transmission/reception device 400 that is another relay transmission/reception device 400 different from the relay transmission/reception device 400.

More specifically, the relay DL processing unit 402 includes a fifth optical receiving FE unit 450, a sixth AD conversion unit 460, a fifth digital demodulation unit 470, and a relay optical signal output unit 490. The relay DL processing unit 402 includes the fifth optical receiving FE unit 450, the sixth AD conversion unit 460, the fifth digital demodulation unit 470, and the relay optical signal output unit 490, thereby converting the fourth optical signal or the fifth optical signal into the fifth optical signal and outputting the fifth optical signal after conversion.

The fifth optical receiving FE unit 450, the sixth AD conversion unit 460, the fifth digital demodulation unit 470, and the relay optical signal output unit 490 included in the relay DL processing unit 402 will be described.

The fifth optical receiving FE unit 450 receives the fourth optical signal output from the third transmission/reception device 300 or the fifth optical signal output from the second relay transmission/reception device 400 that is another relay transmission/reception device 400 different from the relay transmission/reception device 400, and outputs the sixth electrical signal based on the fourth optical signal or the fifth optical signal.

The fifth optical receiving FE unit 450 includes, for example, an optical reception front end circuit 600 illustrated in FIG. 6 as an example.

Specifically, the fifth optical receiving FE unit 450 generates four analog signals on the basis of the fourth optical signal or the fifth optical signal, and outputs the generated four analog signals as sixth electrical signals.

The sixth AD conversion unit 460 converts the sixth electrical signal output from the fifth optical receiving FE unit 450 into a twenty-second digital signal, and outputs the twenty-second digital signal after conversion.

Specifically, for example, the sixth AD conversion unit 460 includes four A/D converters 461, 462, 463, and 464 as illustrated in FIG. 34.

More specifically, for example, the sixth AD conversion unit 460 converts each of the four analog signals, which are the sixth electrical signals output from the fifth optical receiving FE unit 450, into a digital signal by the corresponding A/D converter 461, 462, 463, or 464, and outputs the four digital signals after conversion as the twenty-second digital signals.

The fifth digital demodulation unit 470 demodulates the twenty-second digital signal output from the sixth AD conversion unit 460 to generate a twenty-third digital signal, and outputs the generated twenty-third digital signal.

Specifically, the fifth digital demodulation unit 470 first performs polarization separation on the four digital signals that are the twenty-second digital signals output from the sixth AD conversion unit 460. Further, the fifth digital demodulation unit 470 demodulates the twenty-second digital signal by performing IQ separation on the signal after polarization separation to generate the twenty-third digital signal, and outputs the generated twenty-third digital signal.

The relay optical signal output unit 490 outputs a fifth optical signal based on the twenty-third digital signal output from the fifth digital demodulation unit 470.

Details of the relay optical signal output unit 490 will be described later.

With the above configuration, the relay DL processing unit 402 converts the fourth optical signal or the fifth optical signal into the fifth optical signal and outputs the fifth optical signal after conversion.

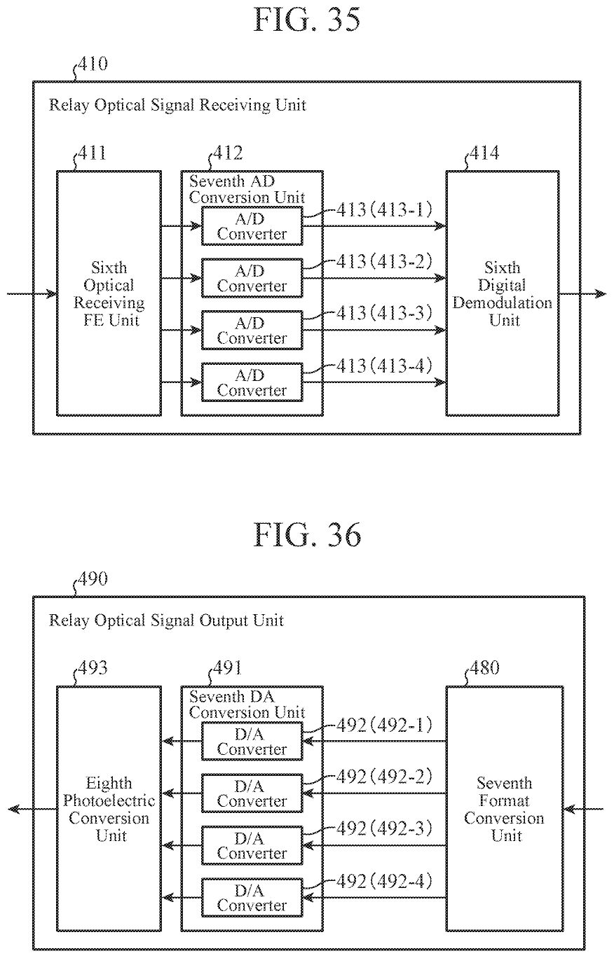

A configuration of a main part of the relay optical signal receiving unit 410 included in the relay transmission/reception device 400 according to the fifth embodiment will be described with reference to FIG. 35.

FIG. 35 is a block diagram illustrating an example of a configuration of a main part of the relay optical signal receiving unit 410 included in the relay transmission/reception device 400 according to the fifth embodiment.

The relay optical signal receiving unit 410 includes a sixth optical receiving FE unit 411, a seventh AD conversion unit 412, and a sixth digital demodulation unit 414.

The sixth optical receiving FE unit 411 is connected to the second transmission/reception device 200 or the first relay transmission/reception device 400 that is another relay transmission/reception device 400 different from the relay transmission/reception device 400 via an optical transmission line.

The sixth optical receiving FE unit 411 receives the second optical signal output from the second transmission/reception device 200 or the third optical signal output from the first relay transmission/reception device 400 that is another relay transmission/reception device 400 different from the relay transmission/reception device 400. The sixth optical receiving FE unit 411 converts the second optical signal or the third optical signal into a seventh electrical signal and outputs the seventh electrical signal after conversion. The sixth optical receiving FE unit 411 includes, for example, an optical reception front end circuit 600 illustrated in FIG. 6 as an example.

Specifically, the sixth optical receiving FE unit 411 generates four analog signals on the basis of the second optical signal or the third optical signal, and outputs the generated four analog signals as the seventh electrical signals.

The seventh AD conversion unit 412 converts the seventh electrical signal output from the sixth optical receiving FE unit 411 into a twenty-fourth digital signal, and outputs the twenty-fourth digital signal after conversion. For example, as illustrated in FIG. 35, the seventh AD conversion unit 412 includes four A/D converters 413 (413-1, 413-2, 413-3, and 413-4).

Specifically, the seventh AD conversion unit 412 converts each of the four analog signals, which are the seventh electrical signals output from the sixth optical receiving FE unit 411, into a digital signal by the corresponding A/D converter 413-1, 413-2, 413-3, or 413-4, and outputs the four digital signals after conversion as the twenty-fourth digital signals.

The sixth digital demodulation unit 414 demodulates the twenty-fourth digital signal output from the seventh AD conversion unit 412 to generate the twentieth digital signal, and outputs the generated twentieth digital signal.

Specifically, the sixth digital demodulation unit 414 first performs polarization separation on the four digital signals that are the twenty-fourth digital signals output from the seventh AD conversion unit 412. Further, the sixth digital demodulation unit 414 demodulates the twenty-fourth digital signal by performing IQ separation on the signal after polarization separation to generate the twentieth digital signal, and outputs the generated twentieth digital signal.

With the above configuration, the relay optical signal receiving unit 410 receives the second optical signal output from the second transmission/reception device 200 or the third optical signal output from the first relay transmission/reception device 400 that is another relay transmission/reception device 400 different from the relay transmission/reception device 400, and outputs the twentieth digital signal based on the second optical signal or the third optical signal.

A configuration of a main part of the relay optical signal output unit 490 included in the relay transmission/reception device 400 according to the fifth embodiment will be described with reference to FIG. 36.

FIG. 36 is a block diagram illustrating an example of a configuration of a main part of the relay optical signal output unit 490 included in the relay transmission/reception device 400 according to the fifth embodiment.

The relay optical signal output unit 490 includes a seventh format conversion unit 480, a seventh DA conversion unit 491, and an eighth photoelectric conversion unit 493.

The eighth photoelectric conversion unit 493 is connected to the second transmission/reception device 200 or the first relay transmission/reception device 400 that is another relay transmission/reception device 400 different from the relay transmission/reception device 400 via the optical transmission line.

The seventh format conversion unit 480 converts the twenty-third digital signal output from the fifth digital demodulation unit 470 into a twenty-fifth digital signal in a predetermined ninth format, and outputs the twenty-fifth digital signal after conversion.

Specifically, first, the seventh format conversion unit 480 converts the twenty-third digital signal output from the fifth digital demodulation unit 470 into an I signal and a Q signal, and further polarizes and separates each of the I signal and the Q signal into an X polarization signal and a Y polarization signal, thereby converting the twenty-third digital signal into a twenty-fifth digital signal in a ninth format.

That is, the conversion into the twenty-fifth digital signal in the ninth format performed by the seventh format conversion unit 480 is to convert the twenty-third digital signal into the XI signal, the XQ signal, the YI signal, and the YQ signal, and the twenty-fifth digital signal is a digital signal including four digital signals of the XI signal, the XQ signal, the YI signal, and the YQ signal.

The seventh format conversion unit 480 converts the twenty-third digital signal into the twenty-fifth digital signal in the ninth format including the XI signal, the XQ signal, the YI signal, and the YQ signal, so that the transmission/reception system 1d can perform transmission and reception of radio signals by the coherent detection system in transmission and reception of radio signals from the relay transmission/reception device 400 to the second transmission/reception device 200 or the first relay transmission/reception device 400 that is another relay transmission/reception device 400 different from the relay transmission/reception device 400.

The seventh DA conversion unit 491 converts the twenty-fifth digital signal output from the seventh format conversion unit 480 into a seventh analog signal, and outputs the seventh analog signal after conversion. For example, as illustrated in FIG. 36, the seventh DA conversion unit 491 includes four D/A converters 492 (492-1, 492-2, 492-3, and 492-4).

Specifically, the seventh DA conversion unit 491 converts each of the XI signal, the XQ signal, the YI signal, and the YQ signal, which are the twenty-fifth digital signals output from the seventh format conversion unit 480, into an analog signal by the corresponding D/A converter 492-1, 492-2, 492-3, or 492-4, and outputs the four analog signals after conversion as the seventh analog signals.

The eighth photoelectric conversion unit 493 converts the seventh analog signal output from the seventh DA conversion unit 491 into a fifth optical signal, and outputs the fifth optical signal after conversion. For example, the eighth photoelectric conversion unit 493 includes a photoelectric converter (not illustrated in FIG. 36).

Specifically, for example, the eighth photoelectric conversion unit 493 generates a fifth optical signal by the photoelectric converter performing E/O conversion on the seventh analog signal, and outputs the generated fifth optical signal to the second transmission/reception device 200 or the first relay transmission/reception device 400 that is another relay transmission/reception device 400 different from the relay transmission/reception device 400.

With the above configuration, the relay optical signal output unit 490 converts the twenty-third digital signal output from the fifth digital demodulation unit 470 into a twenty-fifth digital signal that is an electrical signal in a predetermined ninth format, and outputs a fifth optical signal based on the twenty-fifth digital signal after conversion to the second transmission/reception device 200 or the first relay transmission/reception device 400 that is another relay transmission/reception device 400 different from the relay transmission/reception device 400.

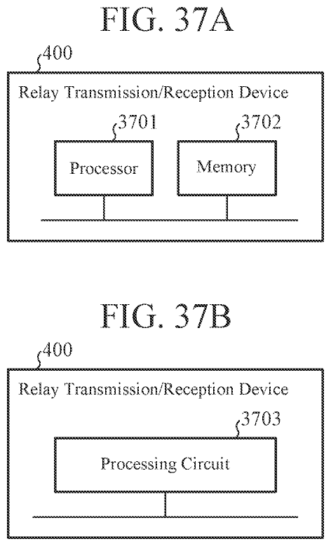

A hardware configuration of the relay transmission/reception device 400 according to the fifth embodiment will be described with reference to FIG. 37.

FIGS. 37A and 37B are diagrams illustrating an example of a hardware configuration of the relay transmission/reception device 400 according to the fifth embodiment.

The processing of the relay transmission/reception device 400 is executed by the hardware configuration illustrated in FIG. 37A or 37B, except for processing from reception of an optical signal to conversion of the optical signal into an electrical signal and processing from conversion of the electrical signal into an optical signal to output of the optical signal.

As illustrated in FIG. 37A, a part of the relay transmission/reception device 400 is configured by a computer, and the computer includes a processor 3701 and a memory 3702.

Further, as illustrated in FIG. 37B, a part of the relay transmission/reception device 400 may include a processing circuit 3703.

Furthermore, a part of the relay transmission/reception device 400 may include the processor 3701, the memory 3702, and the processing circuit 3703 (not illustrated).

Note that the processor 3701, the memory 3702, and the processing circuit 3703 are similar to the processor 701, the memory 702, and the processing circuit 703 illustrated in FIG. 7, respectively, and thus description of the processor 3701, the memory 3702, and the processing circuit 3703 is omitted.

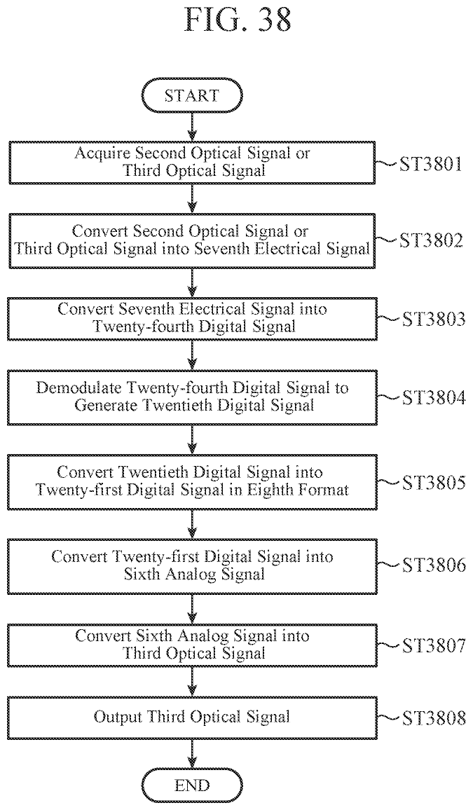

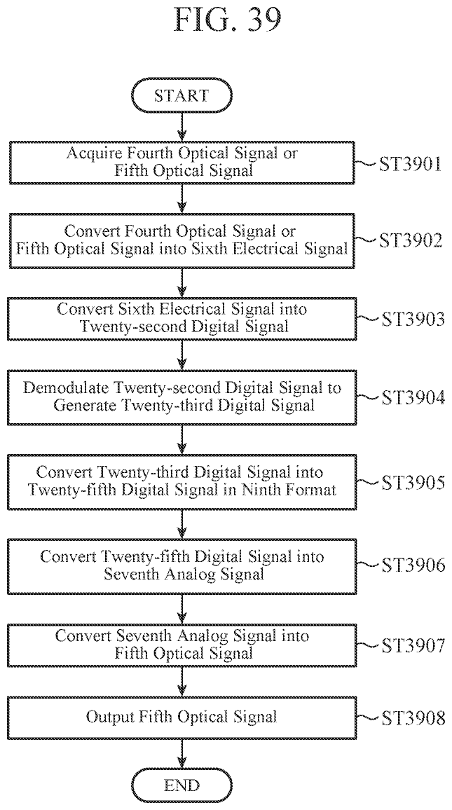

The operation of the transmission/reception system 1d according to the fifth embodiment will be described with reference to FIGS. 38 and 39.

Since the first transmission/reception device 100, the second transmission/reception device 200, and the third transmission/reception device 300 according to the fifth embodiment are similar to the first transmission/reception device 100, the second transmission/reception device 200, and the third transmission/reception device 300 according to the first embodiment, the description of the uplink side operation and the downlink side operation in each of the first transmission/reception device 100, the second transmission/reception device 200, and the third transmission/reception device 300 according to the fifth embodiment will be omitted.

The uplink side operation in the relay transmission/reception device 400 according to the fifth embodiment will be described with reference to FIG. 38.

FIG. 38 is a flowchart illustrating an example of uplink side processing in the relay transmission/reception device 400 according to the fifth embodiment.

First, in step ST3801, the sixth optical receiving FE unit 411 included in the relay optical signal receiving unit 410 acquires the second optical signal or the third optical signal.

Next, in step ST3802, the sixth optical receiving FE unit 411 included in the relay optical signal receiving unit 410 converts the second optical signal or the third optical signal into a seventh electrical signal and outputs the seventh electrical signal.

Next, in step ST3803, the seventh AD conversion unit 412 included in the relay optical signal receiving unit 410 converts the seventh electrical signal into a twenty-fourth digital signal and outputs the twenty-fourth digital signal.

Next, in step ST3804, the sixth digital demodulation unit 414 included in the relay optical signal receiving unit 410 demodulates the twenty-fourth digital signal to generate the twentieth digital signal, and outputs the twentieth digital signal.

Next, in step ST3805, the sixth format conversion unit 420 converts the twentieth digital signal into a twenty-first digital signal in the eighth format, and outputs the twenty-first digital signal.

Next, in step ST3806, the sixth DA conversion unit 430 converts the twenty-first digital signal into a sixth analog signal, and outputs the sixth analog signal.

Next, in step ST3807, the seventh photoelectric conversion unit 440 converts the sixth analog signal into a third optical signal.

Next, in step ST3808, the seventh photoelectric conversion unit 440 outputs the third optical signal.

After step ST3808, the relay transmission/reception device 400 ends the processing of the flowchart. After ending the processing of the flowchart, the relay transmission/reception device 400 returns to step ST3801 and repeatedly executes the processing of the flowchart.

Note that the relay transmission/reception device 400 can execute the processing from step ST3801 to step ST3808 in parallel. Specifically, the relay transmission/reception device 400 executes processing from step ST3802 to step ST3808 in parallel on the FIFO basis for the second optical signal or the third optical signal acquired in step ST3801.

The downlink side operation in the relay transmission/reception device 400 according to the fifth embodiment will be described with reference to FIG. 39.

FIG. 39 is a flowchart illustrating an example of downlink side processing in the relay transmission/reception device 400 according to the fifth embodiment.

First, in step ST3901, the fifth optical receiving FE unit 450 acquires the fourth optical signal or the fifth optical signal.

Next, in step ST3902, the fifth optical receiving FE unit 450 converts the fourth optical signal or the fifth optical signal into a sixth electrical signal and outputs the sixth electrical signal.

Next, in step ST3903, the sixth AD conversion unit 460 converts the sixth electrical signal into a twenty-second digital signal, and outputs the twenty-second digital signal.

Next, in step ST3904, the fifth digital demodulation unit 470 demodulates the twenty-second digital signal to generate a twenty-third digital signal, and outputs the twenty-third digital signal.

Next, in step ST3905, the seventh format conversion unit 480 included in the relay optical signal output unit 490 converts the twenty-third digital signal into a twenty-fifth digital signal in a ninth format and outputs the twenty-fifth digital signal.

Next, in step ST3906, the seventh DA conversion unit 491 included in the relay optical signal output unit 490 converts the twenty-fifth digital signal into a seventh analog signal and outputs the seventh analog signal.

Next, in step ST3907, the eighth photoelectric conversion unit 493 included in the relay optical signal output unit 490 converts the seventh analog signal into a fifth optical signal.

Next, in step ST3908, the eighth photoelectric conversion unit 493 included in the relay optical signal output unit 490 outputs the fifth optical signal.

After step ST3908, the relay transmission/reception device 400 ends the processing of the flowchart. After ending the processing of the flowchart, the relay transmission/reception device 400 returns to step ST3901 and repeatedly executes the processing of the flowchart.

Note that the relay transmission/reception device 400 can execute the processing from step ST3901 to step ST3908 in parallel. Specifically, the relay transmission/reception device 400 executes processing from step ST3902 to step ST3908 in parallel on the FIFO basis for the fourth optical signal or the fifth optical signal acquired in step ST3901.

As described above, the transmission/reception system 1d according to the fifth embodiment is a transmission/reception system 1d that performs transmission and reception of radio signals in one-to-many connection between a third transmission/reception device 300 and a plurality of user terminals by performing the transmission and reception of the radio signals via an optical transmission line between a first transmission/reception device 100 installed at each of a plurality of antenna sites and a second transmission/reception device 200 installed in a relay station building and between the second transmission/reception device 200 and the third transmission/reception device 300 installed in a housing station building, in which the second transmission/reception device 200 includes: a relay station UL processing unit 201 including: an optical signal receiving unit 210 to receive a first optical signal output from each of the plurality of first transmission/reception devices 100 and output a multiplexed signal obtained by multiplexing a plurality of electrical signals based on the plurality of first optical signals; a first format conversion unit 220 to convert the multiplexed signal output from the optical signal receiving unit 210 into a first digital signal in a predetermined first format and output the first digital signal after conversion; a first DA conversion unit 230 to convert the first digital signal output from the first format conversion unit 220 into a first analog signal and output the first analog signal after conversion; and a first photoelectric conversion unit 240 to convert the first analog signal output from the first DA conversion unit 230 into a second optical signal and output the second optical signal after conversion; and a relay station DL processing unit 202 including: a first optical receiving FE unit 250 to receive an optical signal based on a fourth optical signal output from the third transmission/reception device 300 as a fifth optical signal and output a first electrical signal based on the fifth optical signal; a first AD conversion unit 260 to convert the first electrical signal output from the first optical receiving FE unit 250 into a second digital signal and output the second digital signal after conversion; a first digital demodulation unit 270 to demodulate the second digital signal output from the first AD conversion unit 260 to generate a third digital signal and output the generated third digital signal; and an optical signal output unit 290 to output each of a plurality of sixth optical signals based on the third digital signal output from the first digital demodulation unit 270 to a corresponding first transmission/reception device 100, in which the third transmission/reception device 300 includes: a housing station UL processing unit 301 including: a second optical receiving FE unit 310 to receive an optical signal based on the second optical signal output from the second transmission/reception device 200 as a third optical signal and output a second electrical signal based on the third optical signal, a second AD conversion unit 320 to convert the second electrical signal output from the second optical receiving FE unit 310 into a fourth digital signal and output the fourth digital signal after conversion; and a second digital demodulation unit 330 to demodulate the fourth digital signal output from the second AD conversion unit 320 to generate a plurality of fifth digital signals and output the plurality of generated fifth digital signals; and a housing station DL processing unit 302 including: a second format conversion unit 340 to receive a plurality of sixth digital signals, convert the plurality of sixth digital signals into a seventh digital signal in a predetermined second format, and output the seventh digital signal after conversion; a second DA conversion unit 350 to convert the seventh digital signal output from the second format conversion unit 340 into a second analog signal, and output the second analog signal after conversion; and a second photoelectric conversion unit 360 to convert the second analog signal output from the second DA conversion unit 350 into the fourth optical signal, and output the fourth optical signal after conversion, and the transmission/reception system 1d is a transmission/reception system 1d in which one or more relay transmission/reception devices 400 are cascade-connected and installed between the second transmission/reception device 200 and the third transmission/reception device 300, and each of the one or more relay transmission/reception devices 400 includes the relay UL processing unit 401 including: the relay optical signal receiving unit 410 to receive the second optical signal output from the second transmission/reception device 200 or the third optical signal output from the first relay transmission/reception device 400 that is another relay transmission/reception device 400 different from the relay transmission/reception device 400, and output the twentieth digital signal based on the second optical signal or the third optical signal; the sixth format conversion unit 420 to convert the twentieth digital signal output from the relay optical signal receiving unit 410 into a twenty-first digital signal in a predetermined eighth format, and output the twenty-first digital signal after conversion; the sixth DA conversion unit 430 to convert the twenty-first digital signal output from the sixth format conversion unit 420 into a sixth analog signal, and output the sixth analog signal after conversion, and the seventh photoelectric conversion unit 440 to convert the sixth analog signal output from the sixth DA conversion unit 430 into a third optical signal, and output the third optical signal after conversion; and the relay DL processing unit 402 including: the fifth optical receiving FE unit 450 to receive the fourth optical signal output from the third transmission/reception device 300 or the fifth optical signal output from the second relay transmission/reception device 400 that is another relay transmission/reception device 400 different from the relay transmission/reception device 400, and output the sixth electrical signal based on the fourth optical signal or the fifth optical signal; the sixth AD conversion unit 460 to convert the sixth electrical signal output from the fifth optical receiving FE unit 450 into a twenty-second digital signal, and output the twenty-second digital signal after conversion; the fifth digital demodulation unit 470 to demodulate the twenty-second digital signal output from the sixth AD conversion unit 460 to generate a twenty-third digital signal, and output the generated twenty-third digital signal; and the relay optical signal output unit 490 to output a fifth optical signal based on the twenty-third digital signal output from the fifth digital demodulation unit 470.

With such a configuration, even in a case where the distance between the housing station building and the relay station building or the distance between the housing station and the antenna site is long, the transmission/reception system 1d according to the fifth embodiment can perform radio signal transmission of the QAM system having a higher multivalued degree as compared with the conventional transmission/reception system even if the transmission/reception system 1 d is constructed using the A/D converter having the similar performance indices.

In particular, even in a case where the distance between the housing station building and the relay station building is long, in the transmission and reception of the radio signals between the second transmission/reception device 200 and the third transmission/reception device 300, the transmission/reception system 1d according to the fifth embodiment can perform radio signal transmission of the QAM system having a higher multivalued degree as compared with the conventional transmission/reception system.

It should be noted that the present disclosure can freely combine the embodiments, modify any constituent element of each embodiment, or omit any constituent element in each embodiment within the scope of the disclosure.

### INDUSTRIAL APPLICABILITY

The transmission/reception system according to the present disclosure can be applied to a communication system that performs transmission and reception of radio signals in one-to-many connection between a transmission/reception device installed in a housing station and a plurality of user terminals.

### REFERENCE SIGNS LIST

1, 1a, 1b, 1c, 1d: transmission/reception system, 2, 2-1, 2-2, 2-N, 2-A-1, 2-A-N, 2-B-1, 2-B-N: reception antenna, 3, 3-1, 3-2, 3-N, 3-A-1, 3-A-N, 3-B-1, 3-B-N: transmission antenna, 100, 100-1, 100-2, 100-N, 100-A-1, 100-A-N, 100-B-1, 100-B-N, 100b, 100b-1, 100b-2, 100b-N, 100b-A-1, 100b-A-N, 100b-B-1, 100b-B-N: first transmission/reception device, 101, 101b: antenna site UL processing unit, 102, 102b: antenna site DL processing unit, 110: third AD conversion unit, 120, 120b: third format conversion unit, 130, 130b: third photoelectric conversion unit, 140: fourth photoelectric conversion unit, 150: fourth format conversion unit, 160: third DA conversion unit, 170b: fourth DA conversion unit, 180b: third optical receiving FE unit, 190b: fourth AD conversion unit, 171, 172, 173, 174: D/A converter, 191, 192, 193, 194: A/D converter, 199b: third digital demodulation unit, 200, 200a, 200b, 200c: second transmission/reception device, 201, 201-A, 201-B, 201b, 201b-A, 201b-B: relay station UL processing unit, 202, 202-A, 202-B, 202b, 202b-A, 202b-B: relay station DL processing unit, 203: second multiplexing unit, 204: second separation unit, 210, 210b: optical signal receiving unit, 211, 211-1, 211-2, 211-N: fifth photoelectric conversion unit, 212, 212b: first multiplexing unit, 213b, 213b-1, 213b-2: fourth optical receiving FE unit, 214b, 214b-1, 214b-2: fifth AD conversion unit, 216b, 216b-1, 216b-N: fourth digital demodulation unit, 220: first format conversion unit, 230: first DA conversion unit, 240: first photoelectric conversion unit, 250: first optical receiving FE unit, 260: first AD conversion unit, 270: first digital demodulation unit, 290, 290b: optical signal output unit, 291b, 291b-1, 291b-N: fifth format conversion unit, 292, 292b: first separation unit, 293, 293-1, 293-2, 293-N, 293b, 293b-1, 293b-N, : sixth photoelectric conversion unit, 294b, 294b-1, 294b-N: fifth DA conversion unit, 215, 215-1, 215-2, 215-3, 215-4, 261, 262, 263, 264: A/D converter, 231, 232, 233, 234, 295, 295-1, 295-2, 295-3, 295-4: D/A converter, 300, 300a: third transmission/reception device, 301, 301-A, 301-B: housing station UL processing unit, 302, 302-A, 302-B: housing station DL processing unit, 303: third separation unit, 304: third multiplexing unit, 310: second optical receiving FE unit, 320: second AD conversion unit, 330: second digital demodulation unit, 340: second format conversion unit, 350: second DA conversion unit, 360: second photoelectric conversion unit, 321, 322, 323, 324: A/D converter, 351, 352, 353, 354: D/A converter, 400, 400-1, 400-M: relay transmission/reception device, 401: relay UL processing unit, 402: relay DL processing unit, 410: relay optical signal receiving unit, 411: sixth optical receiving FE unit, 412: seventh AD conversion unit, 413, 413-1, 413-2, 413-3, 413-4, 461, 462, 463, 464: A/D converter, 414: sixth digital demodulation unit, 420: sixth format conversion unit, 430: sixth DA conversion unit, 431, 432, 433, 434, 492, 492-1, 492-2, 492-3, 492-4: D/A converter, 440: seventh photoelectric conversion unit, 450: fifth optical receiving FE unit, 460: sixth AD conversion unit, 470: fifth digital demodulation unit, 480: seventh format conversion unit, 490: relay optical signal output unit, 491: seventh DA conversion unit, 493: eighth photoelectric conversion unit, 600: optical reception front end circuit, 610: first polarization separation unit, 620: local oscillator unit, 630: second polarization separation unit, 641, 642: 90° optical hybrid unit, 651, 652, 653, 654: photoelectric converter, 661, 662, 663, 664: amplifier, 701, 801, 901, 3701: processor, 702, 802, 902, 3702: memory, 703, 803, 903, 3703: processing circuit

1. A transmission/reception system that performs transmission and reception of radio signals via an optical transmission line between at least one first transmission/reception device installed at each of a plurality of antenna sites and a second transmission/reception device installed in a relay station building and between the second transmission/reception device and a third transmission/reception device installed in a housing station building and that performs transmission and reception of radio signals in one-to-many connection between a third transmission/reception device and a plurality of user terminals, and the at least one first transmission/reception device includes a plurality of first transmission/reception devices,
the second transmission/reception device including:
a relay station UL processing circuit configured to
receive first optical signals output from each of the plurality of first transmission/reception devices and output a multiplexed signal obtained by multiplexing a plurality of electrical signals based on the plurality of first optical signals;
convert the multiplexed signal into a first digital signal of a predetermined first format and output the first digital signal after conversion;
convert the first digital signal into a first analog signal and output the first analog signal after conversion; and
convert the first analog signal into a second optical signal and output the second optical signal after conversion; and
a relay station DL processing circuit configured to
receive an optical signal based on a fourth optical signal output from the third transmission/reception device as a fifth optical signal and output a first electrical signal based on the fifth optical signal;
convert the first electrical signal into a second digital signal and output the second digital signal after conversion;
demodulate the second digital signal, thereby generating a third digital signal, and output the generated third digital signal; and
output each of a plurality of sixth optical signals based on the
third digital signal to a corresponding first transmission/reception device, and
the third transmission/reception device including:
a housing station UL processing circuit configured to receive an optical signal based on the second optical signal output from the second transmission/reception device as a third optical signal and output a second electrical signal based on the third optical signal;
convert the second electrical signal into a fourth digital signal and output the fourth digital signal after conversion; and
demodulate the fourth digital signal to generate a plurality of fifth digital signals and output the plurality of fifth digital signals having been generated; and
a housing station DL processing circuit configured to
receive a plurality of sixth digital signals, convert the plurality of sixth digital signals into a seventh digital signal in a predetermined second format, and output the seventh digital signal after conversion;
convert the seventh digital signal into a second analog signal, and output the second analog signal after conversion; and
convert the second analog signal into the fourth optical signal, and output the fourth optical signal after conversion.

2. The transmission/reception system according to claim 1, wherein in the transmission and reception of the radio signal between the second transmission/reception device and the third transmission/reception device, the radio signal is converted into a digital signal in a format that causes the second transmission/reception device and the third transmission/reception device to mutually perform the transmission and reception of the radio signal by a coherent detection system.

3. The transmission/reception system according to claim 1,
wherein the at least one first transmission/reception device includes:
an antenna site UL processing circuit configured to
receive a reception radio signal from a reception antenna, convert the reception radio signal into an eighth digital signal, and output the eighth digital signal after conversion;
convert the eighth digital signal into a fourteenth digital signal in a predetermined sixth format, and output the fourteenth digital signal after conversion;
convert the fourteenth digital signal into a third analog signal, and output the third analog signal after conversion; and
convert the third analog signal into the first optical signal, and output the first optical signal after conversion to the second transmission/reception device; and
an antenna site DL processing circuit configured to
receive the sixth optical signal output from the second transmission/reception device, convert the sixth optical signal into a fourth electrical signal, and output the fourth electrical signal after conversion;
convert the fourth electrical signal into a fifteenth digital signal, and output the fifteenth digital signal after conversion;
demodulate the fifteenth digital signal to generate a tenth digital signal, and output the generated tenth digital signal;
convert the tenth digital signal into an eleventh digital signal in a predetermined fourth format, and output the eleventh digital signal after conversion; and
convert the eleventh digital signal into a transmission radio signal and output the transmission radio signal after conversion to a transmission antenna,
wherein the at least one relay station UL processing circuit included in the second transmission/reception device is configured to
convert the first optical signal output from the first transmission/reception device into a fifth electrical signal and outputting the fifth electrical signal after conversion;
convert the fifth electrical signal into a sixteenth digital signal and output the sixteenth digital signal after conversion;
demodulate the sixteenth digital signal to generate a seventeenth digital signal, and output the generated seventeenth digital signal; and
multiplex the seventeenth digital signals to generate the multiplexed signal, and output the generated multiplexed signal, and
wherein the at least one relay station DL processing circuit included in the second transmission/reception device is configured to
separate the third digital signal into a plurality of eighteenth digital signals and output the plurality of eighteenth digital signals after separation;
convert a corresponding eighteenth digital signal among the plurality of eighteenth digital signals into a nineteenth digital signal in a predetermined seventh format and output the nineteenth digital signal after conversion;
convert the nineteenth digital signal into a fifth analog signal and output the fifth analog signal after conversion; and
convert the fifth analog signal into the sixth optical signal and outputting the sixth optical signal after conversion.

4. The transmission/reception system according to claim 3, wherein in the transmission/reception of the radio signal between the at least one first transmission/reception device and the second transmission/reception device, the radio signal is converted into a digital signal in a format that causes the at least one first transmission/reception device and the second transmission/reception device to mutually perform the transmission and reception of the radio signal by a coherent detection system.

5. The transmission/reception system according to claim 1,
wherein the at least one relay station UL processing circuit includes a plurality of relay station UL processing circuits, and
the at least one relay station DL processing circuit includes a plurality of relay station DL processing circuits, and
wherein the second transmission/reception device includes:
the plurality of relay station UL processing circuits;
a second multiplexer to multiplex the second optical signal output from each of the plurality of relay station UL processing circuits and output an optical signal after multiplexing as the second optical signal;
the plurality of relay station DL processing circuits; and
a second separator to receive an optical signal based on the fourth optical signal output from the third transmission/reception device as the fifth optical signal, separate the fifth optical signal into a plurality of optical signals, and output each of the plurality of optical signals after separation as the fifth optical signal to the corresponding relay station DL processing circuits, and
wherein the at least one housing station UL processing circuit includes a plurality of housing station UL processing circuits, and
the at least one housing station DL processing circuit includes a plurality of housing station DL processing circuits, and
wherein the third transmission/reception device includes:
the plurality of housing station UL processing circuits;
a third separator to receive an optical signal based on the second optical signal output from the second transmission/reception device as the third optical signal, separate the third optical signal into a plurality of optical signals, and output each of the plurality of optical signals after separation as the third optical signal to the corresponding housing station UL processing circuit;
the plurality of housing station DL processing circuits; and
a third multiplexer to multiplex the fourth optical signal output from each of the plurality of relay station UL processing circuits and output an optical signal after multiplexing as the fourth optical signal.

6. The transmission/reception system according to claim 1, wherein the radio signal output from the user terminal is in an orthogonal frequency division multiplexing system.

7. A transmission/reception method that performs transmission and reception of radio signals via an optical transmission line between at least one first transmission/reception device installed at each of a plurality of antenna sites and a second transmission/reception device installed in a relay station building and between the second transmission/reception device and a third transmission/reception device installed in a housing station building and that performs the transmission and reception of the radio signals in one-to-many connection between the third transmission/reception device and a plurality of user terminals, and the at least one first transmission/reception device includes a plurality of first transmission/reception devices, the transmission/reception method comprising:
receiving a first optical signal output from each of the plurality of first transmission/reception devices and outputting a multiplexed signal obtained by multiplexing a plurality of electrical signals based on the plurality of first optical signals;
converting the multiplexed signal output in the optical signal reception step into a first digital signal in a predetermined first format and outputting the first digital signal after conversion;
converting the first digital signal output in the first format conversion step into a first analog signal and outputting the first analog signal after conversion;
converting the first analog signal output in the first DA conversion step into a second optical signal and outputting the second optical signal after conversion;
receiving an optical signal based on a fourth optical signal output from the third transmission/reception device as a fifth optical signal and outputting a first electrical signal based on the fifth optical signal;
converting the first electrical signal output in the first optical receiving FE step into a second digital signal and outputting the second digital signal after conversion;
demodulating the second digital signal output in the first AD conversion step to generate a third digital signal, and outputting the generated third digital signal;
outputting each of a plurality of sixth optical signals based on the third digital signal output in the first digital demodulation step to the corresponding first transmission/reception device;
receiving an optical signal based on the second optical signal output from the second transmission/reception device as a third optical signal and outputting a second electrical signal based on the third optical signal;
converting the second electrical signal output in the second optical receiving FE step into a fourth digital signal and outputting the fourth digital signal after conversion;
demodulating the fourth digital signal output in the second AD conversion step to generate a plurality of fifth digital signals, and outputting the plurality of fifth digital signals having been generated;
receiving a plurality of sixth digital signals, converting the plurality of sixth digital signals into a seventh digital signal in a predetermined second format, and outputting the seventh digital signal after conversion;
converting the seventh digital signal output in the second format conversion step into a second analog signal and outputting the second analog signal after conversion; and
converting the second analog signal output in the second DA conversion step into the fourth optical signal and outputting the fourth optical signal after conversion.
